(19) United States
(12) Patent Application Publication
(10) Pub. No.: US 2026/0311124 A1
(43) Pub. Date: Oct. 8, 2026

(54) SYSTEMS AND METHODS FOR USING ADAPTIVE STOCK-KEEPING UNIT DATA STRUCTURES WITH PARAMETERS

(71) Applicant: HemaSource, Inc., West Jordan, UT (US)

(72) Inventors: Beata PUNCEVIC, Golden, CO (US); Jason STITT, Middleton, WI (US); Ali TANGUAY, Boulder, CO (US); Joseph Robert AVERY, Frederick, CO (US)

(73) Assignee: HemaSource, Inc., West Jordan, UT (US)

(21) Appl. No.: 19/639,553

(22) Filed: Apr. 6, 2026

Related U.S. Application Data
(60) Provisional application No. 63/784,943, filed on Apr. 7, 2025.

(51) Int. Cl. G06Q 10/087; G06F 16/21

(52) U.S. Cl. CPC G06Q 10/0877; G06F 16/211

(57) ABSTRACT

A system can maintain an adaptive stock-keeping unit (SKU) associated with a type of procedure, where the adaptive SKU can include a combination SKU having a plurality of SKUs for the type of procedure and a plurality of parameters. The adaptive SKU can be represented by an adaptive SKU data structure having a schema including a procedure-key field storing a procedure identifier, a membership field storing an ordered list of identifiers for the SKUs, a dependency field storing quantity relationship entries defining, for at least one pair of identifiers, a propagation rule mapping a quantity change of a first SKU to a quantity change of a second SKU, and a rule field storing executable membership rules defining permitted membership modifications. The system can establish interfaces to systems of an entity and receive customer parameters for storage in association with the adaptive SKU data structure.

### RELATED APPLICATIONS

This patent application claims the benefit of and priority to U.S. Provisional Patent Application No. 63/784,943 titled “SYSTEMS AND METHODS FOR MANAGEMENT OF ADAPTIVE STOCK KEEPING UNITS” and filed Apr. 7, 2025, the contents of all of which are hereby incorporated herein by reference in its entirety for all purposes

### BACKGROUND

Supply chain management systems can track products and materials using identifiers to facilitate storage, retrieval, and distribution operations. In this regard, various external factors, such as geopolitical issues, weather events, or supplier performance, can impact supply chain stability and degrade system performance.

### SUMMARY

The technical solutions of the present disclosure are directed to enhancing supply chain resilience and operational flexibility through dynamic stock-keeping unit (SKU) management. An SKU can be an identifier assigned to a product within an inventory or catalog system to facilitate tracking, management, and differentiation of such items. Modern supply chain management faces numerous challenges, particularly in industries such as healthcare, where the timely delivery of essential supplies is important for maintaining operations and supporting positive outcomes. In this regard, external factors such as geopolitical tensions, adverse weather conditions, and extended transit times can frequently disrupt supply chain reliability, causing significant risks for industries that depend on just-in-time inventory systems. Distributor systems can function as intermediaries to mitigate disruptions. However, such systems can encounter complexities related to recall management, backorder handling, and inventory accuracy while maintaining cost efficiency and service reliability. As a result, the chain management systems can experience challenges in adapting to dynamic conditions, thereby leading to inefficiencies and increased vulnerability.

The technical solutions described herein address such challenges by implementing the management of adaptive stock-keeping units (SKUs) configured for specific procedures or processes. Adaptive SKUs can incorporate parameters such as supplier details, lot preferences, expiration dates, and dynamic quantity adjustments, allowing distribution systems to adjust to supply chain variations. The system architecture can implement adaptive SKUs and integrate with existing systems, such as enterprise resource planning systems (ERP), warehouse management systems (WMS), transportation management systems (TMS), electronic data exchange systems (EDI), inventory management systems, and purchasing systems to coordinate SKUs, enhance inventory management, and align system configurations with operational demands. Additionally, the system architecture can interface with predictive analytics models and forecasting engines to process demand projections and adjust inventory distribution parameters dynamically. Furthermore, the system architecture can support the configuration of operational parameters and rule-based preferences within distributor and customer management systems. The system architecture can execute one or more machine learning models to forecast demand, determine suitable SKU configurations, and support adaptive configuration planning to improve supply chain adaptability and operational flexibility. The system architecture can process data inputs from distributor and supplier networks, applying predefined SKU parameters to recommend substitutions and transition workflows or autonomously execute them based on granted execution privileges. The system architecture can facilitate coordination between distribution and procurement systems through configurable configuration planning and approval workflows to enhance resource allocation and inventory management efficiency. As a result, the technical solutions described here can improve supply chain resilience, reduce operational costs, and enhance the overall efficiency of inventory management by supporting system-driven adaptation to changing supply chain conditions.

At least one aspect relates to a system. The system can include one or more processors and a non-transitory computer-readable medium storing instructions that, when executed by the one or more processors, cause the system to maintain, in memory, an adaptive stock-keeping unit associated with a type of procedure, the adaptive stock-keeping unit comprising a combination stock-keeping unit having a plurality of stock-keeping units for the type of procedure and having a plurality of parameters. The adaptive stock-keeping unit can be represented by an adaptive stock-keeping unit data structure having a schema comprising a procedure-key field storing a procedure identifier for the type of procedure, a membership field storing an ordered list of identifiers for the plurality of stock-keeping units of the combination stock-keeping unit, a dependency field storing quantity relationship entries that define, for at least one pair of identifiers for the plurality of stock-keeping units, a propagation rule that maps a quantity change of a first stock-keeping unit to a quantity change of a second stock-keeping unit, and a rule field storing executable membership rules that define permitted membership modifications to the ordered list. The system can establish one or more connections, via one or more interfaces, to one or more systems of an entity, the one or more interfaces providing an ordering interface for the entity to request one or more units associated with the adaptive stock-keeping unit. The system can receive, by the one or more interfaces from the one or more systems of the entity, one or more customer parameters of the plurality of parameters for managing the adaptive stock-keeping unit, and store the one or more customer parameters in association with the adaptive stock-keeping unit data structure.

In some embodiments, the ordering interface can be configured to receive an order request from the entity for one or more units associated with the adaptive stock-keeping unit, the order request identifying at least the procedure identifier stored in the procedure-key field. In some embodiments, the one or more customer parameters can comprise one or more combination rules that define, for the adaptive stock-keeping unit, permitted substitutions in which one stock-keeping unit identifier in the ordered list is replaced with a different stock-keeping unit identifier. In some embodiments, the system can initiate, via a second one or more interfaces to a supplier system, an order for one or more units associated with at least one stock-keeping unit identifier in the ordered list based at least on the one or more customer parameters. In some embodiments, the one or more customer parameters can comprise inventory values for the adaptive stock-keeping unit at a plurality of sites of the entity. In some embodiments, the system can be further configured to store the inventory values in association with the adaptive stock-keeping unit data structure. In some embodiments, the system can determine that an inventory value for the adaptive stock-keeping unit at a first site satisfies a threshold condition, and responsive to the threshold condition, trigger a membership modification of the ordered list using at least one executable membership rule stored in the rule field. In some embodiments, the system can trigger a redistribution of one or more units associated with the adaptive stock-keeping unit across the plurality of sites based at least on the inventory values and the one or more customer parameters. In some embodiments, the system can determine a recommended configuration of the adaptive stock-keeping unit for the entity, the recommended configuration identifying at least one of a modified ordered list of stock-keeping unit identifiers or a modified set of the one or more customer parameters. In some embodiments, the system can receive, via the ordering interface, a transition request from the entity to transition from a first combination of the plurality of stock-keeping units to a second combination of the plurality of stock-keeping units, and to modify the membership field responsive to the transition request using at least one executable membership rule stored in the rule field. In some embodiments, the one or more customer parameters can comprise at least one site level constraint specifying site-specific ordering limits or allocation limits for at least one stock-keeping unit identifier in the ordered list. In some embodiments, the ordering interface can enforce the site level constraint when processing an order request.

At least one aspect relates to a computer-implemented method. The method can be performed, for example, by one or more processors coupled to non-transitory memory. The method can include maintaining, in memory, an adaptive stock-keeping unit associated with a type of procedure, the adaptive stock-keeping unit comprising a combination stock-keeping unit having a plurality of stock-keeping units for the type of procedure and having a plurality of parameters. The adaptive stock-keeping unit can be represented by an adaptive stock-keeping unit data structure having a schema comprising a procedure-key field storing a procedure identifier for the type of procedure, a membership field storing an ordered list of identifiers for the plurality of stock-keeping units of the combination stock-keeping unit, a dependency field storing quantity relationship entries that define, for at least one pair of identifiers for the plurality of stock-keeping units, a propagation rule that maps a quantity change of a first stock-keeping unit to a quantity change of a second stock-keeping unit, and a rule field storing executable membership rules that define permitted membership modifications to the ordered list. The method can include establishing one or more connections, via one or more interfaces, to one or more systems of an entity, the one or more interfaces providing an ordering interface for the entity to request one or more units associated with the adaptive stock-keeping unit. The method can include receiving, by the one or more interfaces from the one or more systems of the entity, one or more customer parameters of the plurality of parameters for managing the adaptive stock-keeping unit, and storing the one or more customer parameters in association with the adaptive stock-keeping unit data structure.

In some embodiments, the ordering interface can be configured to receive an order request from the entity for one or more units associated with the adaptive stock-keeping unit, the order request identifying at least the procedure identifier stored in the procedure-key field.

In some embodiments, the one or more customer parameters can comprise one or more combination rules that define, for the adaptive stock-keeping unit, permitted substitutions in which one stock-keeping unit identifier in the ordered list is replaced with a different stock-keeping unit identifier. In some embodiments, the method can include initiating, via a second one or more interfaces to a supplier system, an order for one or more units associated with at least one stock-keeping unit identifier in the ordered list based at least on the one or more customer parameters. In some embodiments, the one or more customer parameters can comprise inventory values for the adaptive stock-keeping unit at a plurality of sites of the entity. In some embodiments, the method can include storing the inventory values in association with the adaptive stock-keeping unit data structure. In some embodiments, the method can include determining that an inventory value for the adaptive stock-keeping unit at a first site satisfies a threshold condition, and responsive to the threshold condition, trigger a membership modification of the ordered list using at least one executable membership rule stored in the rule field. In some embodiments, the method can include triggering a redistribution of one or more units associated with the adaptive stock-keeping unit across the plurality of sites based at least on the inventory values and the one or more customer parameters. In some embodiments, the method can include determining a recommended configuration of the adaptive stock-keeping unit for the entity, the recommended configuration identifying at least one of a modified ordered list of stock-keeping unit identifiers or a modified set of the one or more customer parameters. In some embodiments, the method can include receiving, via the ordering interface, a transition request from the entity to transition from a first combination of the plurality of stock-keeping units to a second combination of the plurality of stock-keeping units, and to modify the membership field responsive to the transition request using at least one executable membership rule stored in the rule field.

At least one aspect relates to a non-transitory computer readable medium. The non-transitory computer readable medium can include one or more instructions stored thereon and executable by a processor. The one or more instructions can be executable to maintain, in memory, an adaptive stock-keeping unit associated with a type of procedure, the adaptive stock-keeping unit comprising a combination stock-keeping unit having a plurality of stock-keeping units for the type of procedure and having a plurality of parameters. The adaptive stock-keeping unit can be represented by an adaptive stock-keeping unit data structure having a schema comprising a procedure-key field storing a procedure identifier for the type of procedure, a membership field storing an ordered list of identifiers for the plurality of stock-keeping units of the combination stock-keeping unit, a dependency field storing quantity relationship entries that define, for at least one pair of identifiers for the plurality of stock-keeping units, a propagation rule that maps a quantity change of a first stock-keeping unit to a quantity change of a second stock-keeping unit, and a rule field storing executable membership rules that define permitted membership modifications to the ordered list. The one or more instructions can be executable to establish one or more connections, via one or more interfaces, to one or more systems of an entity, the one or more interfaces providing an ordering interface for the entity to request one or more units associated with the adaptive stock-keeping unit. The one or more instructions can be executable to receive, by the one or more interfaces from the one or more systems of the entity, one or more customer parameters of the plurality of parameters for managing the adaptive stock-keeping unit, and store the one or more customer parameters in association with the adaptive stock-keeping unit data structure.

These and other aspects and implementations are discussed in detail below. The foregoing information and the following detailed description include illustrative examples of various aspects and implementations and provide an overview or framework for understanding the nature and character of the claimed aspects and implementations. The drawings provide illustration and a further understanding of the various aspects and implementations and are incorporated in and constitute a part of this specification. Aspects can be combined, and it will be readily appreciated that features described in the context of one aspect of the invention can be combined with other aspects. Aspects can be implemented in any convenient form, for example, by appropriate computer programs, which can be carried on appropriate carrier media (computer readable media), which can be tangible carrier media (e.g., disks) or intangible carrier media (e.g., communications signals). Aspects can also be implemented using any suitable apparatus, which can take the form of programmable computers running computer programs arranged to implement the aspect. As used in the specification and in the claims, the singular form of ‘a,’ ‘an,’ and ‘the’ include plural referents unless the context clearly dictates otherwise.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing. In the drawings:

FIG. 1A illustrates an example block diagram depicting a computing device, in accordance with one or more embodiments;

FIG. 1B illustrates an example block diagram depicting a computing environment comprising a client device in communication with cloud service providers, in accordance with one or more embodiments;

FIG. 2A illustrates an example block diagram depicting a system using a machine learning model, in accordance with one or more embodiments;

FIG. 2B illustrates an example block diagram depicting a neural network model, in accordance with one or more embodiments;

FIG. 3 illustrates an example block diagram of a system for management of adaptive stock-keeping units, in accordance with one or more embodiments;

FIG. 4 illustrates an example flow diagram of a method for management of adaptive stock-keeping units, in accordance with one or more embodiments;

FIG. 5 illustrates an example flow diagram of a method for using adaptive stock-keeping unit data structures, in accordance with one or more embodiments;

FIG. 6 illustrates an example flow diagram of a method for managing adaptive stock-keeping units across distributor systems using operational constraints, in accordance with one or more embodiments;

FIG. 7 illustrates an example flow diagram of a method for managing adaptive stock-keeping units using customer parameters, in accordance with one or more embodiments;

FIG. 8 illustrates an example flow diagram of a method for forecasting adaptive stock-keeping units using procedure projections and distributor data, in accordance with one or more embodiments; and

FIG. 9 illustrates an example flow diagram of a method for orchestration using adaptive stock-keeping units, in accordance with one or more embodiments.

### DETAILED DESCRIPTION

Below are detailed descriptions of various concepts related to, and approaches, methods, apparatuses, and systems for implementing the various techniques described herein. The various concepts introduced above and discussed in greater detail below can be implemented in any of numerous ways, as the described concepts are not limited to any particular manner of implementation. Examples of specific implementations and applications are provided primarily for illustrative purposes.

For purposes of reading the description of the various embodiments below, the following descriptions of the sections of the specification and their respective contents can be helpful:
Section A describes a computing environment and network environment that can be useful for practicing embodiments described herein.
Section B describes an artificial intelligence environment that can be useful for practicing embodiments described herein.
Section C describes systems and methods for managing adaptive stock-keeping units.
Section D describes systems and methods for using adaptive stock-keeping unit data structures.
Section E describes systems and methods for managing adaptive stock-keeping units across distributor systems using operational constraints.
Section F describes systems and methods for managing adaptive stock-keeping units using customer parameters.
Section G describes systems and methods for forecasting adaptive stock-keeping units using procedure projections and distributor data.
Section H describes systems and methods for orchestration using adaptive stock-keeping units.

### A. Computing and Network Environment

Prior to discussing the specifics of embodiments of the management of adaptive stock-keeping units for procedure-based inventory, it can be helpful to discuss the computing environments in which such embodiments can be deployed.

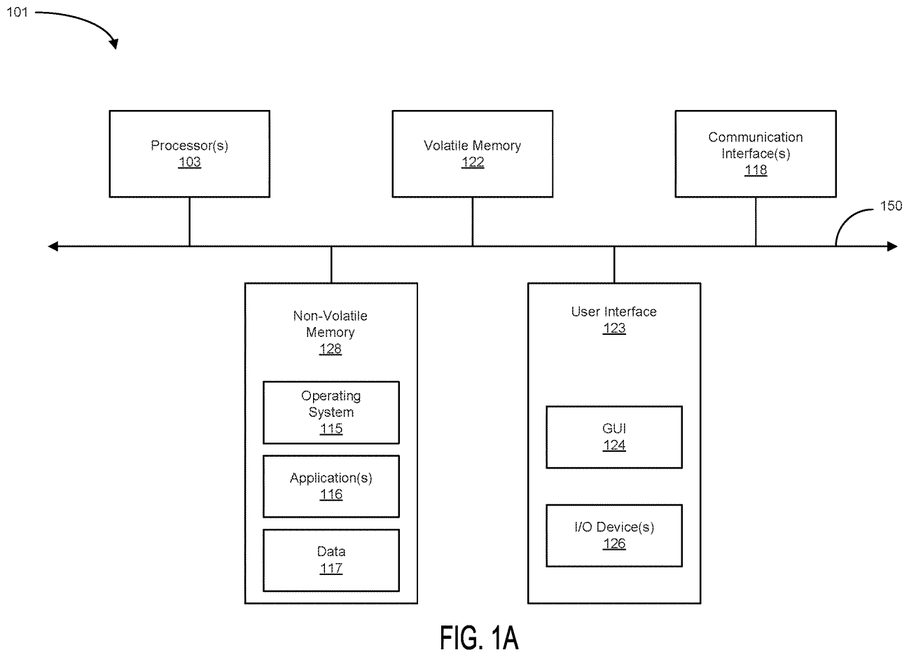

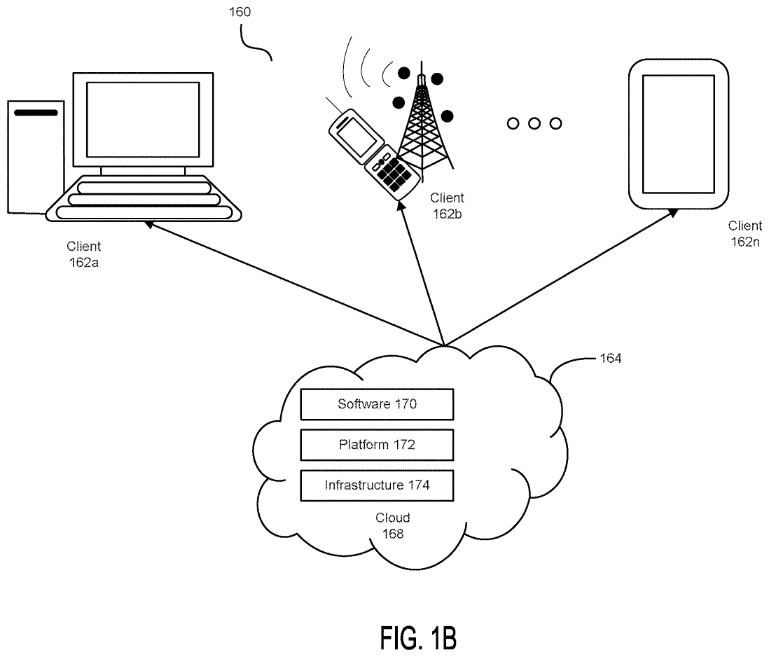

As shown in FIG. 1A, computer 101 can include one or more processors 103, volatile memory 122 (e.g., random access memory (RAM)), non-volatile memory 128 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 123, one or more communications interfaces 118, and communication bus 150. User interface 123 can include graphical user interface (GUI) 124 (e.g., a touchscreen, a display, etc.) and one or more input/output (I/O) devices 126 (e.g., a mouse, a keyboard, a microphone, one or more speakers, one or more cameras, one or more biometric scanners, one or more environmental sensors, one or more accelerometers, etc.). Non-volatile memory 128 stores operating system 115, one or more applications 116, and data 117 such that, for example, computer instructions of operating system 115 and/or applications 116 are executed by processor(s) 103 out of volatile memory 122. In some embodiments, volatile memory 122 can include one or more types of RAM and/or a cache memory that can offer a faster response time than a main memory. Data can be entered using an input device of GUI 124 or received from I/O device(s) 126. Various elements of computer 101 can communicate via one or more communication buses, shown as communication bus 150.

Computer 101 as shown in FIG. 1A is shown merely as an example, as clients, servers, intermediary and other networking devices and can be implemented by any computing or processing environment and with any type of machine or set of machines that can have suitable hardware and/or software capable of operating as described herein. Processor(s) 103 can be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations can be hard coded into the circuitry or soft coded by way of instructions held in a memory device and executed by the circuitry. A “processor” can perform the function, operation, or sequence of operations using digital values and/or using analog signals. In some embodiments, the “processor” can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory. The “processor” can be analog, digital or mixed-signal. In some embodiments, the “processor” can be one or more physical processors or one or more “virtual” (e.g., remotely located or “cloud”) processors. A processor including multiple processor cores and/or multiple processors multiple processors can provide functionality for parallel, simultaneous execution of instructions or for parallel, simultaneous execution of one instruction on more than one piece of data.

Communications interfaces 118 can include one or more interfaces to enable computer 101 to access a computer network such as a Local Area Network (LAN), a Wide Area Network (WAN), a Personal Area Network (PAN), or the Internet through a variety of wired and/or wireless or cellular connections.

In described embodiments, the computing device 101 (which can also be referred to as computer 101) can execute an application on behalf of a user of a client computing device. For example, the computing device 101 can execute a virtual machine, which provides an execution session within which applications execute on behalf of a user or a client computing device, such as a hosted desktop session. The computing device 101 can also execute a terminal services session to provide a hosted desktop environment. The computing device 101 can provide access to a computing environment including one or more of: one or more applications, one or more desktop applications, and one or more desktop sessions in which one or more applications can execute.

Referring to FIG. 1B, a computing environment 160 is depicted. Computing environment 160 can generally be considered implemented as a cloud computing environment, an on-premises (“on-prem”) computing environment, or a hybrid computing environment including one or more on-prem computing environments and one or more cloud computing environments. When implemented as a cloud computing environment, also referred as a cloud environment, cloud computing or cloud network, computing environment 160 can provide the delivery of shared services (e.g., computer services) and shared resources (e.g., computer resources) to multiple users. For example, the computing environment 160 can include an environment or system for providing or delivering access to a plurality of shared services and resources to a plurality of users through the internet. The shared resources and services can include, but not limited to, networks, network bandwidth, servers, processing, memory, storage, applications, virtual machines, databases, software, hardware, analytics, and intelligence.

In embodiments, the computing environment 160 can provide client 162 with one or more resources provided by a network environment. The computing environment 160 can include one or more clients 162a-162n, in communication with a cloud 168 over one or more networks 164. Clients 162 can include, e.g., thick clients, thin clients, and zero clients. The cloud 108 can include back end platforms, e.g., servers 106, storage, server farms or data centers. The clients 162 can be the same as or substantially similar to computer 101 of FIG. 1A.

The users or clients 162 can correspond to a single organization or multiple organizations. For example, the computing environment 160 can include a private cloud serving a single organization (e.g., enterprise cloud). The computing environment 160 can include a community cloud or public cloud serving multiple organizations. In embodiments, the computing environment 160 can include a hybrid cloud that is a combination of a public cloud and a private cloud. For example, the cloud 108 can be public, private, or hybrid. Public clouds 108 can include public servers that are maintained by third parties to the clients 162 or the owners of the clients 162. The servers can be located off-site in remote geographical locations as described above or otherwise. Public clouds 168 can be connected to the servers over a public network 164. Private clouds 168 can include private servers that are physically maintained by clients 162 or owners of clients 162. Private clouds 168 can be connected to the servers over a private network 164. Hybrid clouds 168 can include both the private and public networks 164 and servers.

The cloud 168 can include back end platforms, e.g., servers, storage, server farms or data centers. For example, the cloud 168 can include or correspond to a server or system remote from one or more clients 162 to provide third party control over a pool of shared services and resources. The computing environment 160 can provide resource pooling to serve multiple users via clients 162 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In embodiments, the computing environment 160 can provide on-demand self-service to unilaterally provision computing capabilities (e.g., server time, network storage) across a network for multiple clients 162. The computing environment 160 can provide an elasticity to dynamically scale out or scale in responsive to different demands from one or more clients 162. In some embodiments, the computing environment 160 can include or provide monitoring services to monitor, control and/or generate reports corresponding to the provided shared services and resources.

In some embodiments, the computing environment 160 can include and provide different types of cloud computing services. For example, the computing environment 160 can include Infrastructure as a service (IaaS). The computing environment 160 can include Platform as a service (PaaS). The computing environment 160 can include serverless computing. The computing environment 160 can include Software as a service (SaaS). For example, the cloud 168 can also include a cloud based delivery, e.g. Software as a Service (SaaS) 170, Platform as a Service (PaaS) 172, and Infrastructure as a Service (IaaS) 174. IaaS can refer to a user renting the use of infrastructure resources that are needed during a specified time period. IaaS providers can offer storage, networking, servers or virtualization resources from large pools, allowing the users to quickly scale up by accessing more resources as needed. Examples of IaaS include AMAZON WEB SERVICES provided by Amazon.com, Inc., of Seattle, Washington, RACKSPACE CLOUD provided by Rackspace US, Inc., of San Antonio, Texas, Google Compute Engine provided by Google Inc. of Mountain View, California, or RIGHTSCALE provided by RightScale, Inc., of Santa Barbara, California. PaaS providers can offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Washington, Google App Engine provided by Google Inc., and HEROKU provided by Heroku, Inc. of San Francisco, California. SaaS providers can offer the resources that PaaS provides, including storage, networking, servers, virtualization, operating system, middleware, or runtime resources. In some embodiments, SaaS providers can offer additional resources including, e.g., data and application resources. Examples of SaaS include GOOGLE APPS provided by Google Inc., SALESFORCE provided by Salesforce.com Inc. of San Francisco, California, or OFFICE 365 provided by Microsoft Corporation. Examples of SaaS can also include data storage providers, e.g. DROPBOX provided by Dropbox, Inc. of San Francisco, California, Microsoft SKYDRIVE provided by Microsoft Corporation, Google Drive provided by Google Inc., or Apple ICLOUD provided by Apple Inc. of Cupertino, California.

Clients 162 can access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards can allow clients access to resources over HTTP, and can use Representational State Transfer (REST) protocol or Simple Object Access Protocol (SOAP). Clients 162 can access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that can be built on REST, HTTP, XML, or other protocols. Clients 162 can access SaaS resources through the use of web-based user interfaces, provided by a web browser (e.g. GOOGLE CHROME, Microsoft INTERNET EXPLORER, or Mozilla Firefox provided by Mozilla Foundation of Mountain View, California). Clients 162 can also access SaaS resources through smartphone or tablet applications, including, e.g., Salesforce Sales Cloud, or Google Drive app. Clients 162 can also access SaaS resources through the client operating system, including, e.g., Windows file system for DROPBOX.

In some embodiments, access to IaaS, PaaS, or SaaS resources can be authenticated. For example, a server or authentication server can authenticate a user via security certificates, HTTPS, or API keys. API keys can include various encryption standards such as, e.g., Advanced Encryption Standard (AES). Data resources can be sent over Transport Layer Security (TLS) or Secure Sockets Layer (SSL).

### B. Artificial Intelligence Environment

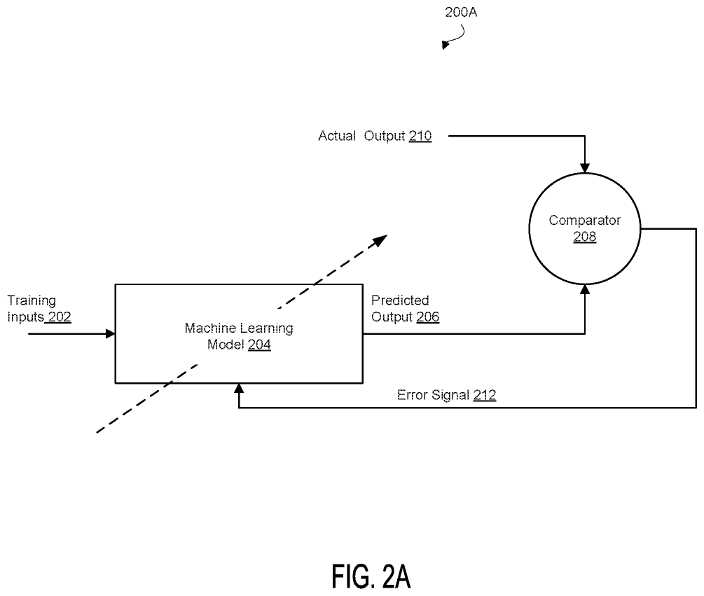

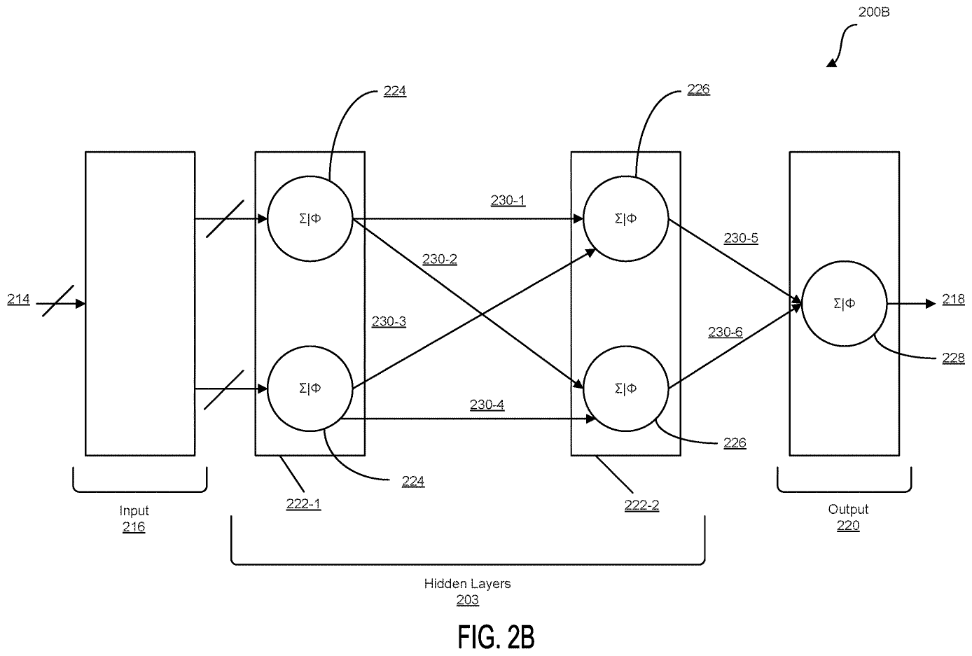

Referring to FIG. 2A, an embodiment of an artificial intelligence environment 200A is depicted. The artificial intelligence environment 200A can incorporate various machine learning models to process data, identify patterns, and generate predictions or decisions. By way of example, machine learning models can comprise supervised learning models, clustering models, neural network models, reinforcement learning models, decision trees, support-vector machines, Bayesian networks, Gaussian processes, genetic algorithms models, any other models that can be used by one or more machine learning algorithms, any other models that can learn from data (e.g., training data) to perform tasks without explicit instructions, or various combinations thereof. The neural network models can comprise, for example and without limitation, artificial neural networks (ANNs), deep neural networks (DNNs), deep belief networks (DBNs), one or more language models, large language models (LLMs), attention-based neural networks, transformer-based neural networks, generative pretrained transformer (GPT) models, bidirectional encoder representations from transformers (BERT) models, encoder/decoder models, sequence to sequence models, autoencoder models, generative adversarial networks (GANs), convolutional neural networks (CNNs), recurrent neural networks (RNNs), diffusion models (e.g., denoising diffusion probabilistic models (DDPMs)), any other models that can learn patterns and make predictions or determinations, or various combinations thereof.

The machine learning models can be configured, learned, or trained using various learning or training operations, such as unsupervised learning, weakly supervised learning, semi-supervised learning, supervised learning, or any other learning or training operations that can learn from data (e.g., training data) and generalize to unseen data, or various combinations thereof. For example, parameters of nodes of a neural network model, such as weights, biases, and/or thresholds, can be configured, learned, or trained using various learning or training operations, such as unsupervised learning, weakly supervised learning, semi-supervised learning, or supervised learning. A machine learning model can be configured using training data from various domain-agnostic and/or domain-specific data sources. The training data can include a plurality of training data elements (e.g., training data instances). Each training data element can be arranged in structured or unstructured formats; for example, the training data element can include an example output mapped to an example input. The training data can include data that is not separated into input and output subsets (e.g., for configuring the machine learning model to perform clustering, classification, or other unsupervised machine learning operations). The training data can include human-labeled information, including but not limited to feedback regarding outputs of the machine learning model, which can allow the machine learning model to generate more human-like outputs.

Referring back to FIG. 2A, a block diagram of an example system using supervised learning is shown. Supervised learning is a method of training a machine learning model given input-output pairs. An input-output pair is an input with an associated known output (e.g., an expected output).

Machine learning model 204 can be trained on known input-output pairs such that the machine learning model 204 can learn how to predict known outputs given known inputs. Once the machine learning model 204 has learned how to predict known input-output pairs, the machine learning model 204 can operate on unknown inputs to predict an output.

The machine learning model 204 can be trained based on general data and/or granular data (e.g., data based on a specific user 132) such that the machine learning model 204 can be trained specific to a particular user 132.

Training inputs 202 and actual outputs 210 can be provided to the machine learning model 204. Training inputs 202 can include features such as numerical data, categorical variables, text, images, audio signals, and the like.

The inputs 202 and actual outputs 210 can be received from various data repositories. For example, a data repository can contain labeled datasets with example data points and their corresponding correct outputs. The data repository can also contain data associated with specific users or general populations. Thus, the machine learning model 204 can be trained to predict outcomes based on the training inputs 202 and actual outputs 210 used to train the machine learning model 204.

The example system can include one or more machine learning models 204. In an embodiment, a first machine learning model 204 can be trained to predict data using a classification or regression technique. For example, the first machine learning model 204 can use the training inputs 202 to predict outputs 206 by applying the current state of the first machine learning model 204 to the training inputs 202. The comparator 208 can compare the predicted outputs 206 to actual outputs 210 to determine an amount of error or differences. For example, the predicted output 206 can be compared to the actual output 210 to calculate a loss function or error metric.

In other embodiments, a second machine learning model 204 can be trained to make one or more recommendations to the user 132 based on the predicted output from the first machine learning model 204. For example, the second machine learning model 204 can use the training inputs 202 and the predicted outputs from the first machine learning model 204 as its own input to predict outputs 206 in the form of personalized recommendations by applying the current state of the second machine learning model 204 to the training inputs 202. The comparator 208 can compare the predicted outputs 206 (e.g., the recommended actions or items) to actual outputs 210 (e.g., user choices or feedback on previous recommendations to determine an amount of error or differences.

The actual outputs 210 can be determined based on historic data of recommendations made to the user 132 and the resulting outcomes in the supply chain. In an illustrative non-limiting example, the machine learning model 204 can be continuously trained to improve its quality and accuracy in predicting and improving supply chain operations. The machine learning model 204 can take into account various inputs such as forecasted demand, inventory data, customer preferences, and distributor preferences to model, recommend, and execute operations. The actual outputs 210 can then be determined by measuring the real-world outcomes after implementing these recommendations, such as the resulting stockout rate, inventory carrying costs, and overall supply chain efficiency.

In some embodiments, a single machine learning model 204 can be trained to make one or more recommendations to the user 132 based on current user data received from enterprise resources. That is, a single machine learning model can be trained using the training inputs 202, which include historical data and current user data, to predict outputs 206 in the form of personalized recommendations by applying the current state of the machine learning model 204 to the training inputs 202. The comparator 208 can compare the predicted outputs 206 to actual outputs 210 to determine an amount of error or differences. The actual outputs 210 can be determined based on historic data associated with the recommendation to the user 132 and their subsequent actions or outcomes. The machine learning model 204 can use the data to learn patterns and make increasingly accurate recommendations over time. For instance, if the machine learning model 204 recommends ordering 1000 units of a product and a user 132 follows the recommendation, the actual output 210 can include data on whether the quantity was sufficient, excessive, or inadequate based on subsequent demand and inventory levels. This feedback loop can allow the machine learning model 204 to continuously refine its predictions and adapt to changing conditions and user preferences in the supply chain ecosystem.

During training, the error (represented by error signal 212) determined by the comparator 208 can be used to adjust the weights in the machine learning model 204 such that the machine learning model 204 changes (or learns) over time. The machine learning model 204 can be trained using a backpropagation algorithm, for instance. The backpropagation algorithm operates by propagating the error signal 212. The error signal 212 can be calculated each iteration (e.g., each pair of training inputs 202 and associated actual outputs 210), batch and/or epoch, and propagated through the algorithmic weights in the machine learning model 204 such that the algorithmic weights adapt based on the amount of error. The error is minimized using a loss function. Non-limiting examples of loss functions can include the square error function, the root mean square error function, and/or the cross entropy error function.

The weighting coefficients of the machine learning model 204 can be tuned to reduce the amount of error, thereby minimizing the differences between (or otherwise converging) the predicted output 206 and the actual output 210. The machine learning model 204 can be trained until the error determined at the comparator 208 is within a certain threshold (or a threshold number of batches, epochs, or iterations have been reached). The trained machine learning model 204 and associated weighting coefficients can subsequently be stored in memory 128 or other data repository (e.g., a database) such that the machine learning model 204 can be employed on unknown data (e.g., not training inputs 202). Once trained and validated, the machine learning model 204 can be employed during a testing (or an inference) phase. During testing, the machine learning model 204 can ingest unknown data to predict future data (e.g., future demand, inventory levels, supplier performance, delivery times, and the like).

Referring to FIG. 2B, a block diagram of a simplified neural network model 200B is shown. The neural network model 200B can include a stack of distinct layers (vertically oriented) that transform a variable number of inputs 214 being ingested by an input layer 216 into an output 218 at the output layer 220.

The neural network model 200B can include a number of hidden layers 222 between the input layer 216 and output layer 220. Each hidden layer has a respective number of nodes (224, 226, and 228). In the neural network model 200B, the first hidden layer 222-1 has nodes 224, and the second hidden layer 222-2 has nodes 226. The nodes 224 and 226 perform a particular computation and are interconnected to the nodes of adjacent layers (e.g., nodes 224 in the first hidden layer 222-1 are connected to nodes 226 in a second hidden layer 222-2, and nodes 226 in the second hidden layer 222-2 are connected to nodes 228 in the output layer 220). Each of the nodes (224, 226, and 228) sum up the values from adjacent nodes and apply an activation function, allowing the neural network model 200B to detect nonlinear patterns in the inputs 214. Each of the nodes (224, 226, and 228) are interconnected by weights 230-1, 230-2, 230-3, 230-4, 230-5, 230-6 (collectively referred to as weights 230). Weights 230 are tuned during training to adjust the strength of the node. The adjustment of the strength of the node facilitates the neural network's ability to predict an accurate output 218.

In some embodiments, the output 218 can be one or more numbers. For example, output 218 can be a vector of real numbers subsequently classified by any classifier. In one example, the real numbers can be input into a softmax classifier. A softmax classifier uses a softmax function, or a normalized exponential function, to transform an input of real numbers into a normalized probability distribution over predicted output classes. For example, the softmax classifier can indicate the probability of the output being in class A, B, C, etc. As such, the softmax classifier can be employed because of the classifier's ability to classify various classes. Other classifiers can be used to make other classifications. For example, the sigmoid function makes binary determinations about the classification of one class (i.e., the output can be classified using label A or the output can not be classified using label A).

### C. Systems and Methods for Managing Adaptive Stock-Keeping Units

Below are detailed descriptions of various concepts related to, and embodiments of, techniques, approaches, methods, apparatuses, and systems for the management of adaptive stock-keeping units. The various concepts introduced above and discussed in greater detail below can be implemented in any of numerous ways, as the described concepts are not limited to any particular manner of implementation. Examples of specific embodiments and applications are provided primarily for illustrative purposes.

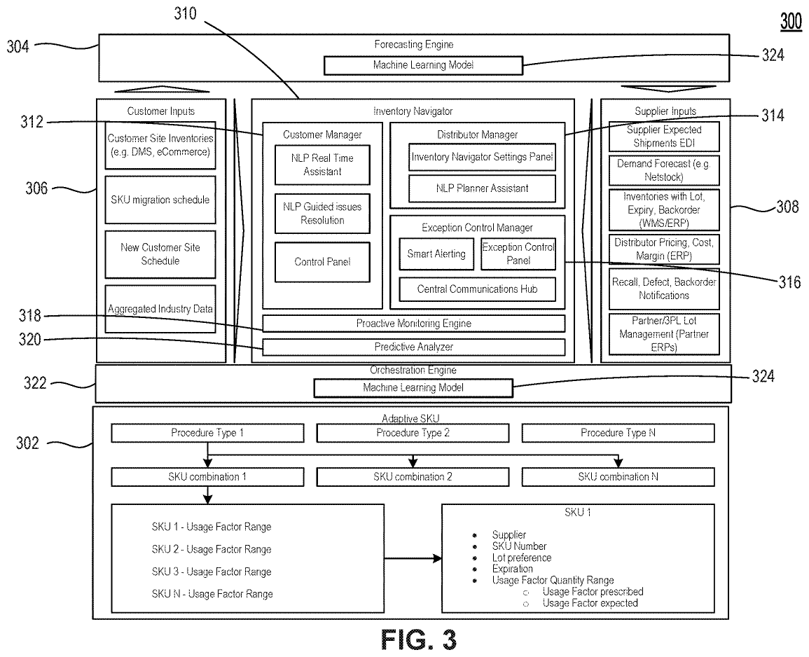

FIG. 3 illustrates an example system 300 for the management of adaptive stock-keeping units. Example system 300 can include one or more of an adaptive stock-keeping unit (SKU) manager 302, a forecasting engine 304, a customer system integration manager 306, a distributor system integration manager 308, an inventory navigator 310, a customer manager 312, a distributor manager 314, an exception control manager 316, a proactive monitoring engine 318, a predictive analyzer 320, and an orchestration engine 322. Any of the systems described in connection with FIGS. 1A-1B and FIGS. 2A-2B can be configured, constructed, or implemented to implement, operate, and/or use any of the options and techniques described in FIG. 3.

The system 300 can include, interface with, communicate with, or otherwise utilize an adaptive stock-keeping unit (SKU) manager 302. The adaptive SKU manager 302 can be or include any script, file, program, application, set of instructions, or computer-executable code that can be configured to manage inventory data for various procedure-based workflows. The adaptive SKU manager 302 can define or generate adaptive SKUs. The adaptive SKU manager 302 can maintain the adaptive SKU as a combination SKU having a plurality of SKUs for a type of procedure. The system 300 can include a data store that stores an adaptive SKU data structure having a schema. An adaptive SKU data structure can refer to a machine-readable data structure that associates a procedure identifier with a procedure-level inventory configuration. The procedure-level inventory configuration can include a plurality of underlying SKU identifiers and associated control data, including at least one of quantity ranges, dependency parameters, or executable membership rules, such that the inventory configuration can be modified responsive to a change event or quantities for affected underlying SKU identifiers can be recomputed in a coordinated manner.

The adaptive SKU manager 302 can store, in a non-transitory computer-readable medium, the adaptive SKU data structure. The adaptive SKU data structure can be referred to as an adaptive SKU record, a combination SKU record, or a procedure linked inventory object. An adaptive SKU can be a procedure-linked combination SKU represented by an adaptive SKU data structure that can identify a plurality of underlying SKUs for a type of procedure and can store associated quantity ranges, dependency parameters, or executable membership rules. The type of procedure can be referred to as a procedure type, a procedural type, or a procedural category. For example, the type of procedure can identify a defined class of procedures, such as a cardiac catheterization procedure, an orthopedic implant procedure, or a surgical suturing procedure.

The schema of the adaptive SKU data structure can include an adaptive SKU identifier, a procedure-key field storing a procedure identifier for the type of procedure, and a membership field storing an ordered list of underlying SKU identifiers for a combination SKU associated with the type of procedure. In certain implementations, the adaptive SKU data structure can further include a dependency field storing quantity relationship entries that define, for at least one pair of underlying SKU identifiers, a propagation rule that maps a quantity change of a first underlying SKU identifier to a quantity change of a second underlying SKU identifier, or a rule field storing executable membership rules that define permitted membership modifications to the ordered list.

The schema can be a defined specification that defines the fields, data types, and relationships within the adaptive SKU data structure. The procedure-key field can be a storage location or a data field within the data structure that maintains the procedure identifier. The membership field can be a storage location or a data field within the data structure that maintains the ordered list of underlying SKU identifiers. The ordered list can be a sequence of SKU identifiers arranged in a defined order. The dependency field can be a storage location or a data field within the data structure that maintains the quantity relationship entries. The quantity relationship entry can be a data record that specifies how a quantity change in one SKU identifier affects or impacts a quantity change in another SKU identifier. A propagation rule can be a computational expression or algorithm that maps a quantity change of a first underlying SKU identifier to a quantity change of a second underlying SKU identifier. The rule field can be a storage location or a data field within the data structure that maintains the executable membership rules. An executable membership rule can be a programmatic instruction or condition that governs whether an underlying SKU identifier can be added, removed, or replaced within the ordered list.

In some embodiments, the adaptive SKU manager 302 can maintain, in volatile or non-volatile memory, the adaptive SKU data structure in an active procedure-level state to facilitate real-time membership modification and incremental quantity recomputation without repeated database reads of individual SKU records. The adaptive SKU data structure can be stored as a procedure linked execution object retrievable as a single unit to avoid repeated reconstruction of procedure level inventory state from individual SKU records. In some embodiments, the system 300 can retrieve and update the adaptive SKU data structure as a single procedure-linked object keyed by the procedure identifier stored in the procedure-key field. During processing of a change event associated with an underlying SKU identifier (e.g., a first underlying SKU identifier) in the membership field, one or more components of the system 300, such as the adaptive SKU manager 302 or the orchestration engine 322, can access, modify, or persist the adaptive SKU data structure as the single procedure linked object rather than performing separate reads and updates of individual SKU records. Such a configuration can reduce repeated database reads and writes for separate SKU records.

In some embodiments, the system 300 can cache, in memory, at least a portion of the adaptive SKU data structure including the membership field, the dependency field, and the rule field. The system 300 can further cache, in association with the adaptive SKU data structure, one or more operational constraints received from an entity system, including machine-readable constraint data specifying at least one of supply availability, substitution eligibility, quantity bounds, dependency restrictions, available-to-promise inventory, lot attributes, expiry attributes, backorder attributes, or shipment timing constraints. The system 300 can reuse the cached portion or one or more cached operational constraints across a plurality of update messages associated with the procedure identifier or across successive change events for one or more underlying SKU identifiers to reduce repeated rule evaluation and repeated reconstruction of procedure-level state. In some embodiments, the cached portion can further be used along with a cached procedure-identifier mapping, a cached SKU-identifier mapping, a cached canonical procedure record, or a cached preference profile record during a subsequent orchestration cycle for a given time period.

In some embodiments, the membership field can store the ordered list of underlying SKU identifiers as a procedure-level consumption sequence maintained independently of individual SKU inventory records. In some embodiments, the procedure-level consumption sequence can be a unified record of SKU identifiers used to execute a procedure, where the record can be stored separately from per-SKU inventory tracking data. Individual SKU inventory records can be standalone data structures that can track quantities and attributes for each SKU across distribution centers or customer sites.

The adaptive SKU data structure can store a usage factor range associated with the procedure identifier, and the adaptive SKU manager 302 can apply the usage factor range to constrain quantity updates during incremental recomputation. A usage factor range can be a numerical interval that defines a range of usage factors for a procedure. A usage factor can be a ratio derived from historical consumption data that specifies the quantity of an SKU consumed, used, or distributed per instance of the procedure. The usage factor for a procedure can be derived from the quantity of items purchased over a predetermined time period, the number of procedures performed during that period, and a comparison to the actual quantity of items utilized. In some embodiments, the usage factor range can be determined for the type of procedure based at least on a quantity of units purchased over a period of time, a number of procedures performed over the period of time, or a quantity of units utilized over the period of time. The usage factor can be computed as the quantity of items desired per procedure multiplied by the waste factor. In some embodiments, the usage factor can be determined based on inventory data, where the starting inventory plus the quantity of shipped items, minus the ending inventory, is divided by the number of procedures performed to calculate the actual quantity of items consumed per procedure.

The dependency field can store dependency parameters that can include quantity relationship entries or one or more combination rules for the underlying SKU identifiers, including rules that add, remove, or substitute a first underlying SKU identifier with a second underlying SKU identifier, for instance. In some embodiments, at least a portion of the dependency parameters stored in the dependency field can include one or more adaptive-SKU substitution rules as combination rules that replace a first underlying SKU identifier in the membership field with a second underlying SKU identifier.

The adaptive SKU manager 302 can update the membership field by executing at least one executable membership rule selected based on a change event. A change event can include a detected condition, input, update, or system occurrence that triggers evaluation or execution of one or more membership rules. The change event can be associated with a first underlying SKU identifier stored in the membership field of the adaptive SKU data structure. Updating the membership field can include at least one of replacing an underlying SKU identifier, adding an additional underlying SKU identifier, or removing an underlying SKU identifier. In some embodiments, updating the membership field can include substituting a first underlying SKU identifier with a second underlying SKU identifier in the membership field and updating quantities for the substituted underlying SKU identifier and for any underlying SKU identifiers reachable through dependency relationships from the substituted underlying SKU identifier.

The system 300 can evaluate the dependency parameters stored in the dependency field to determine, for a given time period, at least one dependency driven quantity adjustment among the underlying SKU identifiers of the membership field by applying a combination rule that adds, removes, or substitutes a first underlying SKU identifier with a second underlying SKU identifier. Additionally, the system 300 can apply a quantity relationship entry that specifies a proportional or conditional change in an anticipated quantity of at least one other underlying SKU identifier responsive to the add, remove, or substitute operation. In some embodiments, when a first underlying SKU identifier is replaced with a second underlying SKU identifier, a quantity relationship entry of the dependency field can update a dynamic quantity for the second underlying SKU identifier responsive to the replacement, and the dynamic quantity can be constrained by the usage factor range associated with the type of procedure. Incremental recomputation can be a computational operation that recalculates quantities for a subset of underlying SKU identifiers in response to a membership modification, rather than recalculating quantities for some or all underlying SKU identifiers. The incremental recomputation operation can update quantities without recalculating quantities for SKUs that are unaffected by the membership modification, thereby reducing processor utilization relative to full recomputation.

In some embodiments, modification of the membership field and the incremental recomputation operation can be executed as a single coordinated procedure-level transaction, which can prevent inconsistent intermediate quantity states and reduce repeated correction cycles that would otherwise be triggered by independent per-SKU updates. The adaptive SKU manager 302 can update the membership field to implement a change in the plurality of SKUs making up the combination SKU for the adaptive SKU. The change can include at least one of combining, adding, or removing one SKU of the plurality of SKUs for another SKU of the plurality of SKUs. The adaptive SKU manager 302 can perform an incremental recomputation operation that updates quantities for a subset of underlying SKU identifiers affected or impacted by a membership modification by applying the quantity relationship entries in the dependency field.

A membership modification can be a change to the ordered list of underlying SKU identifiers stored in the membership field, such as replacing, adding, or removing an underlying SKU identifier. The adaptive SKU manager 302 can identify the affected subset of underlying SKU identifiers by traversing quantity relationship entries incident to a changed underlying SKU identifier and can update quantities for the affected subset without recomputing quantities for unaffected underlying SKU identifiers. In some embodiments, the incremental recomputation operation can include a localized quantity-propagation operation that updates anticipated quantities for fewer than all of the underlying SKU identifiers in the membership field based on at least one quantity relationship entry, thereby reducing processor cycles and memory churn associated with full recomputation across the ordered list of underlying SKU identifiers. In some embodiments, a dependency-driven quantity adjustment determined from the dependency field can be provided to a forecasting engine 304 and used in generating or refining the refined quantity for the adaptive SKU for a given time period.

The adaptive SKU manager 302 can execute updating the membership field and performing the incremental recomputation operation as a single coordinated procedure-level transaction that reduces cascading per-SKU recomputation events. A procedure-level transaction can be a unified computational operation that updates multiple underlying SKU identifiers and the associated quantities within a single execution cycle. The adaptive SKU manager 302 can store updated quantities in association with the adaptive SKU data structure. In some embodiments, the dependency field can store quantity relationship entries defining proportional, bounded, or conditional quantity propagation rules between underlying SKU identifiers. A proportional quantity propagation rule can be a computational expression that scales the quantity of a second underlying SKU identifier by a fixed ratio relative to a change in the quantity of a first underlying SKU identifier. A bounded quantity propagation rule can be a computational expression that applies a minimum or maximum limit to the quantity of a second underlying SKU identifier when the quantity of a first underlying SKU identifier changes. A conditional quantity propagation rule can be a computational expression that applies a quantity change to a second underlying SKU identifier when a specified condition associated with a first underlying SKU identifier is satisfied. The dependency field can define quantity propagation rules that encode proportional, conditional, or bounded quantity relationships between SKUs consumed together as part of the type of procedure.

In some embodiments, the executable membership rules can include constraint-governed substitution rules. Such substitution rules can prevent the introduction of an underlying SKU that violates at least one compatibility or quantity dependency defined in the dependency field. A constraint-governed substitution rule can be a programmatic condition that evaluates whether adding, removing, or replacing an underlying SKU identifier within the membership field can result in a violation of a stored compatibility constraint or a stored quantity dependency. A compatibility constraint can be a logical condition that specifies which underlying SKU identifiers can coexist within the same ordered list based on supplier relationships, regulatory requirements, or procedural standards. A quantity dependency can be a relational expression stored in the dependency field that defines how a quantity change of one underlying SKU identifier affects a quantity change of another underlying SKU identifier. Executing the at least one executable rule to modify the membership field can enforce compatibility constraints across the ordered list of SKUs such that a replacement or addition of an SKU can be prevented when the dependency field indicates an invalid quantity propagation outcome. The adaptive SKU manager 302 can facilitate procedural classification and SKU dependency mapping, such that SKU allocations remain aligned with the procedural context and operational parameters. In some embodiments, the adaptive SKU manager 302 can define SKU priority or ranking levels to indicate each SKU's importance or relevance to the procedure.

Various computing infrastructures can execute different procedural workflows. For example, In some embodiments, procedural workflows can demand SKUs mandated by regulatory bodies. In some embodiments, procedural workflows can incorporate SKUs based on policies defined by medical governance models. The adaptive SKU manager 302 can process system-defined SKU combination parameters to determine permissible SKU groupings for each procedure. The adaptive SKU manager 302 can ingest and compute operational parameters, such as supplier details, origin attributes (including tariff status), lot numbers and ranges, expiry dates (including expiration buffer thresholds), dynamic SKU quantities, SKU combination rules, SKU priority levels, and financial metrics such as cost, price, margin, or freight terms. For each underlying SKU within an adaptive SKU configuration, the system 300 can store a usage factor range associated with a procedure type. The system 300 can also record SKU specific attributes, such as supplier, SKU number, lot preference, expiration, or a usage factor quantity range that includes prescribed and expected usage factors. Dynamic SKU quantities can be established in combinations to manage substitutions, such that when an SKU substitution occurs, any corresponding adjustments to other SKUs in the defined configuration can be executed. In some embodiments, if a SKU substitution demands adding or removing another SKU, SKU combination rules can trigger the corresponding substitution. The adaptive SKU manager 302 can implement a swap of the SKU combination of the plurality of SKUs based at least on receiving a substitution of one of the one or more SKUs to be added or removed.

In some embodiments, the adaptive SKU manager 302 can support multiple transition types for changing from a first SKU combination to a second SKU combination, including direct transitions, blended transitions in which units from the first SKU combination and the second SKU combination can be permitted during at least part of a transition period, or contingent transitions in which a transition can be conditioned on satisfaction of one or more trigger conditions such as inventory depletion, arrival of replenishment inventory, customer approval, or warehouse readiness. In some embodiments, transition rules can further account for non-equivalent units of measure, including changes in case size, pack size, or other packaging configuration, such that a substitution or transition can include corresponding quantity normalization, rounding, and consumption-factor adjustments for affected underlying SKUs.

In some embodiments, the system 300 can evaluate transition-related exceptions and generate alerts based on defined trigger conditions, including excessive ordering relative to a projected transition schedule, days-on-hand threshold violations, missed transition dates, or vendor supply shortfalls. The system 300 can further support scenario modeling for comparing different transition outcomes, including modeling an impact of schedule slips, delayed replenishment, or alternate substitution timing. In some embodiments, the system 300 can maintain transition governance data identifying an approval state, a responsible entity, and a time association for a transition-related event such that the system 300 can maintain a knowledge-state history and can generate an early-warning notification when a purchasing action associated with a transition occurs before an approval is recorded.

The system 300 can include, interface with, communicate with, or otherwise utilize a forecasting engine 304. The forecasting engine 304 can be or include any script, file, program, application, set of instructions, or computer-executable code that can be configured to manage and generate demand forecasts based on input parameters. The forecasting engine 304 can process procedural forecast data received from external entities, including customer-provided procedure forecasts, distributor-anticipated forecasts derived from machine learning models, or SKU-specific purchase factor-based forecasts incorporating additional operational parameters beyond procedure volume.

The forecasting engine 304 can implement algorithmic prediction models, such as demand forecasting systems or predictive analytics frameworks, to compute future inventory demands. The forecasting engine 304 can be configured to interact with various system components and dynamically update inventory allocation predictions using heterogeneous forecast inputs received from the system components. In some embodiments, the forecasting engine 304 can facilitate adaptive SKU configuration by projecting future inventory needs and generating SKU decisions or determinations. Such determinations can proactively account for anticipated supply constraints. The forecasting engine 304 can process a demand forecast for the adaptive SKU or at least one or more of the plurality of SKUs, where the plurality of parameters can include the demand forecast.

The system 300 can include an ingestion engine that can receive, via one or more interfaces from heterogeneous data source systems, procedure data associated with the procedure identifier. The procedure data can include a projection of volumes of the procedure for a given time period. The ingestion engine can be or include any one or more components of the system 300 that can receive, aggregate, normalize, store, or transform data from heterogeneous source systems. For example, the ingestion engine can include, but is not limited to, the adaptive SKU manager 302, the forecasting engine 304, the customer system integration manager 306, the distributor system integration manager 308, the proactive monitoring engine 318, and the orchestration engine 322, among others. In some embodiments, the projection of volumes of the procedure for the given time period can include or correspond to a projection of a frequency of the type of procedure for the given time period. The ingestion engine can receive, via the one or more interfaces from the heterogeneous data source systems, factor-based data including operational parameter values that can cause changes in anticipated quantities of adaptive SKUs for the given time period. In some embodiments, the factor-based data can further include one or more adaptive-SKU substitution rules that define permitted substitutions among underlying SKU identifiers of the membership field.

The ingestion engine can transform the procedure data and the factor-based data into a canonical feature representation that can include a feature vector for the given time period. In some embodiments, the canonical feature representation can be generated according to a defined or fixed source-agnostic feature schema that can map a plurality of heterogeneous source-system field names, formats, or units into corresponding canonical feature fields of the feature vector. The source-agnostic feature schema can be reused across multiple heterogeneous data source systems for the given time period and for subsequent time periods to reduce repeated per-source parsing and field-mapping operations otherwise performed separately for each source system. In some embodiments, the operational parameter values can be received from different heterogeneous source systems in different units, scales, categorical formats, textual formats, or field formats. In such cases, the ingestion engine can normalize the operational parameter values into a canonical representation for use as model inputs by applying one or more of a unit conversion operation, a scaling operation, a categorical encoding operation, a text-to-field normalization operation, or a missing-value imputation operation. The canonical representation can be reused during generation of candidate combination SKU record identifiers and during subsequent forecasting operations for the given time period to reduce repeated per-source unit conversion and repeated feature assembly.

In some embodiments, the system 300 via the ingestion engine can further perform dimensionality reduction on at least a portion of the factor-based data to generate the canonical feature representation. For example, the ingestion engine can receive a first operational parameter value specifying a quantity in kilograms from a first heterogeneous data source system and a second operational parameter value specifying a quantity in pounds from a second heterogeneous data source system, and can normalize the first operational parameter value and the second operational parameter value by converting both quantities to a common unit of grams to generate a normalized operational parameter value that can be included in the canonical feature representation.

In response to transforming the procedure data and the factor-based data into the canonical feature representation, the forecasting engine 304 can execute the trained machine learning model using the canonical feature representation without re-transforming raw inputs received from the heterogeneous data source systems for at least one subsequent forecasting operation for a given time period. The canonical feature representation for the given time period can be stored in a cache in association with at least one of the procedure identifier or the adaptive SKU identifier and reused to execute the trained machine learning model for at least one subsequent forecasting operation for the given time period to reduce processor utilization and memory allocation associated with repeated feature construction.

The forecasting engine 304 can execute a machine learning model 324 to compute predictive inventory demand forecasts for adaptive SKUs. The machine learning model 324 can be similar to and incorporate any of the structure and functionality of the machine learning models described in connection with FIGS. 2A-2B. The forecasting engine 304 can process procedure forecast data originating from customer or distributor sources to quantify anticipated procedural volumes. The machine learning model 324, integrated within the forecasting engine 304, can apply purchase factor-based modeling to generate SKU-specific demand projections. The forecasting engine 304 can execute a trained machine learning model to generate an initial quantity estimate for the adaptive SKU for the given time period using the feature vector.

For example, in a procedural execution model, a surgical procedure can demand a designated suture type. While procedural volume directly affects the demand for the suture, the demand for ancillary SKUs, such as surgical gloves within the adaptive SKU configuration, can be influenced or regulated by external operational parameters. Such parameters can include hospital occupancy metrics, seasonal epidemiological trends, or supplier-driven bulk procurement incentives. The purchase factor-based model within the forecasting engine 304 can process such external data streams to generate demand projections for surgical gloves and dynamically adjust inventory allocations to maintain stock levels aligned with operational parameters despite procedural volume fluctuations.

In some embodiments, the forecasting engine 304 can generate an initial quantity estimate for an adaptive SKU using the canonical feature representation and can thereafter refine the initial quantity estimate using distributor data received by an integration manager, including delivery-date data for one or more underlying SKU identifiers of the membership field. In some embodiments, the refinement can be performed by updating a subset of the feature vector corresponding to delivery-date features derived from the distributor data while maintaining the remaining features of the canonical feature representation unchanged to reduce recomputation relative to re-executing the trained machine learning model over an entire reconstructed feature vector. The refinement can further incorporate dependency parameters associated with the adaptive SKU data structure, including combination rules and quantity relationship entries stored in a dependency field, such that substitutions, additions, or removals of underlying SKU identifiers and resulting proportional or conditional quantity changes for related underlying SKU identifiers can be reflected in the refined quantity for the given time period.

In some embodiments, the forecasting engine 304 can further generate or refine quantity estimates using forward-looking commercial and financial planning data, including projected price changes, rebate effects, contract terms, or other deal-economics attributes associated with one or more underlying SKU identifiers. In some embodiments, the forecasting engine 304 can apply such data when selecting among candidate substitutions, transition schedules, or procurement quantities for a given time period. In some embodiments, where forecast data is incomplete, sparse, or unreliable for a particular market, customer, or site, the forecasting engine 304 can generate an initial quantity estimate or a refined quantity using partial forecast inputs in combination with historical usage factors, distributor constraints, or procedure-linked dependency parameters stored in the adaptive SKU data structure. In some embodiments, the ingestion engine or the forecasting engine 304 can further normalize warehouse-specific unit-of-measure data and consumption-factor data for use in generating the initial quantity estimate or the refined quantity. Such normalization can include applying conversion factors between non-equivalent packaging or ordering units, applying rounding rules associated with a warehouse or supplier, and mapping consumption values across transition states such that quantity outputs remain aligned with warehouse-specific fulfillment constraints and procedure-level usage expectations.

The system 300 can include, interface with, communicate with, or otherwise utilize a customer system integration manager 306. The customer system integration manager 306 can be or include any script, file, program, application, set of instructions, or computer-executable code that can be configured to receive customer inventory data via one or more system interfaces. The customer system integration manager 306 can establish one or more connections via one or more interfaces to one or more systems of a customer entity. The customer system integration manager 306 can interface with multiple system components to aggregate and process real-time or near real-time inventory data across one or more customer sites. The customer system integration manager 306 can maintain continuous inventory visibility by tracking SKU migration schedules, site activations, or deactivations. The customer system integration manager 306 can also receive and process aggregated industry data and new customer site schedule data. The customer system integration manager 306 can facilitate data ingestion and synchronization through batch and micro-batch inventory processing, structured flat file inventory exchanges, or event-driven inventory updates derived from active order transactions or episodic alerts provided by customers.

The one or more interfaces can provide an ordering interface for the customer entity to request one or more units associated with the adaptive SKU. In some embodiments, the ordering interface can be configured to receive an order request from the customer entity for one or more units associated with the adaptive SKU, and the order request can identify at least the procedure identifier stored in the procedure-key field. The ordering interface can parse the received order request to identify the procedure identifier in the procedure-key field and retrieve the corresponding adaptive SKU configuration from memory to facilitate immediate association with the ordered combination SKU.

The customer system integration manager 306 can receive, via the one or more interfaces from the one or more systems of the customer entity, one or more customer parameters of the plurality of parameters for managing the adaptive SKU, and can store the one or more customer parameters in association with the adaptive SKU data structure. In some embodiments, the one or more customer parameters can include one or more combination rules that define, for the adaptive SKU, permitted substitutions in which one SKU identifier in the ordered list can be replaced with a different SKU identifier. In some embodiments, the combination rules can be applied in conjunction with executable membership rules stored in the rule field of the adaptive SKU data structure to determine compatibility, procedural alignment, or quantity propagation effects prior to substitution.

In some embodiments, the one or more customer parameters can include inventory values for the adaptive SKU at a plurality of sites of the customer entity, and the system 300 can store the inventory values in association with the adaptive SKU data structure. The inventory values can be stored as site-specific data records linked to the adaptive SKU schema via foreign key associations to facilitate multisite allocation visibility and coordinated redistribution actions. The system 300 can determine that an inventory value for the adaptive SKU at a first site satisfies a threshold condition based on the stored inventory values, and, responsive to the threshold condition (e.g., the inventory value reaching a defined limit or falling outside a defined range), can trigger a membership modification of the ordered list using at least one executable membership rule stored in the rule field.

In some embodiments, the one or more customer parameters can include at least one site level constraint specifying site-specific ordering limits or allocation limits for at least one SKU identifier in the ordered list, and the ordering interface can enforce the site level constraint when processing an order request. In this regard, enforcement can be performed by validating order request quantities against stored site-level constraint parameters prior to fulfillment to prevent processing when requested allocations exceed permissible thresholds for the site. A threshold can be referred to as a defined limit, a permitted range, or a trigger condition for initiating or preventing processing.

In some embodiments, the one or more customer parameters can further include transition calendar data associated with at least one customer site, warehouse, or both, such that transition timing for a first SKU combination and a second SKU combination can vary by customer, by site, or by warehouse. The transition calendar data can identify planned transition dates, approval milestones, confidence levels, or exception states for one or more underlying SKU identifiers or SKU combinations. In some embodiments, the system 300 can process a shared transition calendar across multiple teams and can apply warehouse-specific transition logic such that a first warehouse can continue fulfillment according to a first transition schedule while a second warehouse fulfills according to a second transition schedule for the same procedure type or adaptive SKU.

The customer system integration manager 306 can receive, via the ordering interface, a transition request from the customer entity to transition from a first combination of the plurality of SKUs to a second combination of the plurality of SKUs, and the adaptive SKU manager 302 can modify the membership field responsive to the transition request using at least one executable membership rule stored in the rule field. Upon receiving the transition request, the adaptive SKU manager can retrieve applicable membership rules from the rule field, validate procedural compatibility of the second combination, and execute a coordinated membership field modification that maintains consistency of the dependency field relationships.

The customer system integration manager 306 can transmit, via a network interface, an update message identifying an availability change, recall event, or substitution event associated with an underlying SKU identifier. The network interface can include an API, receipt of network packets or payloads, bidirectional application-to-application or system-to-system messaging, one or more configured adapters, or protocol specific communications. In some embodiments, the customer system integration manager 306 can detect the availability change, recall event, or substitution event associated with the underlying SKU identifier based on customer-provided inventory messages, order cart data, episodic alerts, or event-driven inventory updates. The customer system integration manager 306 can process in-progress order cart data to inform demand forecasting or SKU allocation configurations. The update message identifying the change event can correspond to a supply disruption, substitution notice, or availability transition received asynchronously from one of the systems of the customer entity.

The system 300 can include, interface with, communicate with, or otherwise utilize a distributor system integration manager 308. The distributor system integration manager 308 can be or include any script, file, program, application, set of instructions, or computer-executable code that can be configured to receive distributor data via one or more interfaces. Various system components can retrieve data through the distributor system integration manager 308, including projected SKU delivery timelines, actual delivery records, SKU inventory states, or shipment status updates. The distributor system integration manager 308 can receive demand forecast data, including forecast data from external forecasting platforms such as Netstock, and partner or third-party logistics (3PL) lot management data from partner enterprise resource planning systems.

The distributor system integration manager 308 can retrieve an expected shipment of one or more of the plurality of SKUs, where the plurality of parameters can include the expected shipment. The distributor system integration manager 308 can retrieve inventories of the entity with lot, expiry, or backorder information, where the plurality of parameters can include the inventories. The distributor system integration manager 308 can process distributor-specific rule sets or operational parameters to dynamically adjust SKU management logic.

The distributor system integration manager 308 can interface with the forecasting engine 304 to incorporate distributor-defined allocation strategies, rules, or data into inventory forecasting models. The distributor system integration manager 308 can configure rule-based processing frameworks for margin analysis, defect resolution, or backorder processing. The distributor system integration manager 308 can integrate such rule sets into processing or execution models, such as an orchestration engine 322, to improve SKU distribution logic.

The distributor system integration manager 308 can establish one or more connections via one or more interfaces to the one or more systems of the entity. In this regard, the entity can refer to a distributor, supplier, third-party logistics provider, fulfillment provider, or another organization that can provide, manage, or facilitate delivery of one or more SKUs. In some embodiments, the distributor system integration manager 308 can establish an authenticated interface session with a distributor system to exchange inventory or fulfillment messages. The distributor system integration manager 308 can maintain the connection by periodically transmitting heartbeat messages, keep-alive messages, or status queries to detect connectivity disruptions or data synchronization failures. For example, the distributor system integration manager 308 can transmit a status query every five minutes to verify that the connection to a warehouse management system remains active and that inventory data remains synchronized with the adaptive SKU data structure.

In some embodiments, the distributor system integration manager 308 can interface with enterprise resource planning (ERP) systems to synchronize item data configured by purchasing, customer service, or commercial teams. The distributor system integration manager 308 can integrate with warehouse management systems (WMS) to track shipment status and inventory across distribution centers. The distributor system integration manager 308 can connect with supplier electronic data interchange (EDI) systems to retrieve expected delivery dates. The distributor system integration manager 308 can interact with transportation management systems (TMS) to compare expected and actual delivery timelines. The distributor system integration manager 308 can communicate with third-party logistics providers and supplier networks to manage shared lot responsibilities.

The distributor system integration manager 308 can receive one or more operational constraints from one or more systems of an entity that provides units of at least one or more SKUs for the adaptive SKU or the combination SKU, where the one or more operational constraints can define at least a portion of a plurality of parameters used by the system 300 to manage the adaptive SKU and to determine an action to take with respect to the adaptive SKU in response to a change event associated with an underlying SKU identifier. The entity can include a distributor system that supplies units of at least a subset of the plurality of SKUs. The operational constraints can include distributor-provided constraints encoded in machine-readable constraint data specifying available-to-promise inventory for one or more SKUs, lot attributes, expiry attributes, backorder attributes, shipment timing constraints, or substitution eligibility constraints. For example, the distributor system integration manager 308 can receive operational constraints from a distributor enterprise resource planning system specifying an available-to-promise inventory quantity of fifty units for a guidewire SKU, lot attributes indicating a lot number range of 1000-1050, expiry attributes specifying an expiration date threshold of ninety days from a current date, backorder attributes indicating that a catheter SKU is currently backordered with an expected restocking date of fifteen days from the current date, shipment timing constraints indicating that replenishment orders demand a minimum lead time of seven days, and substitution eligibility constraints indicating that the catheter SKU can be replaced with an alternative catheter SKU having a different supplier identifier provided that the alternative catheter SKU satisfies procedural compatibility requirements stored in the rule field of the adaptive SKU data structure. The distributor system integration manager 308 can store the one or more operational constraints in association with the adaptive SKU data structure, including as additional data fields within the adaptive SKU data structure schema or as linked data records in a relational database table that references the adaptive SKU data structure via a foreign key relationship.

The distributor system integration manager 308 can receive, via one or more interfaces to a distributor system, distributor data that identifies delivery dates for at least one underlying SKU identifier of the membership field. The delivery dates can include at least one of an expected delivery date or an actual delivery date. In some embodiments, the distributor system integration manager 308 can serve or function as an integration manager that provides the distributor data to the forecasting engine 304. The forecasting engine 304 can refine an initial quantity estimate for the adaptive SKU for a given time period by applying a refinement operation that updates the initial quantity estimate based on the distributor data, including delivery dates for the at least one underlying SKU identifier, to generate a refined quantity for the given time period. The forecasting engine 304 can store the refined quantity in association with the adaptive SKU identifier.

The distributor system integration manager 308 can transmit, via a network interface, an update message identifying an availability change, recall event, or substitution event associated with an underlying SKU identifier. In some embodiments, the distributor system integration manager 308 can detect the availability change, recall event, or substitution event associated with the underlying SKU identifier based on distributor inventory data, lot status data, backorder data, shipment timing data, or substitution notifications received from one or more distributor systems.

The system 300 can include, interface with, communicate with, or otherwise utilize an inventory navigator 310. The inventory navigator 310 can be or include any script, file, program, application, set of instructions, or computer-executable code that can be configured to provide adaptive, intelligent, or user-driven inventory management in accordance with procedural workflows or organizational objectives. The inventory navigator 310 can allow users, such as members of purchasing or commercial teams, to establish business rules or preferences that facilitate inventory planning and execution. The inventory navigator 310 can define such preferences by implementing predictive analytics, which use machine learning-driven procedure forecasts and financial data (e.g., pricing or margin) to recommend or generate outputs. Users can also establish conditional and passive preferences, which can be triggered by specific conditions or followed in order of priority, with or without additional approvals.

The inventory navigator 310 can facilitate margin improvements by substituting higher-margin SKUs or SKU combinations. The inventory navigator 310 can facilitate expiry management by incentivizing the use of specific lots within defined expiry parameters, for example, through price-based incentives. The inventory navigator 310 can provide defect and recall workflows by removing affected or impacted SKUs or lots from SKU combinations and substituting valid alternatives. The inventory navigator 310 can manage backorder and allocation instances by allowing users to define rules for prioritizing SKU allocation across customers or distribution centers during SKU shortages.

The inventory navigator 310 can facilitate SKU migration management to guide the transition from older to newer SKUs due to changes in medical equipment, best practices, or regulatory requirements. Such migration events can be triggered when inventory levels at customer sites fall below a threshold, when supplier deliveries are delayed, or when redistribution is desired across multiple sites. In this regard, a threshold can refer to a defined inventory quantity, a limit, or a calculated inventory level that, when reached or crossed, initiates an action or an execution logic.

The inventory navigator 310 can incorporate natural language processing (NLP) capabilities that can allow users to model scenarios or instances and explore options by submitting natural language queries. For example, a purchasing manager can inquire, “If we only have X inventory of SKU ABC, what is the most profitable way to configure SKU combinations to keep Customer 101 fully stocked until this date?”

The inventory navigator 310 can integrate with transportation management systems (TMS), electronic data interchange (EDI) feeds, and warehouse management systems (WMS), as well as customer inventory and forecast data, to identify anomalies such as delayed shipments or projected shortfalls. The inventory navigator 310 can implement natural language processing to evaluate communications from suppliers, customers, and carriers for potential issues, triage anomalies based on ranking or priority levels, and present recommended actions that users can execute through natural language inputs.

The inventory navigator 310 can execute certain actions based on defined thresholds and conditions or escalate such actions for approval. The inventory navigator 310 can facilitate real-time collaboration among stakeholders, retain a shared history of determinations and alerts for traceability, and integrate with enterprise resource planning (ERP) systems or customer relationship management (CRM) systems to maintain continuous data flow and maintain a comprehensive customer view.

The inventory navigator 310 can respond to shipment tracking inquiries, delivery delays, and other queries with current, accurate information. The inventory navigator 310 can facilitate guided issue resolution via NLP chatbots that can allow the customers initiate refunds or reschedule shipments for missed or damaged deliveries. The inventory navigator 310 can further allow customers or users to define recommended usage and purchase factor ranges for each SKU combination, prioritize sites for receiving certain SKU combinations or lots, sequence SKU migrations based on specific business rules, and review or approve recommended SKU changes.

The system 300 can include, interface with, communicate with, or otherwise utilize a customer manager 312. The customer manager 312 can be or include any script, file, program, application, set of instructions, or computer-executable code that can be configured to manage and process customer-specific preference parameters, including SKU management configurations within an adaptive SKU framework. The inventory navigator 310 can include or integrate the customer manager 312. The customer manager 312 can present a control panel that allows users to configure SKU selection parameters based on operational criteria, define purchase factor thresholds for SKU groupings, establish priority associations between specific sites and SKU allocations, sequence SKU migrations according to structured business logic, or validate recommended SKU modifications. The customer manager 312 can define conditional or passive preference parameters that activate based on system-detected conditions or require authorization based on predefined priority levels. The customer manager 312 can incorporate such parameters into SKU allocation processes to regulate usage thresholds or prioritization mechanisms within the adaptive SKU framework. The customer manager 312 can interact with the forecasting engine 304 to update forecast models based on historical data trends or customer-specific procurement patterns.

The customer manager 312 can monitor and perform adjustments based on disruptions or exceptions by integrating with a proactive monitoring engine that implements TMS, EDI feeds, and WMS. Such integration allows the customer manager 312 to identify anomalies such as delayed shipments, delayed orders, or projected inventory shortfalls. The customer manager 312 can implement a control interface to triage such anomalies based on ranking or priority levels, recommend actions to users, and execute certain actions without user intervention if predefined thresholds are met or, alternatively, route them for approval. In some embodiments, a central communication hub can facilitate real-time collaboration among relevant stakeholders, maintaining a shared record of determinations, actions, alerts, and discussions for easy review. ERP and CRM integrations can allow the customer manager 312 to feed data back into enterprise systems continuously to facilitate a customer view and streamlined workflows. In some embodiments, the customer manager 312 can provide an NLP real-time assistant to process queries about shipment tracking, delivery delays, or other immediate customer needs. The customer manager 312 can also incorporate an NLP guided issue resolution feature (e.g., NLP chatbots), which can guide customers or users through step-by-step procedures for resolving disruptions such as missed deliveries or damaged goods.

The system 300 can include, interface with, communicate with, or otherwise utilize a distributor manager 314. The distributor manager 314 can be or include any script, file, program, application, set of instructions, or computer-executable code that can be configured to process distributor-defined parameters for managing SKU allocations within an adaptive SKU framework. The inventory navigator 310 can include or integrate the distributor manager 314. The distributor manager 314 can receive and store distributor-specific rule sets associated with SKU substitution logic, inventory prioritization, or procurement adjustments. The distributor manager 314 can configure rule-based processing frameworks for margin analysis, expiry tracking, defect resolution, recall processing, backorder fulfillment, or SKU transition management.

In some embodiments, the distributor manager 314 can maintain distributor preference metadata identifying one or more preferred distributors for a type of procedure in association with the adaptive SKU data structure. The distributor preference metadata can include a preferred distributor identifier field that stores an identifier of a distributor entity, a procedure type identifier field that associates the preferred distributor with a specific procedure type stored in the procedure-key field of the adaptive SKU data structure, and a preference ranking field that specifies a numerical priority value indicating a relative preference level among a plurality of candidate distributors. For example, the distributor manager 314 can maintain distributor preference metadata for a cardiac catheterization procedure that includes a preferred distributor identifier field storing an identifier of a first distributor entity, a procedure type identifier field storing an identifier of the cardiac catheterization procedure, and a preference ranking field storing a numerical priority value of one, indicating that the first distributor entity has the highest preference level for fulfillment of orders associated with the cardiac catheterization procedure. The distributor manager 314 can receive the distributor preference metadata from the customer manager 312, which can retrieve customer-defined preferences specifying preferred distributor relationships based on historical delivery performance, cost structures, or contractual agreements. The distributor manager 314 can store the distributor preference metadata as linked data records in a relational database table that references the adaptive SKU data structure via a foreign key relationship. The orchestration engine 322 can retrieve the distributor preference metadata when determining an action to take with respect to the adaptive SKU in response to receiving a change event.

The distributor manager 314 can execute programmatic adjustments to SKU selection logic based on profitability models, where margin analysis includes substituting higher-margin SKUs or SKU groupings to enhance revenue performance. The distributor manager 314 can process expiry-based inventory adjustments and apply programmatic price recalibrations or lot prioritization mechanisms to mitigate inventory obsolescence. The distributor manager 314 can facilitate defect and recall management by programmatically identifying, flagging, or replacing impacted SKUs or lot allocations. The distributor manager 314 can execute allocation logic for backordered SKUs by applying prioritization rules and distribution rules across customer sites and distribution nodes.

The distributor manager 314 can manage SKU transition workflows and facilitate SKU replacements due to updated medical protocols, regulatory adjustments, or equipment standardization updates. The distributor manager 314 can initiate SKU combination modifications when an existing SKU approaches a predefined inventory threshold, including based on the in-transit time (e.g., a time period between shipment dispatch and shipment arrival) for an incoming shipment. The distributor manager 314 can dynamically adjust SKU substitutions based on real-time or near real-time expected delivery updates. The distributor manager 314 can reallocate SKU inventory across distribution nodes, customer sites, and fulfillment centers to maintain inventory availability while adapting to supply chain fluctuations.

In some embodiments, the distributor manager 314 can integrate with or be configured for access through an inventory navigator settings panel to allow distributors to manage margin improvement, expiry management, defect and recall handling, backorder and allocation rules, and SKU migration triggers from a centralized interface. In some embodiments, the distributor manager 314 can integrate with or feed information to a planner assistant to allow purchasing or distribution teams to ask scenario-based questions (e.g., “If we only have X inventory of ABC SKU, how should we allocate SKUs to maintain service levels?”). In this regard, the planner assistant can be implemented as an NLP planner assistant.

The system 300 can include, interface with, communicate with, or otherwise utilize an exception control manager 316. The exception control manager 316 can be or include any script, file, program, application, set of instructions, or computer-executable code that can be configured to manage and triage anomalies or exceptions. The inventory navigator 310 can include or integrate the exception control manager 316. The exception control manager 316 can implement smart alerting features that use NLP techniques to evaluate notifications from suppliers, customers, or carriers to detect potential issues or anomalies. The exception control manager 316 can present an exception control panel that can be configured to identify anomalies based on the corresponding impact, ranking, or priority levels, recommend actions or system outputs to users, and allow the users to trigger or modify actions through natural language inputs. The exception control manager 316 can automatically execute certain actions or operations without user intervention if predefined thresholds or conditions are satisfied or, alternatively, route them for approval. The exception control manager 316 can provide a central communication hub that allows relevant stakeholders to collaborate in real time, maintain a record of actions and alerts, and effectively manage exceptions.

The system 300 can include, interface with, communicate with, or otherwise utilize a proactive monitoring engine 318. The proactive monitoring engine 318 can be or include any script, file, program, application, set of instructions, or computer-executable code that can be configured to integrate with TMS to track shipment statuses, with EDI feeds for supplier shipment updates, and with WMS for order fulfillment. The inventory navigator 310 can include or integrate the proactive monitoring engine 318. The proactive monitoring engine 318 can be configured to reference customer forecasts and on-hand inventories to identify anomalies such as delayed shipments, delayed orders, or projected inventory shortfalls. The proactive monitoring engine 318 can generate and transmit anomaly notifications as update messages via a network interface to trigger configuration updates.

The customer system integration manager 306 can transmit, via a network interface, an update message identifying an availability change, recall event, or substitution event associated with an underlying SKU identifier. The distributor system integration manager 308 can transmit, via a network interface, an update message identifying an availability change, recall event, or substitution event associated with an underlying SKU identifier. The proactive monitoring engine 318 can receive an asynchronous event notification from the entity indicating at least one of a stock-out condition, a recall, an expiry-related restriction, a backorder status change, or a substitution notice for a first SKU, for instance. In some embodiments, the system 300, including one or more of the proactive monitoring engine 318, the customer system integration manager 306, the distributor system integration manager 308, or the orchestration engine 322, can detect an availability change, recall event, or substitution event associated with an underlying SKU identifier in the membership field based on the update message or the asynchronous event notification received via the network interface. The underlying SKU identifier can refer to an identifier of an individual stock-keeping unit included in the ordered list stored in the membership field of the adaptive SKU data structure.

In some embodiments, the asynchronous event notification can be transmitted by the distributor system integration manager 308 in response to detecting a change in inventory availability, lot status, or shipment timing for the corresponding SKU. For example, the distributor system integration manager 308 can receive, from a warehouse management system via an electronic data interchange feed, an asynchronous event notification indicating that a catheter SKU has transitioned from an available status to a backordered status with an expected restocking date of fifteen days from thecurrent date, and can provide the asynchronous event notification to the proactive monitoring engine 318. The asynchronous event notification can include machine-readable event data that can specify an event type field identifying the type of change event (such as stock-out, recall, expiry-related restriction, backorder status change, or substitution notice), an affected SKU identifier field storing an identifier of the SKU, and an event parameter field storing additional attributes such as an expected restocking date, a recall lot number, an expiry date threshold, or a substitute SKU identifier. The proactive monitoring engine 318 can parse the asynchronous event notification to extract the event type, the affected SKU identifier, and the event parameters, and can transmit the extracted data to the orchestration engine 322 to initiate a determination of an action based on the operational constraints stored in association with the adaptive SKU data structure and the change event identified in the asynchronous event notification.

The system 300 can include, interface with, communicate with, or otherwise utilize a predictive analyzer 320. The predictive analyzer 320 can be or include any script, file, program, application, set of instructions, or computer-executable code that can be configured to implement machine learning-based procedure forecasts and financial data, such as pricing and margin, to generate analytics that inform recommended outputs or actions for the purchasing team. The inventory navigator 310 can include or integrate the predictive analyzer 320. The predictive analyzer 320 can process historical procedure data, inventory data, or operational parameter data to identify trends or generate predictive outputs associated with adaptive SKU configuration and inventory planning. The predictive analyzer 320 can provide predictive scores, rankings, or recommendation data to the inventory navigator 310, the forecasting engine 304, or the orchestration engine 322 for use in evaluating candidate SKU combinations or inventory actions.

The system 300 can include, interface with, communicate with, or otherwise utilize an orchestration engine 322. The orchestration engine 322 can be or include any script, file, program, application, set of instructions, or computer-executable code that can be configured to receive a procedure identifier corresponding to a specified procedural type or category. The orchestration engine 322 can process an identifier linked to an adaptive SKU for procedural association. The orchestration engine 322 can execute SKU selection logic by identifying an adaptive SKU. The orchestration engine 322 can retrieve configuration parameters defining SKU combinations and associated SKUs.

The system 300 can include one or more processors and a non-transitory computer-readable medium storing instructions that, when executed by the one or more processors, cause the system 300 to receive, by the orchestration engine 322, procedure data from a plurality of heterogeneous source systems. The procedure data can include the procedure identifier and a projected volume for the type of procedure. Heterogeneous source systems can refer to different source systems that vary in data format, schema, interface, protocol, structure, or originating platform. The system 300 can store, in memory, a mapping data structure having a schema that includes a procedure-identifier mapping that can map procedure identifiers received from the plurality of heterogeneous source systems to a canonical procedure identifier, and an SKU-identifier mapping that can map SKU identifiers received from the plurality of heterogeneous source systems to canonical SKU identifiers.

The system 300 can store, in memory, for at least one adaptive SKU identifier, a combination SKU record having a schema that includes a membership field storing an ordered list of canonical SKU identifiers for a plurality of constituent SKUs for the type of procedure, a quantity-range field storing dynamic quantity ranges for at least a subset of the plurality of constituent SKUs, a rule field storing executable combination rules that define permitted membership modifications to the membership field, including at least one of combining, adding, removing, or substituting one constituent SKU with another constituent SKU, and a dependency field storing quantity relationship entries that each define a propagation rule mapping a quantity change of a first constituent SKU to a quantity change of a second constituent SKU, for instance. As used herein, a “constituent SKU” and an “underlying SKU” can refer to the same SKU item represented within a combination SKU or adaptive SKU configuration. In some embodiments, a “combination SKU record” can be an instance of, or can be stored using, the adaptive SKU data structure described herein.

The orchestration engine 322 can transform, using the mapping data structure, the procedure data into a procedure record associated with the canonical procedure identifier. In some embodiments, transforming the procedure data into the procedure record can include resolving at least two different source-system procedure identifiers to the canonical procedure identifier and de-duplicating or consolidating multiple source-system procedure data records that map to the canonical procedure identifier for a given time period into the procedure record. In some embodiments, the orchestration engine 322 can apply the procedure-identifier mapping to resolve at least two different source-system procedure identifiers to the canonical procedure identifier. In some embodiments, when multiple procedure data records received for a given time period from different source systems map to the same canonical procedure identifier, the orchestration engine 322 can de-duplicate, merge, or otherwise consolidate the multiple procedure data records into a single canonical procedure record associated with the canonical procedure identifier for the given time period. The single canonical procedure record can be stored in memory and reused during subsequent orchestration operations for the given time period to reduce repeated identifier reconciliation and repeated procedure-record construction from source-system data. In some embodiments, the orchestration engine 322 can transform inventory data received from the plurality of heterogeneous source systems using the SKU-identifier mapping into a canonical inventory record that references canonical SKU identifiers corresponding to the membership field.

The orchestration engine 322 can receive factor-based data including operational parameter values correlated with anticipated consumption or processing of at least one constituent SKU independent of the projected volume. The orchestration engine 322 can receive preference data and store the preference data in a preference profile record associated with at least one site identifier. In some embodiments, the preference profile record can be cached in memory and reused across a plurality of orchestration cycles for the given time period to generate the plurality of candidate combination SKU record identifiers without repeatedly reconstructing site-specific preference data from source-system inputs. In some embodiments, the factor-based data, the procedure data, and the inventory data can be transformed into a canonical feature representation according to a defined source-agnostic feature schema shared across a plurality of heterogeneous source systems, such that subsequent scoring or forecasting operations can reuse the canonical feature representation without repeated re-parsing of source-specific input fields.

In some embodiments, the system 300 caches, in volatile memory or non-volatile memory, at least one of the procedure-identifier mapping, the SKU-identifier mapping, the procedure record associated with the canonical procedure identifier (including In some embodiments the single canonical procedure record for the given time period), or the preference profile record associated with at least one site identifier. The orchestration engine 322 can reuse the cached mapping, record, or profile during at least one subsequent orchestration cycle for the given time period without re-transforming source-system identifiers or re-constructing the procedure record from source-system data to reduce processor utilization and memory allocation associated with repeated mapping operations and repeated record construction.

The orchestration engine 322 can generate, by executing one or more trained machine learning models, a plurality of candidate combination SKU record identifiers and corresponding score values based on at least the canonical procedure record, the factor-based data, inventory data, or the preference profile record. The orchestration engine 322 can select a target combination SKU record identifier based on the score values and at least one rule-based selection criterion, condition, or constraint. In some embodiments, the orchestration engine 322 can filter candidate combination SKU records based on executable combination rules to exclude any candidate that is not permitted for a preference profile record associated with at least one site identifier. In some embodiments, selecting the target combination SKU record identifier can include enforcing a hard constraint that excludes from selection any candidate combination SKU record whose membership field includes a constituent SKU indicated by the inventory data as unavailable for the given time period to reduce compute consumption associated with scoring, quantity computation, or quantity propagation for infeasible candidate configurations.

The orchestration engine 322 can compute quantities for at least a subset of the plurality of constituent SKUs by applying at least one dynamic quantity range in the quantity-range field and applying at least one propagation rule in the dependency field. In some embodiments, the orchestration engine 322 can apply the dynamic quantity range as a bounded constraint on a base quantity derived from a projected procedure volume and can apply, using the dependency field, at least one propagation rule that adjusts a quantity of a second constituent SKU responsive to the bounded quantity of a first constituent SKU. For example, the orchestration engine 322 can determine a base quantity of ten units for a first constituent SKU from a projected procedure volume, constrain the base quantity to a dynamic quantity range of eight to twelve units, and apply a propagation rule that sets a quantity of a second constituent SKU to five units.

The orchestration engine 322 can perform an incremental recomputation operation that updates quantities for an affected subset of the plurality of constituent SKUs responsive to at least one of a change in inventory data, a change in preference data, or execution of at least one executable combination rule, and can commit an updated quantity state to memory in association with the selected target combination SKU record identifier. In some embodiments, the orchestration engine 322 can identify the affected subset of constituent SKUs by traversing quantity relationship entries incident to a changed constituent SKU and can update quantities for the affected subset without recomputing quantities for unaffected constituent SKUs. Affected constituent SKUs can refer to constituent SKUs that are directly or indirectly impacted by a change in another constituent SKU, a quantity, a dependency relationship, or a membership modification. In some embodiments, the orchestration engine 322 can commit the updated quantity state to memory after updating quantities for the affected subset of constituent SKUs and without performing full recomputation for some or all constituent SKUs in the membership field to reduce recomputation relative to updating quantities for some or all of the plurality of constituent SKUs.

The orchestration engine 322 can generate action parameters for the adaptive SKU by executing one or more machine learning models 324. The machine learning model 324 can be similar to and incorporate any of the structure and functionality of the machine learning models described in connection with FIGS. 2A-2B. In some embodiments, the machine learning model 324 can be continuously trained via a machine learning operations (MLOps) pipeline to maintain iterative improvements and deployment of the trained machine learning models. The machine learning model 324 can process demand forecast data, inventory datasets, procedural classification parameters, or distributor-defined selection criteria or parameters. The system 300 can cache the adaptive SKU data structure in memory as a retrievable procedure-level execution unit to reduce repeated rule evaluation across multiple inventory transactions.

In some embodiments, the adaptive SKU data structure can be executable in multiple respects or can function as an execution unit for one or more operations of the system 300. For example, the adaptive SKU data structure can include one or more fields that store executable rules, logic references, dependency entries, parameters, thresholds, preferences, or condition values that are retrievable and usable by one or more processors during execution of selection operations, substitution operations, quantity recomputation operations, monitoring operations, forecasting operations, or transaction operations. In some embodiments, a rule field of the adaptive SKU data structure can store executable membership rules, and a dependency field of the adaptive SKU data structure can store propagation logic or quantity relationship entries that are executable to determine changes to quantities or membership of underlying SKU identifiers. The system 300 can retrieve and execute the adaptive SKU data structure as a whole, such as a procedure-level execution unit, or can retrieve and execute one or more portions of the adaptive SKU data structure, such as one or more fields, entries, or stored values, to perform a corresponding operation.

The orchestration engine 322 can receive, via a network interface, an update message identifying a change event for an underlying SKU identifier and transmit a substitution event notification based on the change event to the adaptive SKU manager 302 for membership modification or quantity recomputation. In some embodiments, the update message identifies the change event for a first underlying SKU identifier, for instance, stored in the membership field of the adaptive SKU data structure. The orchestration engine 322 can determine an action to take with respect to the adaptive SKU based at least on the one or more operational constraints received from the distributor system integration manager 308 and the change event identified in the update message. In some embodiments, the orchestration engine 322 can enforce a constraint that prevents selection of a candidate combination SKU record that includes a constituent SKU having an inventory state indicative of unavailability for a given time period.

In some embodiments, the orchestration engine 322 can execute at least one executable rule stored in the rule field to modify the membership field by at least one of replacing a first SKU with another SKU, adding an additional SKU, or removing an SKU. The orchestration engine 322 can perform an incremental recomputation operation that can update quantities for a subset of the plurality of SKUs affected by the modification of the membership field by applying one or more quantity relationship entries in the dependency field. The orchestration engine 322 can execute the determination of the action and the performance of the incremental recomputation operation as a single coordinated transaction to prevent cascading recalculation cycles triggered by independent SKU-level updates. For example, the orchestration engine 322 can receive a change event notification indicating that a catheter SKU has transitioned to a backordered status with an expected restocking date of fifteen days from the current date. The orchestration engine 322 can retrieve an executable rule from the rule field specifying that, when a catheter SKU receives a backorder status change, the catheter SKU is to be replaced with an alternative catheter SKU that satisfies procedural compatibility constraints and has an available-to-promise inventory quantity greater than zero units, and can execute the executable rule to replace the catheter SKU identifier in the membership field with an alternative catheter SKU identifier. The orchestration engine 322 can perform an incremental recomputation operation that recalculates a quantity for a guidewire SKU from ten units to twelve units by applying a quantity relationship entry in the dependency field specifying that substitution of the catheter SKU triggers a proportional adjustment to the guidewire SKU quantity.

In some embodiments, the dependency field can store quantity relationship entries that define distributor-aware quantity propagation rules that update quantities for the subset of SKUs affected by the membership modification without recomputing quantities for unaffected SKUs. For example, the dependency field can store a quantity relationship entry specifying that a quantity change in the catheter SKU triggers a proportional quantity change in the guidewire SKU based on a usage factor ratio, and can store a second quantity relationship entry specifying that a contrast agent SKU quantity remains unchanged when the catheter SKU is substituted, such that the incremental recomputation operation recalculates quantities for the catheter SKU and the guidewire SKU without recalculating the quantity for the contrast agent SKU.

The orchestration engine 322 can implement a multi-tiered recommender framework that can combine or aggregate data from ERP and WMS, vendor or customer preferences, and real-time inventory states to generate and score multiple SKU set recommendations. Such recommendations can incorporate SKU-to-SKU conversion mappings, maintained through regular usage factor updates, and internal objectives such as depleting short-dated inventory or prioritizing SKUs associated with rebate opportunities. In some embodiments, the orchestration engine 322 can use customer-defined preferences and internal organization logic to refine recommendation rankings, including goals such as reducing short-dated inventory, deprioritizing deprecated SKUs, or promoting rebate-eligible products.

In some embodiments, distributors can configure the orchestration engine 322 to define the extent of automated action execution. The execution scope can be dynamically adjusted based on procedural complexity, procurement policies, or predefined operational parameters. For example, a distributor can configure the orchestration engine 322 to execute a substitution of an unavailable SKU when the substitution satisfies stored compatibility rules and inventory availability constraints, while routing a shipment delay action for approval when the delay exceeds a predefined time limit. In some embodiments, the orchestration engine 322 can implement parameterized configurations to adapt to evolving network environments or product cycles to provide flexible reconfiguration of selection rules, weighting criteria, or approval thresholds.

The orchestration engine 322 can select a distributor-level fulfillment action based at least on the one or more operational constraints provided by the entity. In some embodiments, the distributor-level fulfillment action can include at least one of initiating a replenishment order, delaying a shipment associated with the adaptive SKU, splitting a shipment across multiple fulfillment windows, or rerouting fulfillment to an alternate distributor endpoint. For example, the orchestration engine 322 can retrieve operational constraints from the distributor system integration manager 308 indicating that a backordered catheter SKU has an expected restocking date of three days from a current date. The orchestration engine 322 can invoke the machine learning model 324 to generate action scores for candidate distributor-level fulfillment actions including initiating a replenishment order for an alternative catheter SKU, delaying a shipment associated with the adaptive SKU by three days to await restocking of the backordered catheter SKU, splitting a shipment such that a first fulfillment window includes SKUs that are currently available and a second fulfillment window includes the backordered catheter SKU upon restocking, and rerouting fulfillment to an alternate distributor endpoint that has available inventory of the backordered catheter SKU. The orchestration engine 322 can compare the generated action scores for the candidate distributor-level fulfillment actions. The orchestration engine 322 can select the distributor-level fulfillment action of delaying the shipment when the machine learning model 324 assigns the highest action score to the delaying action based on a determination that delaying the shipment reduces total procurement cost relative to initiating a replenishment order for the alternative catheter SKU, for instance.

In some embodiments, the one or more operational constraints can further include warehouse-specific transition parameters that define when a first warehouse is permitted to transition from a first SKU combination to a second SKU combination relative to one or more other warehouses. Such warehouse-specific transition parameters can include scheduled transition dates, depletion thresholds, receipt conditions, approval milestones, or confidence levels associated with expected inventory availability.

In some embodiments, the system 300 can apply such parameters to maintain different transition logic for different warehouses while coordinating fulfillment for a common customer or procedure type. In some embodiments, the system 300 can generate exception alerts associated with the warehouse-specific transition parameters, including alerts for excessive ordering relative to a transition plan, days-on-hand threshold violations, missed transition milestones, or vendor shortfalls that can affect a planned transition. The system 300 can further compare alternative scenarios associated with a delayed warehouse transition or schedule slip and can determine a distributor-level fulfillment action based on the comparison.

The orchestration engine 322 can perform a substitution that replaces the first SKU with another SKU permitted by distributor substitution constraints while maintaining compatibility across the ordered list of identifiers in the membership field. For example, the orchestration engine 322 can retrieve distributor substitution constraints from the operational constraints received from the distributor system integration manager 308 indicating that a catheter SKU having a first supplier identifier can be replaced with an alternative catheter SKU having a second supplier identifier provided that the alternative catheter SKU satisfies procedural compatibility requirements stored in the rule field. The orchestration engine 322 can execute an executable rule from the rule field to determine that the alternative catheter SKU satisfies the procedural compatibility requirements by verifying that the alternative catheter SKU has a matching diameter specification and a matching length specification relative to the first catheter SKU, for instance. The orchestration engine 322 can replace the first catheter SKU identifier in the membership field with the alternative catheter SKU identifier while maintaining compatibility across the ordered list by maintaining the alternative catheter SKU identifier in the same position in the ordered list as the first catheter SKU identifier occupied prior to substitution.

In some embodiments, the orchestration engine 322 can select a preferred distributor based at least on the distributor preference metadata maintained by the distributor manager 314 and one or more operational constraints when determining the action. For example, the orchestration engine 322 can retrieve distributor preference metadata from the distributor manager 314 indicating that a first distributor entity has a preference ranking value of one for fulfillment of orders associated with a cardiac catheterization procedure, for instance. The orchestration engine 322 can retrieve operational constraints from the distributor system integration manager 308 indicating that the first distributor entity has an available-to-promise inventory quantity of fifty units for a guidewire SKU and a shipment timing constraint indicating a minimum lead time of seven days. The orchestration engine 322 can select the first distributor entity as the preferred distributor for fulfillment of a replenishment order for the guidewire SKU when the requested delivery date is at least seven days from a current date.

In some embodiments, the orchestration engine 322 can initiate, via one or more second or additional interfaces to a supplier system, an order for one or more units associated with at least one SKU identifier in the ordered list based at least on one or more customer parameters. In some embodiments, the one or more second or additional interfaces can include interfaces provided through the distributor system integration manager 308 to communicate with a supplier system or a distributor system for fulfillment of the order. The orchestration engine can perform such initiation through the distributor system integration manager 308, such that supplier orders can comply with operational constraints and delivery timing parameters associated with the distributor system. The orchestration engine 322 can apply rule-based selection algorithms to associate an adaptive SKU with a customer order. The orchestration engine 322 can initiate, via one or more interfaces, an order of one or more units of the adaptive SKU from the entity based at least on the plurality of parameters for the adaptive SKU.

In some embodiments, responsive to selecting the target combination SKU record identifier, the orchestration engine 322 can initiate execution of at least one downstream inventory action using the computed quantities. The downstream inventory action can include at least one of generating a replenishment instruction, triggering a redistribution operation among sites, or updating an availability state for the selected combination SKU, without recomputing quantities for unaffected constituent SKUs or unaffected portions of the selected combination SKU record. The orchestration engine 322 can reference dynamic quantity factor ranges to compute procurement quantities.

The orchestration engine 322 can trigger a redistribution of one or more units associated with the adaptive SKU across the plurality of sites based at least on the inventory values and the one or more customer parameters. Redistribution can be executed via orchestration commands issued through the distributor system integration manager 308. The orchestration commands can specify source site identifiers, destination site identifiers, SKU quantities, and scheduling parameters for facilitating the coordinated transfer of stock between sites. The orchestration engine 322 can determine a recommended configuration of the adaptive SKU for the customer entity. The recommended configuration can identify at least one of a modified ordered list of SKU identifiers or a modified set of the one or more customer parameters. In some embodiments, the recommended configuration can be stored or transmitted as a system-generated recommendation associated with the adaptive SKU data structure. Recommendation generation can incorporate forecast outputs from the forecasting engine 304, distributor constraints from the distributor system integration manager 308, and historical consumption patterns. Recommendation generation can also apply weighted scoring criteria such as procedural compatibility, margin optimization, or expiry proximity to select a recommended configuration.

The orchestration engine 322 can transmit a procedure-level instruction set to the entity via the one or more interfaces. In some embodiments, the procedure-level instruction set can specify a modified membership field and updated quantities generated by the incremental recomputation operation. For example, the orchestration engine 322 can generate a procedure-level instruction set encoded as a JavaScript Object Notation data structure. The procedure-level instruction set can include a modified membership field array storing identifiers for a guidewire SKU, an alternative catheter SKU that replaced a backordered catheter SKU, and a contrast agent SKU, and can further include an updated quantities object storing a quantity value of twelve units for the guidewire SKU and a quantity value of five units for the alternative catheter SKU. The orchestration engine 322 can transmit the procedure-level instruction set to a distributor enterprise resource planning system via the distributor system integration manager 308.

The orchestration engine 322 can communicate the action via a procedure-level inventory adjustment instruction that reflects a coordinated update to the plurality of SKUs rather than separate per-SKU instructions. The orchestration engine 322 can communicate the action to the one or more systems of the entity via the one or more interfaces established by the distributor system integration manager 308. For example, the orchestration engine 322 can transmit an order instruction to a warehouse management system via an application programming interface endpoint established by the distributor system integration manager 308, where the order instruction can specify a replenishment order for twenty units of the alternative catheter SKU having a SKU identifier of CAT-5678, a requested delivery date of seven days from a current date, and a destination distribution center identifier of DC-001, for instance.

The orchestration engine 322 can function as an integration module and can aggregate forecasted demand, inventory states, procedural classification parameters, distributor allocation strategies, and external system data. The procedure-key field can bind the adaptive SKU data structure to a procedure type, and retrieval of inventory configuration for the procedure type can be performed using a data access operation, including In some embodiments a single data access operation. The orchestration engine 322 can retrieve, using a single data access operation, a procedure-level inventory configuration bound to a single procedure type by the procedure-key field of the adaptive SKU data structure. The orchestration engine 322 can process the data to model SKU selection outcomes, generate selection recommendations, and execute SKU allocation processes. The orchestration engine 322 can execute event-driven alerting mechanisms to notify the distributor when system-detected changes in operational parameters initiate actionable conditions, such as supplier shipment delays. The orchestration engine 322 can generate distributor-directed action parameters using action or output recommendation algorithms based on SKU selection models. The orchestration engine 322 can process scenario modeling functions to simulate SKU selection outcomes, evaluating cost impact, margin variations, and service level feasibility across different logic paths. The orchestration engine 322 can implement approval workflow management processes to execute rule-based authorization protocols that validate procedural actions for customer and distributor approval hierarchies.

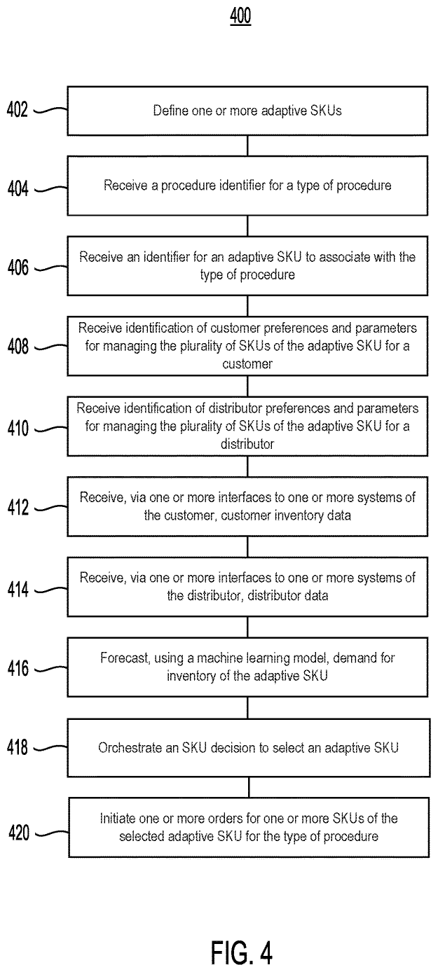

FIG. 4 depicts a method 400 of the management of adaptive stock-keeping units for procedure-based inventory. The method 400 can be implemented using a system or any other features discussed in FIGS. 1-3. The method can include Acts 402-420. The Acts 402-420 can be executed in any order or sequence.

At 402, an adaptive SKU manager can define one or more adaptive SKUs. Each of the one or more adaptive SKUs can include a combination of a plurality of SKUs for units for a type of procedure and a dynamic quantity and usage factor range for each of the plurality of SKUs. Each of the one or more adaptive SKUs can include one or more combination rules for combining, adding, or removing one SKU of the plurality of SKUs for another SKU of the plurality of SKUs. The dynamic quantities of an adaptive SKU of the one or more adaptive SKUs can correspond to a change in quantity of one SKU of the plurality of SKUs of the adaptive SKU with respect to a change in another SKU of the plurality of SKUs.

At 404, an orchestration engine can receive a procedure identifier for a type of procedure. The orchestration engine can map the procedure identifier to relevant SKU configurations. The orchestration engine can validate the procedure identifier against existing inventory data to maintain compatibility with system parameters.

At 406, the orchestration engine can receive an identifier for an adaptive SKU to associate with the type of procedure. The orchestration engine can correlate the adaptive SKU identifier with established SKU parameters. The orchestration engine can evaluate the adaptive SKU's dynamic quantity ranges based on projected usage for the identified procedure.

At 408, a customer manager can receive identification of customer preferences and parameters for managing the plurality of SKUs of the adaptive SKU for a customer. The customer manager can store such preferences in a parameter repository. The customer manager can process customer-defined parameters, such as SKU prioritization rules, purchase factor thresholds, and allocation constraints, to adjust SKU selection and ordering logic.

At 410, a distributor manager can receive identification of distributor preferences and parameters for managing the plurality of SKUs of the adaptive SKU for a distributor. The distributor manager can integrate such preferences with distributor-specific rules. The distributor manager can validate allowable SKU transitions or backorder practices based on the distributor's established policies.

At 412, a customer system integration manager can receive, via one or more interfaces to one or more systems of the customer, customer inventory data. The forecasting engine, via the customer system integration manager, can receive current inventories at one or more sites of the customer. The orchestration engine, via the customer system integration manager, can receive current inventories at one or more sites of the customer.

At 414, a distributor system integration manager can receive, via one or more interfaces to one or more systems of the distributor, distributor data. The forecasting engine, via the distributor system integration manager, can receive one or more of the expected delivery dates of one or more SKUs, the actual delivery dates of one or more SKUs, the inventories of one or more SKUs, and the shipment status of one or more SKUs. The orchestration engine, via the distributor system integration manager, can receive one or more of the expected delivery dates of one or more SKUs, the actual delivery dates of one or more SKUs, the inventories of one or more SKUs, and the shipment status of one or more SKUs.

At 416, the forecasting engine can forecast, using a machine learning model, demand for inventory of the adaptive SKU. The forecasting engine can process via the machine learning model various inputs, such as procedure forecasts from a customer, procedure forecasts from a distributor, and purchase factor-based forecasts.

At 418, the orchestration engine can orchestrate an SKU decision or determination to select an adaptive SKU. The orchestration engine can receive a configuration of the combination SKU and each of the plurality of SKUs of the combination SKU. The orchestration engine can provide, using one or more machine learning models, recommendations for one or more actions associated with the one or more adaptive SKUs. The machine learning models can process various inputs, such as demand forecasts, inventory data, customer preferences, and distributor preferences, to recommend one or more actions or system outputs. The orchestration engine can use one or more rules to select an adaptive SKU of the one or more adaptive SKUs to use for an order for a customer.

At 420, the orchestration engine can initiate one or more orders for one or more SKUs of the selected adaptive SKU for the type of procedure. The orchestration engine can initiate orders for one or more SKUs of the plurality of SKUs of the combination SKU for the type of procedure based at least on the dynamic quantity factor range for the one or more SKUs.

### D. Systems and Methods for Using Adaptive Stock-Keeping Unit Data Structures

The present description relates to techniques for using adaptive stock-keeping unit (SKU) data structures. SKUs are identifiers assigned to products within inventory or catalog systems to facilitate tracking, management, and differentiation of items. In various operational environments, such as healthcare distribution networks, manufacturing supply chains, and other business-to-business sectors, inventory management systems can process SKU data to support procurement workflows, allocation processes, and fulfillment operations. Such systems can interface with enterprise resource planning (ERP) platforms, warehouse management systems (WMS), transportation management systems (TMS), and electronic data interchange (EDI) frameworks to coordinate inventory states, shipment statuses, and supplier performance metrics. Inventory management systems can support demand forecasting by processing historical consumption data, procedural volume projections, and supplier delivery timelines. In certain operational contexts, such as healthcare environments, inventory management systems can align SKU allocations with procedural requirements, where specific procedures can demand designated SKU configurations to satisfy regulatory mandates or operational protocols.

However, certain inventory management systems face technical challenges in adapting to dynamic supply chain conditions and procedural requirements. For example, certain SKU management approaches can apply static SKU configurations that do not adjust to changes in supplier availability, lot expiration timelines, or procedural demand variations. Such static configurations can result in inventory inefficiencies, including stockouts of high priority or impact-sensitive SKUs, excess inventory of low-demand items, or misalignment between SKU availability and procedural needs. When supply chain disruptions occur, such as delayed supplier shipments, product recalls, or backorder conditions, existing systems often lack automated substitution logic to identify and execute alternative SKU allocations. In certain cases, user intervention can be required to evaluate permissible SKU substitutions, assess inventory constraints, and reconfigure procurement orders, which can introduce operational delays and increase labor costs. Additionally, certain systems can fail to account for interdependencies between SKUs within procedural contexts, where the substitution of one SKU can trigger corresponding adjustments to other SKUs to maintain procedural compliance. Certain inventory management systems also lack mechanisms to dynamically adjust SKU quantities based on usage factor variations, expiration date constraints, or lot-specific parameters. As a result, such systems can generate procurement recommendations that do not reflect real-time inventory states, supplier performance, or procedural demand, leading to suboptimal inventory allocations and reduced operational efficiency.

The technical solutions described herein can provide certain techniques or approaches for managing adaptive SKUs to address the technical limitations of existing inventory management systems. Such techniques can define adaptive SKU configurations that incorporate dynamic quantity parameters, usage factor ranges, and SKU combination rules to support procedural requirements. An adaptive SKU can represent a structured grouping of multiple SKUs aligned with a specific procedure type, where each SKU within the grouping can have associated parameters such as supplier details, lot ranges, expiration date thresholds, financial metrics, and priority or ranking levels. Such techniques can apply substitution logic to the adaptive SKU configurations, such that when a substitution of one SKU occurs, corresponding adjustments to other SKUs within the configuration can be executed automatically. Such techniques can process demand forecast data, inventory states, customer preferences, and distributor parameters to model SKU selection outcomes and generate recommendations or execute procurement actions. Such techniques can integrate with external systems, such as ERP platforms, WMS, TMS, and EDI interfaces, to retrieve real-time inventory data, shipment statuses, and supplier delivery timelines. Such techniques can apply machine learning models to process heterogeneous data streams and generate predictive inventory forecasts, substitution recommendations, and allocation strategies.

To implement the techniques described herein, one or more servers can receive a procedure identifier corresponding to a procedural type or category. The servers can process an identifier linked to an adaptive SKU for procedural association. The adaptive SKU can include a combination of multiple SKUs, each having dynamic quantity parameters and usage factor ranges. The servers can retrieve configuration parameters defining SKU combinations and associated constraints, such as supplier details, origin attributes, lot ranges, expiration date cushions, and financial metrics. The servers can execute SKU selection logic by applying rule-based algorithms that evaluate customer preferences, distributor parameters, and inventory states to determine permissible SKU allocations. The servers can implement a forecasting engine that processes demand forecast data, including procedure forecasts from customers, distributor-anticipated forecasts derived from proprietary machine learning models, and purchase factor-based forecasts. The forecasting engine can compute future inventory demands and generate SKU decisions or determinations to proactively account for anticipated supply constraints. The servers can integrate with customer systems to receive inventory data, SKU migration schedules, site activations, and deactivations through batch processing, micro-batch processing, structured flat file exchanges, or event-driven inventory updates. The servers can integrate with distributor systems to retrieve projected SKU delivery timelines, actual delivery records, SKU inventory states, and shipment status updates. The servers can implement an orchestration engine that aggregates forecasted demand, inventory data, customer preferences, distributor preferences, and external system data to model SKU selection outcomes, generate selection recommendations, and execute SKU allocation processes. The orchestration engine can apply machine learning models to process the aggregated data and generate action parameters for adaptive SKU selection. The servers can execute event-driven alerting mechanisms to notify distributors when system-detected changes in operational parameters initiate actionable conditions, such as supplier shipment delays. The servers can process scenario modeling functions to simulate SKU selection outcomes, evaluating cost impact, margin variations, and service level feasibility across different logic paths. The servers can implement approval workflow management processes to execute rule-based authorization protocols that validate procedural actions for customer and distributor approval hierarchies. The servers can initiate SKU procurement processes or orders within the selected adaptive SKU framework, referencing dynamic quantity factor ranges to compute procurement quantities.

The techniques described herein can overcome the technical limitations of existing inventory management systems by providing adaptive SKU configurations that dynamically adjust to supply chain conditions and procedural requirements. The techniques can reduce inventory inefficiencies by automatically executing SKU substitutions and quantity adjustments based on real-time inventory states, supplier performance, and procedural demand. The techniques can minimize operational delays by eliminating the need for manual intervention in evaluating permissible SKU substitutions and reconfiguring procurement orders. The techniques can account for interdependencies between SKUs within procedural contexts, such that the substitution of one SKU can trigger corresponding adjustments to other SKUs to maintain procedural compliance. The techniques can dynamically adjust SKU quantities based on usage factor variations, expiration date constraints, and lot-specific parameters to generate procurement recommendations that reflect current inventory states and procedural needs. The techniques can integrate with external systems to retrieve real-time data, enabling the servers to process heterogeneous data streams and generate predictive inventory forecasts, substitution recommendations, and allocation strategies. The techniques can apply machine learning models to continuously improve the quality of SKU selection decisions or determinations and demand forecasting accuracy. The techniques can provide event-driven alerting mechanisms to proactively notify distributors of supply chain disruptions and recommend or execute corrective actions. The techniques can support scenario modeling to evaluate alternative SKU selection outcomes and assess cost, margin, and service level impacts before executing procurement decisions or operations. The techniques can implement approval workflows to maintain alignment between distributor and customer preferences while adapting to operational parameters and procedural complexity. As a result, the technical solutions described herein can improve supply chain resilience, reduce operational costs, and enhance inventory management efficiency by supporting system-driven adaptation to dynamic supply chain conditions.

The adaptive stock-keeping unit (adaptive SKU) provides a series of concrete technical improvements in the efficiency of procedure-based inventory management by reducing the processing power, memory usage, and storage resources required to compute and maintain inventory states. In certain SKU-only systems, every computation related to a procedure, such as forecasting, substitution handling, compatibility checking, and quantity recalculation, is to be performed independently for each SKU involved in the procedure. Such a configuration forces the system to repeatedly traverse SKU records, repeatedly evaluate rules, and repeatedly reconstruct the set of items required for the procedure. When a single SKU changes, such systems often trigger cascading recomputation cycles in which dependent SKUs are to be reevaluated and reconciled one by one. Such architectures consume significant CPU time, generate high volumes of intermediate states, and introduce latency into ordering and forecasting workflows.

By contrast, the adaptive SKU consolidates the procedure-level information into a single stored, machine-readable data structure that binds a procedure identifier to a combination SKU and a parameter set. The combination SKU stores the identifiers of all underlying SKUs used in the procedure, while the parameter set stores the machine-executable rules that govern the membership of those SKUs and the corresponding coordinated quantity behavior. Because this information is persisted as a unified structure, the system can retrieve the entire procedure configuration in a single operation and apply updates at the procedure level rather than performing repeated per-SKU computations. Such consolidation reduces the number of rule-evaluation cycles, eliminates the need for repeated reconciliation of SKU sets, and lowers the overall computational complexity of procedure-based inventory operations. As a result, the system consumes fewer CPU cycles and reduces the latency associated with forecasting, ordering, and substitution workflows.

The adaptive SKU also reduces memory consumption by bypassing the process step of constructing and maintaining multiple temporary in-memory structures during computation. In this regard, certain traditional systems are to assemble procedure-level item sets from independent SKU records, maintain external mapping tables to represent inter-SKU dependencies, and generate transient reconciliation structures whenever a substitution or quantity change occurs. Such operations create memory churn, increase memory management processing load, and fragment the system's state. The adaptive SKU avoids such inefficiencies by storing the combination membership, combination rules, quantity relationships, and usage factor ranges in a single durable object. Such a configuration reduces the number of in-memory objects required during computation, minimizes the creation of temporary reconciliation structures, and facilitates more efficient caching because the system can cache a single adaptive SKU rather than multiple fragmented SKU-level components.

Such configurations also improve storage efficiency. For example, in SKU systems, procedure-level logic is duplicated across multiple SKU records or stored in external mapping tables that are to be maintained separately. Quantity rules, compatibility constraints, and usage factors can be redundantly stored or repeatedly inferred from SKU-level data, increasing the persistent storage footprint and requiring additional I/O operations to read and update such distributed records. The adaptive SKU eliminates or reduces such redundancy by storing some or all procedure-level logic in one place. Such an approach reduces the number of records that are to be persisted, decreases the size of database indexes, and lowers the volume of read and write operations required to maintain procedure-related state.

The adaptive SKU further reduces computational overhead by supporting coordinated quantity propagation across related SKUs. In certain traditional systems, when one SKU changes, the system is to independently recalculate its quantity, recalculate the quantities of dependent SKUs, and reconcile any mismatches that arise. Such iterative correction loops consume significant processing resources. Because the adaptive SKU stores quantity relationship logic centrally, a single membership update triggers a single coordinated quantity adjustment across some or all dependent SKUs. Such an approach eliminates repeated recalculation cycles such that quantitative behavior remains coherent across the entire procedure.

The stored usage factor range within the adaptive SKU also contributes to computational efficiency. In SKU systems, forecasting demands repeated analysis of SKU-level usage patterns and reconciliation of SKU-level signals into a procedure-level demand estimate. By associating the usage factor range directly with the procedure-linked adaptive SKU, the system can apply consistent quantity bounds and calibration logic each time the procedure is processed. Such an approach reduces the need for repeated historical data scans, lowers forecasting complexity, and minimizes reconciliation overhead.

Additionally, the adaptive SKU reduces workflow and exception-handling overhead. In SKU systems, each substitution or transition event triggers a separate workflow action, approval, compatibility check, and quantity recalculation. Because the adaptive SKU serves as the unit of change, a single substitution event updates the entire combination SKU, applies the relevant combination rules, and propagates quantity adjustments across all dependent SKUs. Such an approach reduces the number of workflow events, decreases orchestration complexity, and lowers the CPU and I/O resources consumed by exception handling.

Collectively, such improvements demonstrate that the adaptive SKU architecture provides a technically superior approach to procedure-based inventory management. By consolidating procedure-level logic into a single stored structure and facilitating coordinated updates across some or all underlying SKUs, the system reduces processing power, memory usage, storage requirements, and operational overhead, while improving consistency and reducing the likelihood of mismatches or divergence in computed inventory states.

Furthermore, implementing the adaptive SKU as a stored data structure that binds a procedure identifier to a combination SKU and parameter set provides a technical improvement in procedure-based inventory management computing by allowing the system to compute and execute ordering decisions or determinations at a procedure level rather than through repeated independent computations on individual SKUs. By persisting the membership of the combination SKU together with combination rules and quantity relationships, the system maintains a durable procedure-to-inventory mapping that can be retrieved and applied repeatedly for procedure-based ordering and inventory calculation, including under changing supply conditions. Such an approach reduces mismatch between procedure requirements and computed inventory representations because the procedure's required items are captured in a single machine-managed structure rather than distributed across independent SKU records that require repeated reconciliation.

In some embodiments, the stored combination rules allow the system to maintain the procedure-to-inventory mapping when an underlying SKU changes by triggering a constraint-governed update to the combination SKU membership. When a substitution is received or inferred, the system updates the stored set of underlying SKUs in accordance with the parameter set, rather than replacing a single SKU without evaluating the compatibility of the overall set. As a result, the system reduces iterative exception handling and repeated per-SKU rule evaluation that would otherwise be performed to restore procedure compatibility after a change in one item.

In some embodiments, the stored dynamic quantity parameters and quantity relationship logic provide a technical effect of maintaining coherent quantity behavior across multiple SKUs that are consumed together as part of the procedure. When the membership of the combination SKU changes due to a combination rule or substitution-driven update, quantities for affected SKUs can be adjusted responsive to the membership change, and quantity changes can be propagated across related SKUs using the stored quantity relationship logic. Such an approach reduces divergence between intended procedure-level quantities and computed per-SKU quantities by ensuring that changes in one underlying SKU produce corresponding changes in other underlying SKUs as defined by the adaptive SKU parameters, thereby reducing repeated recomputation cycles that arise in SKU-only systems.

In some embodiments, storing a usage factor range in the adaptive SKU data structure improves quantity determination for procedure-based inventory by constraining quantities based on observed or detected procedure-related purchasing and utilization over time. Because the usage factor range is associated with the procedure-linked adaptive SKU and stored as part of the parameter set, the system can apply the same quantity bounds or calibration logic each time the procedure is processed, thereby reducing forecasting reconciliation overhead and reducing mismatch between procedure requirements and computed order quantities across repeated procedure execution.

In some embodiments, the adaptive SKU reduces computational and operational resource consumption compared to inventory systems that manage each single SKU independently. In SKU systems, substitutions and inventory adjustments are processed per SKU, often demanding repeated and cascading recomputation to restore compatibility across the multi-item set required for a procedure. By contrast, the adaptive SKU provides a stored procedure-level unit that supports membership updates and quantity adjustments to be performed as a coordinated operation based on the parameter set, thereby reducing redundant per-SKU processing cycles and reducing iterative correction loops triggered by interdependent changes.

In some embodiments, the adaptive SKU reduces data storage redundancy and state fragmentation by storing, in a single procedure-linked object, the combination SKU membership together with the combination rules, quantity logic, and usage factor range. This reduces duplication of procedure logic across multiple SKU records and reduces the need to maintain external or manual mappings to represent inter-SKU dependencies. In addition, by facilitating forecasting and ordering to be performed using procedure-level information and stored usage factor ranges, the adaptive SKU reduces forecasting complexity and reduces reconciliation steps otherwise required to infer procedure demand from independent SKU-level signals. The system further reduces exception management and orchestration overhead by applying constraint-governed combination rules to perform substitutions and transitions at the combination SKU level, thereby reducing the number of discrete workflow events and approvals that would otherwise be invoked per affected SKU.

In some embodiments, the adaptive stock-keeping unit (adaptive SKU) is implemented as a stored, machine-readable data structure in a data store accessible by one or more processors and is configured to bind a procedure identifier for a type of procedure to a combination SKU and a parameter set. The combination SKU stores identifiers for a plurality of underlying SKUs used to execute the type of procedure, and the parameter set stores machine-executable constraints that govern both (i) membership of the plurality of underlying SKUs within the combination SKU and (ii) coordinated quantity behavior across the plurality of underlying SKUs. In operation, when a change event occurs for an underlying SKU (e.g., unavailability, recall, substitution, or transition), the computing system applies stored combination rules in the parameter set to update membership of the combination SKU by replacing, adding, or removing at least one underlying SKU, and applies stored quantity relationship logic to propagate coordinated quantity adjustments across dependent underlying SKUs responsive to the membership update. By persisting the procedure-linked combination membership and parameter logic in the adaptive SKU data structure, the computing system performs procedure-based inventory computation using a retrievable procedure-level execution unit, reducing repeated per-SKU recomputation and reducing inconsistency that arises when substitutions and quantity changes are processed independently on a per-SKU basis.

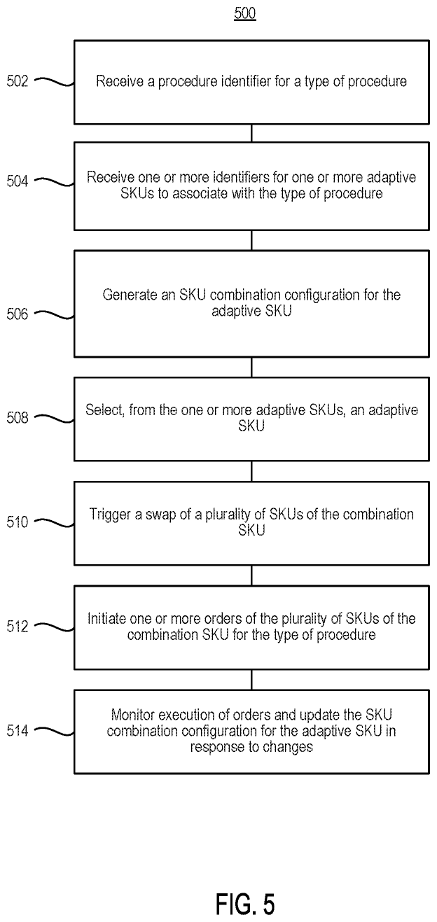

Referring now to FIG. 5, depicted is an example flow diagram of a method 500 of using adaptive stock-keeping unit data structures. The method 500 can be executed, performed, or otherwise carried out by any of the computing systems or devices described herein, and any of the components thereon, such as depicted in FIG. 3. In brief overview of the method 500, the method 500 can include receiving a procedure identifier for a type of procedure (ACT 502), receiving one or more identifiers for one or more adaptive SKUs to associate with the type of procedure (ACT 504), generating a SKU combination configuration for the adaptive SKU (ACT 506), selecting an adaptive SKU from the one or more adaptive SKUs (ACT 508), triggering a swap of a plurality of SKUs of the combination SKU (ACT 510), initiating one or more orders of the plurality of SKUs of the combination SKU for the type of procedure (ACT 512), and monitoring execution of orders and updating the SKU combination configuration for the adaptive SKU in response to changes (ACT 514).

The method 500 can include receiving a procedure identifier for a type of procedure (ACT 502). The system 300 can receive the procedure identifier via a user interface or an application programming interface (API) or other network interface. The network interface can include an API, receipt of network packets or payloads, bidirectional application-to-application or system-to-system messaging, one or more configured adapters, or protocol specific communications. In some embodiments, one or more components of the system 300 can receive the procedure identifier. In some embodiments, the system 300 can receive the procedure identifier from a client device that transmits the identifier through a graphical user interface that allows a user to select or enter a procedure type from a predefined list of procedural classifications.

For example, in a healthcare environment, the user interface can present a dropdown menu or a search field that allows a user to specify a surgical procedure type such as a cardiac catheterization. The system 300 can receive the corresponding procedure identifier when the user submits the selection. In some embodiments, the customer system integration manager 306 of the system 300 can receive the procedure identifier through an API that interfaces with external systems, such as a hospital scheduling system, an electronic health record system, or a customer order management system. The external system can transmit the procedure identifier as part of a data payload of one or more network packets that initiates an order workflow or inventory replenishment request over a bidirectional application-to-application or system-to-system communication session. The transmission can occur via one or more configured adapters and according to one or more communication protocols or protocol formatted messages associated with the external system.

In some embodiments, the orchestration engine 322 of the system 300 can receive the procedure identifier from the system 300 or from one or more components of the system 300, such as the customer system integration manager 306 or distributor system integration manager 308. The orchestration engine 322 can validate the procedure identifier against existing inventory data to maintain compatibility with system parameters. The orchestration engine 322 can verify that the procedure identifier conforms to standardized classification schemes used across integrated systems. The orchestration engine 322 can store or associate the validated procedure identifier in a procedure-key field of an adaptive SKU data structure for subsequent retrieval and execution operations.

The method 500 can include receiving one or more identifiers for one or more adaptive SKUs to associate with the type of procedure (ACT 504). The system 300 can receive one or more identifiers for one or more adaptive SKUs via one or more processing components, as depicted in FIG. 3. For example, the adaptive SKU manager 302 can store, in a non-transitory computer-readable medium, an adaptive SKU data structure that includes a procedure-key field storing the procedure identifier, a membership field storing an ordered list of underlying SKU identifiers, a dependency field storing quantity relationship entries, and a rule field storing executable membership rules that define permitted membership modifications to the ordered list. The orchestration engine 322 of the system 300 can receive the identifiers of one or more adaptive SKUs from one or more components of the system 300, such as the adaptive SKU manager 302. Each adaptive SKU can have or include a combination SKU having a plurality of SKUs for units for the type of procedure. Each adaptive SKU can include, in the adaptive SKU data structure, a dynamic quantity and usage factor range for each of the plurality of SKUs. For example, an adaptive SKU for a surgical procedure can include identifiers for a combination SKU that specifies quantities of sutures, surgical gloves, and antiseptic supplies, among others. Each SKU of the adaptive SKU data structure can be associated with or store dynamic quantity parameters and usage factor ranges determined based on historical consumption data. The orchestration engine 322 can receive the identifiers in response to the procedure identifier received in ACT 502. The system 300 can establish, create or configure an adaptive SKU data structure to associate one or more identifiers with a type or types of procedures such that subsequent operations are executable using, over, or against the adaptive SKU data structure.

In some embodiments, the orchestration engine 322 can receive multiple adaptive SKU identifiers where the procedure type permits alternative SKU configurations. For example, a cardiac catheterization procedure can permit three alternative adaptive SKU configurations. A first configuration includes a first combination of guidewires, catheters, and contrast agents from a first supplier. A second configuration includes a second combination of guidewires, catheters, and contrast agents from a second supplier. A third configuration includes a third combination of guidewires, catheters, and contrast agents that substitutes one catheter type for another catheter type while maintaining procedural compliance. The orchestration engine 322 can use identifiers to retrieve the configurations, such as for the alternative adaptive SKU configurations or can use the identifiers to create one or more adaptive SKU data structures for adaptive SKU configurations. Each adaptive SKU data structure can be separately retrievable and executable for selection, substitution, or ordering operations.

In some embodiments, the membership field can store an ordered list of underlying SKU identifiers as a procedure-level consumption specification or sequence that can be maintained independently of individual SKU inventory records. In some embodiments, the system 300 via the orchestration engine 322 can cache the adaptive SKU data structure in memory as a retrievable execution unit. In some embodiments, the procedure-key field can bind the adaptive SKU data structure to a procedure type such that retrieval of inventory configuration can be performed using a data access operation over a network interface or local interface and executed, in whole or in part, to support subsequent inventory management actions.

In some embodiments, the adaptive SKU data structure can be arranged as a procedure-linked execution object or other retrievable execution unit associated with a procedure identifier. For example, the procedure-key field can bind the adaptive SKU data structure to a procedure type, and the membership field, dependency field, rule field, and one or more additional fields can be organized such that the adaptive SKU data structure is retrievable as a single unit for procedure-level processing. In some embodiments, the system 300 can retrieve the adaptive SKU data structure as a whole to support a selection operation, substitution operation, quantity recomputation operation, monitoring operation, or transaction operation. In some embodiments, the system 300 can retrieve and use a subset of the adaptive SKU data structure, such as one or more fields, entries, or stored values, for a corresponding operation without reconstructing procedure-level state from individual underlying SKU records.

The adaptive SKU data structure is executable or is an execution unit in multiple aspects, such as comprising logic to be executed or fields having instructions that are executable or being used for execution of operations of the system. Execution related to data structures comes in multiple or different forms. Executable membership rules stored inside the data structure can be executed to determine membership for the adaptive SKU. Computational propagation rules stored in dependency fields of the adaptive SKU data structure can be executed to propagate changes to the adaptive SKU, including the configuration or data and values stored in the adaptive SKU data structure. The system 300 via one or more processors may execute operations that modify the adaptive SKU data structure and values stored herein. The system 300 via one or more processors can execute or perform transactions over, using, or based on the adaptive SKU data structure. The system 300 via one or more processors can execute or perform transactions using logic stored therein or based on the adaptive SKU data structure. The transactions can include transactions initiated through APIs, protocol formatted messages, network packets, payloads, configured adapters, or other bidirectional application-to-application or system-to-system interface.

The method 500 can include generating an SKU combination configuration of one or more adaptive SKU data structures for the adaptive SKU (ACT 506). The system 300 can generate an SKU combination configuration for the adaptive SKU via one or more processing components, as depicted in FIG. 3. For example, the adaptive SKU manager 302 of the system 300 can generate the SKU combination configuration by applying combination rules, adjusting dynamic SKU quantities, and determining usage factor ranges based on the plurality of parameters associated with the adaptive SKU data structure. In some embodiments, the SKU combination configuration can be implemented in the adaptive SKU data structure by populating or updating the membership field with an ordered list of underlying SKU identifiers included in the configuration, populating or updating the dependency field with quantity relationship entries that define how quantity changes to one underlying SKU identifier propagate to one or more other underlying SKU identifiers, and populating or updating the rule field with executable combination rules that regulate permitted substitutions, additions, or removals within the configuration.

In some embodiments, the adaptive SKU manager 302 can incorporate forecasted demand generated by the forecasting engine 304 when determining combination rules, dynamic quantities, and usage factor ranges. The adaptive SKU manager 302 can further implement the SKU combination configuration by storing, in association with the adaptive SKU data structure, one or more quantity values, quantity ranges, usage factor ranges, procedural compatibility parameters, or substitution parameters corresponding to the underlying SKU identifiers represented in the membership field. In some embodiments, the adaptive SKU manager 302 can generate a configuration that specifies that if one SKU within the combination is substituted due to a supplier backorder, another SKU is to be added to maintain procedural compliance. The configuration can specify that the quantities of remaining SKUs are adjusted accordingly. For example, if a primary suture SKU becomes unavailable due to a supplier backorder, the adaptive SKU manager 302 can generate a configuration that substitutes an alternative suture SKU and adds an additional antiseptic SKU to maintain procedural compliance. In this example, the adaptive SKU manager 302 can implement the configuration in the adaptive SKU data structure by updating the membership field to replace an identifier of the primary suture SKU with an identifier of the alternative suture SKU and to add an identifier of the additional antiseptic SKU, and by updating the dependency field or associated quantity values to reflect adjusted quantities for remaining SKUs in the combination. The generated configuration can be stored in or represented by the adaptive SKU data structure.

The adaptive SKU manager 302 can generate the SKU combination configuration upon receiving the adaptive SKU identifiers in ACT 504. In some embodiments, the configuration of the adaptive SKU data structure(s) can be generated in advance and stored in memory for retrieval when the orchestration engine 322 processes an order. In some embodiments, the adaptive SKU manager 302 can regenerate the SKU combination configuration dynamically in response to changes in supplier availability, expiration date constraints, or customer preferences. The adaptive SKU manager 302 can apply combination rules by evaluating interdependencies between SKUs within the adaptive SKU data structure or a selected portion, part, or subset thereof.

The adaptive SKU manager 302 can use recommendation data generated using the machine learning model 324 to recommend substitutions or quantity adjustments. The machine learning model 324 can process forecasted demand, inventory availability, supplier performance metrics, and customer-defined operational parameters, among others. In some embodiments, the executable membership rules can include substitution rules that prevent the introduction of an underlying SKU that violates at least one compatibility or quantity dependency defined in the dependency field. In some embodiments, the the adaptive SKU manager 302 of the system 300 can store, within the adaptive SKU data structure, a usage factor range associated with the procedure identifier for execution in substitution, selection, or order generation operations.

The adaptive SKU manager 302 can adjust dynamic SKU quantities by computing quantity changes for other SKUs in the configuration of one or more adaptive SKU data structures when one SKU is substituted. The corresponding adjustments maintain the total quantity for the procedure while accounting for usage factor variations and procedural requirements. In some embodiments, the adaptive SKU manager 302 can compute quantity changes by processing usage factor ranges for each SKU within the adaptive SKU configuration of one or more adaptive SKU data structures. The usage factor range can be determined based on a quantity of units purchased over a predetermined time period, a number of procedures performed over that time period, and a quantity of units utilized over that time period. For example, if a surgical procedure requires 10 units of a primary suture SKU and the adaptive SKU manager 302 substitutes an alternative suture SKU that has a usage factor of 1.2 instead of 1.0, the adaptive SKU manager 302 can compute the quantity change by multiplying the original quantity of 10 units by the usage factor of 1.2 to generate a new quantity of 12 units for the alternative suture SKU by executing quantity propagation logic of the adaptive SKU data structure or by performing a recomputation operation over the dependency field thereof.

The method 500 can include selecting an adaptive SKU from the one or more adaptive SKUs (ACT 508). The system 300 can select the adaptive SKU from the one or more adaptive SKUs via one or more processing components, as depicted in FIG. 3. For example, the orchestration engine 322 of the system 300 can select an adaptive SKU by applying rule-based selection algorithms that evaluate customer preferences, distributor parameters, and inventory states to determine permissible SKU allocations or configurations. In some embodiments, the orchestration engine 322 can retrieve customer preference parameters from the customer manager 312 and distributor preference parameters from the distributor manager 314 to apply in the selection logic. In some embodiments, these customer or distributor preferences may be associated with or stored in the adaptive SKU data structure. The orchestration engine 322 can invoke the machine learning model 324 to score and prioritize permissible adaptive SKU allocations based on forecasted demand, inventory availability, distributor-defined parameters, and customer-defined operational rules, among others. In some embodiments, the orchestration engine 322 can select an adaptive SKU that prioritizes higher-margin SKU combinations when distributor preferences indicate margin optimization goals. In some embodiments, the adaptive SKU data structure can store one or more of the distributor-defined parameters or customer-defined operational rules. For example, if a distributor preference parameter specifies a margin limit of fifteen percent for a cardiac catheterization procedure, the orchestration engine 322 can evaluate multiple adaptive SKU configurations. The orchestration engine 322 can select a configuration of adaptive SKU data structures that includes a higher-cost guidewire SKU and a lower-cost catheter SKU to achieve a combined margin of fourteen percent, which satisfies the distributor-defined limit. The system 300 can perform the selection by executing or evaluating one or more fields, rules, or stored parameters of the adaptive SKU data structure.

In some embodiments, the orchestration engine 322 can select an adaptive SKU that prioritizes SKUs with shorter expiration dates when distributor preferences indicate expiry management objectives. For example, if a distributor preference parameter for or of one or more adaptive SKU data structures specifies an expiry management priority level of high for surgical suture inventory, the orchestration engine 322 can evaluate inventory data retrieved from the distributor system integration manager 308 and can identify suture lots with expiration dates within ninety days, for instance. The orchestration engine 322 can select an adaptive SKU configuration that incorporates the suture lots with expiration dates within ninety days for reducing inventory obsolescence. The orchestration engine 322 can select the adaptive SKU in response to generating the SKU combination configuration in ACT 506 and based on execution of the adaptive SKU data structure or one or more executable portions thereof.

The orchestration engine 322 can apply rule-based selection algorithms by processing customer-defined parameters for or of one or more adaptive SKU data structures. The customer-defined parameters can include recommended ranges for usage and purchase factors for each SKU combination. In some embodiments, the orchestration engine 322 can process a customer-defined parameter that specifies a usage factor range of 0.9 to 1.1 for a suture SKU in a surgical procedure, for instance. The orchestration engine 322 can evaluate adaptive SKU configurations and can select a configuration that includes a suture SKU with a usage factor of 1.0, which falls within the specified range. The orchestration engine 322 can access the stored usage factor range in the adaptive SKU data structure and can execute selection logic based thereon.

The orchestration engine 322 can evaluate inventory states by interfacing with one or more components of the system 300, such as the customer system integration manager 306 and the distributor system integration manager 308, to retrieve current inventories at customer sites, shipment statuses, and expected delivery dates, and account for real-time inventory availability and supply chain conditions. The orchestration engine 322 can use to execute or execute portions of one or more adaptive SKU data structures to evaluate such inventor states, such as executing any logic or rules of the adaptive SKU data structure in response to receiving the inventories, shipment statuses, and expected delivery dates through one or more network interfaces, APIs, adapters, or protocol formatted payloads.

The method 500 can include triggering a swap of a plurality of SKUs of the combination SKU represented by the adaptive SKU data structure (ACT 510). The system 300 can trigger a swap of the plurality of SKUs of the combination SKU via one or more processing components, as depicted in FIG. 3. For example, the adaptive SKU manager 302 of the system 300 can trigger a swap of the plurality of SKUs by applying or executing combination rules of the one or more adaptive SKU data structures that determine when a substitution of one SKU demands another SKU to be added or removed. The adaptive SKU manager 302 can adjust the quantity of one SKU in the adaptive SKU data structure with respect to a change in another SKU in the adaptive SKU data structure based on dynamic quantity parameters applied or executed by the system 300 using the the adaptive SKU data structure. In some embodiments, the adaptive SKU manager 302 can trigger a swap using or executing the adaptive SKU data structure or portions thereof, that substitutes an alternative suture SKU and adds an additional antiseptic SKU to maintain procedural compliance when a primary suture SKU becomes unavailable due to a supplier backorder.

The adaptive SKU manager 302 can trigger the swap in the adaptive SKU data structure in response to detecting a substitution event. In some embodiments, the adaptive SKU manager 302 can detect a substitution event when the orchestration engine 322 identifies that a selected SKU is unavailable, backordered, or subject to a recall. For example, the orchestration engine 322 can query inventory data retrieved from the distributor system integration manager 308. The orchestration engine 322 can determine that a selected catheter SKU has an inventory quantity of zero units across distribution centers. The orchestration engine 322 can transmit a substitution event notification to the adaptive SKU manager 302. The substitution event notification can include an identifier of the catheter SKU and a status indicator specifying that the selected catheter SKU is unavailable. The adaptive SKU manager 302 can receive the substitution event notification. The adaptive SKU manager 302 can trigger a swap by retrieving combination rules associated with the catheter SKU and executing such combination rules. The adaptive SKU manager 302 can identify an alternative catheter SKU that satisfies procedural standards and inventory availability constraints. The adaptive SKU manager 302 can update the membership field of the adaptive SKU data structure and can execute dependency logic over the updated data structure.

In some embodiments, the adaptive SKU manager 302 can trigger the swap automatically without user intervention if the substitution event meets predefined conditions. For example, the adaptive SKU manager 302 can evaluate the substitution event against predefined conditions stored in memory or part of the adaptive SKU data structure. The predefined conditions can specify automatic swap execution for SKU substitutions where the alternative SKU has a cost differential of less than ten percent relative to the unavailable SKU. The predefined conditions can specify that the alternative SKU is available in a quantity sufficient to fulfill forecasted demand for a period of at least seven days. The adaptive SKU manager 302 can determine that the substitution event satisfies the predefined conditions. The adaptive SKU manager 302 can execute the swap by updating the SKU combination configuration of the adaptive SKU data structure without routing the swap through an approval workflow. The system 300 can execute the updating as a transaction over the adaptive SKU data structure.

The adaptive SKU manager 302 can apply or execute combination rules of an adaptive SKU data structure by evaluating interdependencies between SKUs within the adaptive SKU configuration of the adaptive SKU data structure. The adaptive SKU manager 302 can use recommendation data generated using the machine learning model 324 to recommend permissible substitutions and related quantity adjustments. The machine learning model 324 can process forecasted demand, inventory availability, supplier performance metrics, and customer-defined operational parameters, among others. In some embodiments, the combination rules can specify which SKUs are to be added or removed from the adaptive SKU data structure when a substitution occurs. In some embodiments, the combination rules can define the conditions under which such substitutions are permissible. In some embodiments, the combination rules or the dependency field can store quantity relationship entries defining proportional, bounded, or conditional quantity propagation rules between underlying SKU identifiers. In some embodiments, the adaptive SKU manager 302 can receive, via a network interface, an update message that identifies a change event for a first underlying SKU identifier in the membership field as the substitution event notification. In some embodiments, the change event can include an availability change, recall event, or substitution event associated with the first underlying SKU identifier. In some embodiments, the adaptive SKU manager 302 can update a membership field of the adaptive SKU data structure storing an ordered list of underlying SKU identifiers by executing at least one executable membership rule selected based on the change event, where updating the membership field can include at least one of replacing the first underlying SKU identifier, adding an additional underlying SKU identifier, or removing an underlying SKU identifier.

The adaptive SKU manager 302 can adjust the quantity of one SKU in the adaptive SKU data structure with respect to a change in another SKU in the adaptive SKU data structure by computing quantity changes based on dynamic SKU quantity parameters of or for the adaptive SKU data structure. In some embodiments, the adaptive SKU manager 302 can perform an incremental recomputation operation that updates quantities for a subset of underlying SKU identifiers in the adaptive SKU data structure affected by the membership modification by applying the quantity relationship entries in the dependency field. The adaptive SKU manager 302 can avoid recalculating quantities for underlying SKU identifiers that are unaffected by the membership modification. In some embodiments, the adaptive SKU manager 302 can apply the usage factor range to constrain quantity updates during the incremental recomputation operation. For example, if a surgical procedure requires ten units of a primary suture SKU and the adaptive SKU manager 302 substitutes an alternative suture SKU that has a usage factor of 1.2 instead of 1.0, the adaptive SKU manager 302 can compute the quantity change by multiplying the original quantity of ten units by the usage factor of 1.2 to generate a new quantity of twelve units for the alternative suture SKU. The adaptive SKU manager 302 can further adjust the quantity of an antiseptic SKU within the same adaptive SKU configuration by applying a dynamic quantity parameter that specifies that for every two additional units of suture SKU, one additional unit of antiseptic SKU is required. The adaptive SKU manager 302 can compute that the increase of two units of suture SKU from ten units to twelve units requires an increase of one unit of antiseptic SKU. The adaptive SKU manager 302 can update the SKU combination configuration of the adaptive SKU data structure to reflect the new quantity of twelve units for the alternative suture SKU and the increased quantity of antiseptic SKU to maintain procedural compliance while accounting for the higher consumption rate associated with the alternative SKU. In some embodiments, the system 300 can execute updating of the membership field and perform or execute the recomputation operation as a transaction that reduces cascading per-SKU recomputation events. The adaptive SKU manager 302 can store the updated quantities in association with the adaptive SKU data structure for subsequent execution in ordering, monitoring, or further substitution operations.

In some embodiments, the system 300 can support multiple transition types for changing from a first SKU combination to a second SKU combination, including direct transitions, blended transitions in which units from the first SKU combination and the second SKU combination can be permitted during at least part of a transition period, or contingent transitions in which a transition can be conditioned on satisfaction of one or more trigger conditions such as inventory depletion, arrival of replenishment inventory, customer approval, or warehouse readiness. In some embodiments, transition rules can further account for non-equivalent units of measure, including changes in case size, pack size, or other packaging configuration, such that a substitution or transition can include corresponding quantity normalization, rounding, and consumption-factor adjustments for affected underlying SKUs. In some embodiments, the system 300 can evaluate transition-related exceptions and generate alerts based on defined trigger conditions, including excessive ordering relative to a projected transition schedule, days-on-hand threshold violations, missed transition dates, or vendor supply shortfalls.

The system 300 can further support scenario modeling for comparing different transition outcomes, including modeling an impact of schedule slips, delayed replenishment, or alternate substitution timing. In some embodiments, the system 300 can maintain transition governance data identifying an approval state, a responsible entity, and a time association for a transition-related event such that the system 300 can maintain an approval-state history and can generate an early-warning notification when a purchasing action associated with a transition occurs before an approval is recorded.

The method 500 can include initiating one or more orders of the plurality of SKUs of the combination SKU for the type of procedure based on, using, over or via one or more corresponding adaptive SKU data structures (ACT 512). The system 300 can initiate one or more orders of the plurality of SKUs of the combination SKU for the type of procedure via one or more processing components, as depicted in FIG. 3. For example, the orchestration engine 322 of the system 300 can initiate one or more orders for one or more SKUs of the plurality of SKUs of the combination SKU for the type of procedure based at least on the dynamic quantity factor range or the dynamic quantity range for the one or more SKUs. For example, the orchestration engine 322 can process an or execute using an adaptive SKU configuration of one or more adaptive SKU data structures for a cardiac catheterization procedure. The adaptive SKU configuration for the cardiac catheterization procedure can specify a dynamic quantity range of eight to twelve units for a guidewire SKU. The adaptive SKU configuration for the cardiac catheterization procedure can specify a dynamic quantity range of four to six units for a catheter SKU. The adaptive SKU configuration for the cardiac catheterization procedure can specify a dynamic quantity range of ten to fifteen units for a contrast agent SKU. The orchestration engine 322 can compute procurement quantities of ten units for the guidewire SKU. The orchestration engine 322 can compute procurement quantities of five units for the catheter SKU. The orchestration engine 322 can compute procurement quantities of twelve units for the contrast agent SKU. The orchestration engine 322 can initiate an order for ten units of the guidewire SKU. The orchestration engine 322 can initiate an order for five units of the catheter SKU. The orchestration engine 322 can initiate an order for twelve units of the contrast agent SKU. The orchestration engine 322 can initiate the orders by transmitting order instructions to the distributor system integration manager 308 via a network interface using one or more APIs, packets, payloads, adapters, or protocol formatted messages.

The orchestration engine 322 can initiate the orders in response to selecting the adaptive SKU represented by one or more adaptive SKU data structures in ACT 508. The orchestration engine 322 can initiate the orders using or executing via the one or more adaptive SKU data structure in response to triggering any SKU swaps in ACT 510. The orders can reflect the SKU combination configuration of one or more adaptive SKU data structures that accounts for substitutions executed by the adaptive SKU manager 302. In some embodiments, the orchestration engine 322 can initiate the orders based on granted permissions stored in the distributor manager 314. The granted permissions stored in the distributor manager 314 can specify an authorization level of automatic execution for SKU procurement processes. The authorization level of automatic execution for SKU procurement processes can apply where the total order cost is below a defined limit. The authorization level of automatic execution for SKU procurement processes can apply where the SKU combination configuration satisfies customer-defined preference parameters retrieved from the customer manager 312 or stored in the adaptive SKU data structure.

In some embodiments, the orchestration engine 322 can generate order recommendations using or executing transactions over one or more adaptive SKU data structures. The order recommendations can be routed through an approval workflow. The order recommendations can be routed through an approval workflow when the granted permissions specify an approval condition for SKU procurement processes. The approval condition for SKU procurement processes can apply where the total order cost exceeds the threshold value. The approval condition for SKU procurement processes can apply where the SKU combination configuration of the adaptive SKU data structures includes substitutions that deviate from customer-defined preference parameters represented in or accessible through the adaptive SKU data structure.

The orchestration engine 322 can reference dynamic quantity factor ranges for or of adaptive SKU data structures to compute procurement quantities. The orchestration engine 322 can determine the order quantities for each SKU within the adaptive SKU configuration. The orchestration engine 322 can invoke the machine learning model 324 to score SKU procurement recommendations. The orchestration engine 322 can invoke the machine learning model 324 to prioritize SKU procurement recommendations. The recommendations can include recommendations generated by executing or evaluating the adaptive SKU data structure or one or more portions thereof.

In some embodiments, the system 300 can further generate or refine quantity estimates using forward-looking commercial and financial planning data, including projected price changes, rebate effects, contract terms, or other deal-economics attributes associated with one or more underlying SKU identifiers. In some embodiments, the system 300 can apply such data when selecting among candidate substitutions, transition schedules, or procurement quantities for a given time period. In some embodiments, where forecast data is incomplete, sparse, or unreliable for a particular market, customer, or site, the system 300 can generate an initial quantity estimate or a refined quantity using partial forecast inputs in combination with historical usage factors, distributor constraints, or procedure-linked dependency parameters stored in the adaptive SKU data structure. In some embodiments, the system 300 can further normalize warehouse-specific unit-of-measure data and consumption-factor data, including by applying conversion factors between non-equivalent packaging or ordering units, applying rounding rules associated with a warehouse or supplier, and mapping consumption values across transition states such that quantity outputs remain aligned with warehouse-specific fulfillment constraints and procedure-level usage expectations.

The orchestration engine 322 can initiate SKU procurement processes by performing or executing a transaction over or using the one or more adaptive SKU data structures and by transmitting order instructions via a network interface to the distributor system integration manager 308. The distributor system integration manager 308 can interface with enterprise resource planning (ERP) systems to execute the procurement transactions. The distributor system integration manager 308 can interface with warehouse management systems (WMS) to execute the procurement transactions. The distributor system integration manager 308 can interface with order management systems to execute the procurement transactions via bidirectional application-to-application or system-to-system communications. The distributor system integration manager 308 can use configured adapters and protocol-based or protocol formatted exchanges.

The method 500 can include monitoring execution of orders and updating the SKU combination configuration of one or more adaptive SKU data structures for the adaptive SKU in response to changes (ACT 514). The system 300 can monitor the execution of orders and can update the SKU combination configuration of one or more adaptive SKU data structures for the adaptive SKU via one or more processing components, as depicted in FIG. 3. For example, the proactive monitoring engine 318 of the system 300 can monitor execution of orders by interfacing with the transportation management systems, the electronic data interchange feeds, and the warehouse management systems to retrieve shipment status data, supplier shipment updates, and order fulfillment records. The proactive monitoring engine 318 can identify anomalies such as delayed shipments, delayed orders, and projected inventory shortfalls by comparing the retrieved data against expected delivery timelines and projected inventory states. The system 300 can use retrieved data to update, execute, or re-execute one or more portions of the adaptive SKU data structure.

In some embodiments, the proactive monitoring engine 318 can query via the network interface shipment status data from the distributor system integration manager 308. The proactive monitoring engine 318 can determine that a shipment containing fifty units of a catheter SKU has an expected delivery date that is delayed by five days relative to an original expected delivery date. The proactive monitoring engine 318 can transmit the anomaly notification to the orchestration engine 322. The orchestration engine 322 can update the SKU combination configuration of one or more adaptive SKU data structures by identifying an alternative catheter SKU that satisfies procedural parameters and inventory availability constraints. The system 300 can receive or transmit the anomaly notification as a payload of one or more network packets or via an API, adapter, or protocol formatted message.

The proactive monitoring engine 318 can perform monitoring at periodic intervals after the orders are initiated in ACT 512. The proactive monitoring engine 318 can execute monitoring processes that retrieve shipment status data and inventory states from the distributor system integration manager 308 and the customer system integration manager 306 at scheduled time intervals. The scheduled time intervals can be every hour, every four hours, or every twenty-four hours. The proactive monitoring engine 318 can compare the retrieved data against projected demand and expected delivery timelines to identify deviations and can trigger execution of an update operation over the adaptive SKU data structure responsive to the deviations.

In some embodiments, the system 300 can evaluate one or more operational constraints associated with the adaptive SKU data structure. The one or more operational constraints can further include warehouse-specific transition parameters that define when a first warehouse is permitted to transition from a first SKU combination to a second SKU combination relative to one or more other warehouses. Such warehouse-specific transition parameters can include scheduled transition dates, depletion thresholds, receipt conditions, approval milestones, or confidence levels associated with expected inventory availability. In some embodiments, the system 300 can apply such parameters to maintain different transition logic for different warehouses while coordinating fulfillment for a common customer or procedure type. In some embodiments, the system 300 can generate exception alerts associated with the warehouse-specific transition parameters, including alerts for excessive ordering relative to a transition plan, days-on-hand threshold violations, missed transition milestones, or vendor shortfalls that can affect a planned transition. The system 300 can further compare alternative scenarios associated with a delayed warehouse transition or schedule slip and can determine a distributor-level fulfillment action based on the comparison.

In some embodiments, the proactive monitoring engine 318 can trigger automated responses to detected anomalies. The automated responses can include initiating substitute orders. The automated responses can include reallocating inventory across distribution centers. In some embodiments, the system 300 can route the anomalies to the exception control manager 316 for review and approval when predefined conditions are not satisfied. For example, the proactive monitoring engine 318 can compare one or more anomaly attributes identified from retrieved shipment status data, order fulfillment records, or inventory state data against threshold values, rule values, or condition fields stored in memory or in one or more fields of the adaptive SKU data structure, and can determine, based on the comparison, whether an automated response is permitted or whether routing to the exception control manager 316 is to be performed. The system 300 can store the predefined conditions in memory or in one or more fields of the adaptive SKU data structure.

The adaptive SKU manager 302 can update the SKU combination configuration of one or more adaptive SKU data structures in response to changes detected by the proactive monitoring engine 318 by applying combination rules to adjust SKU allocations, triggering SKU swaps, or recalculating dynamic quantity parameters of one or more adaptive SKU data structures to reflect current supply chain conditions and inventory availability. In some embodiments, the proactive monitoring engine 318 can detect a supplier shipment delay that affects a primary suture SKU. The adaptive SKU manager 302 can retrieve combination rules that specify permissible alternative suture SKUs for the procedure type. The adaptive SKU manager 302 can identify an alternative suture SKU that satisfies procedural parameters. The adaptive SKU manager 302 can trigger a SKU swap by updating the SKU combination configuration to replace the primary suture SKU with the alternative suture SKU. The adaptive SKU manager 302 can recalculate dynamic quantity parameters by applying a usage factor of 1.1 for the alternative suture SKU instead of a usage factor of 1.0 for the primary suture SKU. The adaptive SKU manager 302 can adjust the quantities of other SKUs in the configuration to maintain procedural compliance based on the recalculated dynamic quantity parameters. The adaptive SKU manager 302 can use recommendation data generated using the machine learning model 324 to determine configuration updates of one or more adaptive SKU data structures based on forecasted demand, real-time inventory availability, supplier performance metrics, and customer-defined operational parameters, among others. The adaptive SKU manager 302 can store updated quantities in association with the adaptive SKU data structure such that the updated adaptive SKU data structure remains executable for subsequent selection, ordering, monitoring, or substitution operations.

### E. Systems and Methods for Managing Adaptive Stock-Keeping Units Across Distributor Systems Using Operational Constraints

The present description relates to techniques for managing adaptive stock-keeping units across distributor systems using operational constraints. Distributors in industries such as healthcare, manufacturing, and other business-to-business sectors can source products from multiple suppliers, store inventory across multiple distribution centers, and deliver products to customers. Customers can rely on distributors to provide access to specific products or combinations of products required for procedures, operations, or production processes. In many cases, customers can define preferred stock-keeping unit combinations that correspond to particular procedure types or operational workflows. Distributors can use warehouse management systems, transportation management systems, enterprise resource planning systems, electronic data interchange systems, and inventory management systems to track inventory levels, manage shipments, and coordinate fulfillment across the supply chain.

In this regard, supply chain disruptions can create challenges for distributors and customers. When a distributor faces a backorder, a recall, a defect, or an expiry-related restriction for a particular stock-keeping unit, the distributor is to identify suitable alternatives while minimizing disruption to customer operations. Certain approaches rely on processes in which substitutions are identified and executed on a case-by-case basis. Such approaches can be time-consuming, error-prone, and inconsistent, particularly when working with large inventories or serving multiple customers with distinct preferences. Certain systems fail to provide selection or determination capabilities based on operational constraints and real-time inventory data when determining substitutions or fulfillment actions. Furthermore, certain systems also fail to support dynamic stock-keeping unit combinations in which a substitution of one stock-keeping unit within a combination can trigger corresponding changes to other stock-keeping units in the combination.

The technical solutions described herein provide an orchestration system that can maintain adaptive stock-keeping unit data structures for specific procedure types or operational workflows. Each adaptive stock-keeping unit data structure can include a membership field that can store an ordered list of identifiers for the stock-keeping units in a combination, a dependency field that can store quantity relationship entries defining propagation rules for quantity changes, and a rule field that can store executable rules for modifying the membership list. The orchestration system can establish connections to distributor systems and receive operational constraints via interfaces to the distributor systems. The operational constraints can include parameters such as expiry date preferences, backorder allocation priorities, and substitution eligibility constraints, among others. In such configurations, when a change event occurs, such as a stock-out condition, a recall, an expiry-related restriction, or a backorder status change, the orchestration system can determine an action based on the operational constraints and the change event and can communicate the action via the interfaces.

To implement the technical solutions described herein, the orchestration system can establish connections to distributor systems to receive inventory data and shipment status data. The orchestration system can maintain a monitoring engine that can monitor for change events across the systems. When a change event is detected, the orchestration system can apply executable rules stored in the rule field of the adaptive stock-keeping unit data structure to determine whether a substitution or other action is required. For example, if a stock-keeping unit is on backorder, the orchestration system can execute a rule that selects an alternative stock-keeping unit based on substitution eligibility constraints. If the substitution requires a corresponding change to another stock-keeping unit in the combination, the orchestration system can apply quantity relationship entries in the dependency field to update quantities for affected stock-keeping units without recomputing quantities for unaffected stock-keeping units. The orchestration system can communicate actions to distributor systems via the established interfaces.

The techniques described herein can improve supply chain reliability by performing stock-keeping unit selection or action determination in response to supply chain events. The techniques can reduce the time and effort required to address supply chain disruptions by reducing user driven operations and providing consistent, rules-based action determination. The dependency field and the incremental recomputation operation can improve computational efficiency by updating the quantities for stock-keeping units affected by a membership modification, rather than recomputing quantities for all stock-keeping units in the combination. The adaptive stock-keeping unit data structures can provide flexibility to accommodate dynamic stock-keeping unit combinations in which substitutions can trigger corresponding changes to related stock-keeping units, such that customers can receive complete and compatible stock-keeping unit sets for procedure types or operational workflows.

Furthermore, conventional inventory and fulfillment computing systems can process distributor and supplier inputs as fragmented, SKU-level records and discrete workflow events. When distributed distributor systems, forecasting components, and customer systems generate time varying signals, such as availability changes, shipment timing changes, substitution notices, and inventory attribute changes, certain architectures can ingest such signals into separate tables and services and then recompute ordering and fulfillment decisions on a per SKU basis. As a result, a single change event affecting one SKU can trigger repeated reconstruction of a procedure-level inventory state, meaning the set of SKUs jointly required for a procedure, repeated evaluation of substitution and eligibility logic across multiple SKUs, and repeated quantity reconciliation across interdependent SKUs. Such repeated passes over distributed records can generate cascading recomputation cycles, increased intermediate state generation, and inconsistent transient states between forecasting outputs, inventory records, and distributor-facing fulfillment actions.

Such technical limitations can present a computer-centric scaling problem. SKU-only pipelines can perform redundant I/O to retrieve and reconcile multiple SKU records each time a procedure-level decision is needed, allocate temporary in-memory structures to assemble procedure-level SKU sets and map dependencies, and repeatedly apply rule evaluation and quantity recalculation for each affected SKU when a distributor update arrives. As the volume and heterogeneity of distributor data increase, particularly when constraints include fine-grained attributes such as lot identifiers, expiry constraints, and backorder states, CPU utilization, memory churn, and persistent storage overhead can increase due to duplicated logic, repeated reconciliation, and repeated read and write cycles across distributed records, which can increase latency in generating executable distributor-facing actions, such as initiating an order, delaying a shipment, or executing a substitution, and can increase the likelihood of mismatched inventory and fulfillment state because updates occur as non-atomic, per SKU operations.

The present solution can improve inventory and fulfillment computing by configuring one or more servers to manage procedure-based inventory as an adaptive stock keeping unit, maintained as an adaptive SKU data structure. The adaptive SKU data structure can have a schema that can include a membership field storing an ordered list of identifiers for a plurality of SKUs of a combination SKU associated with a type of procedure, a dependency field storing quantity relationship entries that define, for at least one pair of identifiers, a propagation rule mapping a quantity change of a first SKU to a quantity change of a second SKU, and a rule field storing executable rules that define permitted membership modifications to the ordered list. By persisting membership, dependency logic, and executable rules as a unified, procedure-linked structure, the system can retrieve and update procedure-level configuration using a single managed object rather than repeatedly reconstructing procedure requirements from independent SKU records.

The servers can establish one or more connections, via one or more interfaces, to one or more systems of an entity that can provide units of at least one or more SKUs for the adaptive SKU, receive one or more operational constraints, and store the operational constraints in association with the adaptive SKU data structure. In response to receiving, via one or more interfaces, an update message that identifies a change event for a first SKU of the plurality of SKUs identified in the membership field, the servers can determine an action to take with respect to the adaptive SKU based at least on the one or more operational constraints and the change event. Determining the action can include executing at least one executable rule stored in the rule field to modify the membership field by at least one of replacing the first SKU with another SKU, adding an additional SKU, or removing an SKU, and performing an incremental recomputation operation that updates quantities for a subset of the plurality of SKUs affected by the modification of the membership field by applying one or more quantity relationship entries in the dependency field. The servers can communicate, via the one or more interfaces to the one or more systems of the entity, the action. Such architecture can shift event handling from repeated per SKU recomputation to a coordinated, procedure-level computation driven by the stored membership field, dependency field, rule field, and stored operational constraints, while limiting quantity updates to the affected subset of SKUs and avoiding cascading correction loops.

In some embodiments, the entity can include a distributor system, and the operational constraints can include machine-readable distributor constraints that specify at least one of available to promise quantities for one or more SKUs, lot identifiers and lot-based restrictions, expiry dates or expiry windows, backorder flags or backorder queues, shipment timing constraints, allocation limits, substitution eligibility constraints, or fulfillment routing constraints. In some embodiments, the update message can be an asynchronous distributor event indicating at least one of a stock out condition, a recall, an expiry-related restriction, a backorder status transition, an expected shipment change, or a substitution notice for the first SKU. In some embodiments, the action communicated to the distributor system can include at least one of initiating an order for one or more SKUs in the membership field, delaying a shipment associated with the adaptive SKU, splitting fulfillment across multiple shipment windows, rerouting fulfillment to an alternate distributor endpoint, or communicating a coordinated substitution instruction that reflects the modified membership field and the updated quantities generated by the incremental recomputation operation.

The present solution can generate concrete technical effects in the operation of distributed inventory and fulfillment computing systems by reducing computing resources consumed during distributor change event processing and action generation. Because the adaptive SKU is maintained as a stored procedure-level object with a defined schema, the servers can reduce database lookups and rule evaluation cycles to determine an action in response to an update message, avoiding repeated reconstruction of procedure-level state from independent SKU records. The incremental recomputation operation can reduce processor utilization by updating quantities for a subset of SKUs affected by a membership modification, rather than recalculating quantities across some or all SKUs or executing iterative per SKU reconciliation loops.

The present solution can also reduce memory consumption and memory churn. Certain per-SKU approaches allocate temporary in-memory reconciliation structures to assemble procedure-level SKU sets, maintain external dependency mappings, and reconcile quantity changes after substitutions. By storing the membership field, dependency field, rule field, and operational constraints in association with the adaptive SKU data structure, the system can reduce creation of transient objects during event handling and facilitate more efficient caching of procedure-level state, reducing memory reclamation overhead and improving runtime stability under high event volume from distributor interfaces.

Additionally, storage and I/O efficiency can be improved by reducing redundancy and fragmentation of procedure-level logic. In SKU-only systems, procedure-level substitution logic, quantity coupling, and operational constraints can be duplicated across multiple records or maintained in separate mapping tables that are to be read and updated independently. By associating operational constraints directly with the adaptive SKU data structure and encoding quantity propagation relationships in the dependency field, the system can reduce the number of separate records to persist and reduce the volume of read and write operations to maintain consistent procedure-related state.

The coordinated determination of action, including rule-based membership modification and dependency-aware incremental recomputation, can reduce inconsistent intermediate states across distributed systems. By computing a procedure-level action using stored operational constraints and dependency-based propagation rules and communicating that action through established interfaces, the system can reduce divergence between distributor-facing fulfillment state and internal procedure-level inventory state that otherwise can result from non-atomic per SKU updates and repeated correction loops. The overall result is a computing system that can respond more efficiently and consistently to distributor change events while consuming fewer processing, memory, and storage resources than certain SKU-only architectures.

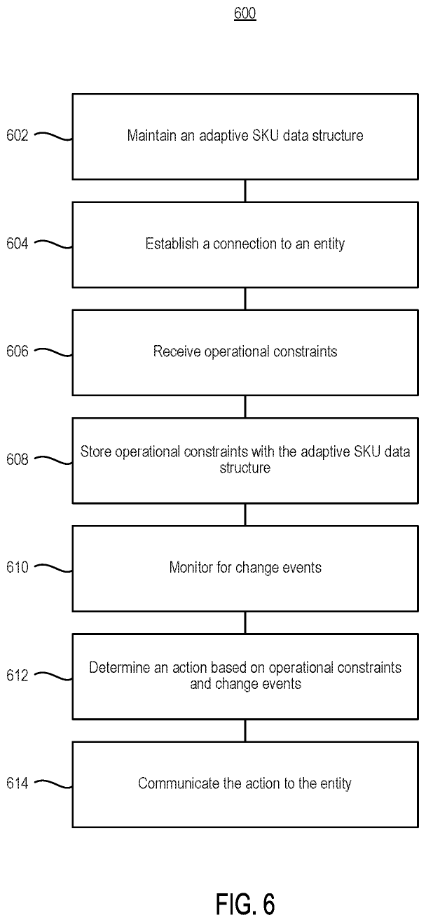

Referring now to FIG. 6, depicted is an illustrative flow diagram of a method 600 of managing adaptive stock-keeping units across distributor systems using operational constraints. The method 600 can be executed, performed, or otherwise carried out by any of the computing systems or devices described herein, and any of the components thereon, such as depicted in FIG. 3. In brief overview of the method 600, the method 600 can include maintaining an adaptive SKU data structure (ACT 602), establishing a connection to an entity (ACT 604), receiving operational constraints (ACT 606), storing operational constraints with the adaptive SKU data structure (ACT 608), monitoring for change events (ACT 610), determining an action based on operational constraints and change events (ACT 612), and communicating the action to the entity (ACT 614).

The method 600 can include maintaining an adaptive SKU data structure (ACT 602). The system 300 can maintain the adaptive SKU data structure via one or more processing components, as depicted in FIG. 3. For example, the adaptive SKU manager 302 of the system 300 can store, in a non-transitory computer-readable medium, the adaptive SKU data structure having a schema including a procedure-key field storing a procedure identifier, a membership field storing an ordered list of underlying SKU identifiers, a dependency field storing quantity relationship entries that define propagation rules, and a rule field storing executable membership rules that define permitted membership modifications to the ordered list. For instance, the adaptive SKU manager 302 can maintain an adaptive SKU data structure for a cardiac catheterization procedure, where the membership field can store identifiers for guidewire SKUs, catheter SKUs, and contrast agent SKUs, and the dependency field can store quantity relationship entries specifying that a quantity change of two units in a guidewire SKU triggers a quantity change of one unit in a catheter SKU. The adaptive SKU manager 302 can maintain the adaptive SKU data structure by periodically updating the schema fields based on changes in procedural requirements, supplier availability, or distributor preferences. The system 300 can execute one or more rules or propagation entries stored in the adaptive SKU data structure to update values maintained in one or more fields thereof.

In some embodiments, the dependency field of the adaptive SKU data structure can define quantity propagation rules that encode proportional, conditional, or bounded quantity relationships between SKUs consumed together as part of the type of procedure. For example, a quantity propagation rule can specify that a change to a first SKU results in a proportional change in a second SKU, a change in the second SKU when a specified condition is satisfied, or a change in the second SKU subject to a minimum or maximum quantity bound. The system 300 can execute the quantity propagation rules to update affected portions of the adaptive SKU data structure.

In some embodiments, the adaptive SKU manager 302 can maintain, in association with the adaptive SKU data structure, distributor preference information for the type of procedure. The distributor preference information can identify one or more preferred distributors, ranked distributors, or distributor selection criteria for fulfilling one or more SKUs of the adaptive SKU In some embodiments, the distributor preference information can be stored in one or more fields of the adaptive SKU data structure, such that the distributor preference information is retrievable for execution during selection or action determination operations.

In some embodiments, the adaptive SKU manager 302 can cache the adaptive SKU data structure in memory as a retrievable execution unit to reduce repeated rule evaluation across multiple inventory transactions. In some embodiments, the adaptive SKU data structure can be stored as a procedure-linked execution object, or other retrievable execution unit associated with a procedure identifier, such that the adaptive SKU data structure is retrievable as a single unit. Retrieving the adaptive SKU data structure as a single unit can avoid repeated reconstruction of procedure-level inventory state from individual underlying SKU records. The system 300 can execute the retrieved adaptive SKU data structure as a whole or in part, such as by executing one or more rules, propagation entries, or stored parameters of one or more fields of the adaptive SKU data structure for a corresponding operation.

The method 600 can include establishing a connection to an entity (ACT 604). The system 300 can establish a connection to the entity via one or more processing components, as depicted in FIG. 3. For example, the distributor system integration manager 308 of the system 300 can establish one or more connections, via one or more interfaces, to one or more systems of an entity that provides units of at least one or more SKUs for the adaptive SKU. The entity can include a distributor system that supplies units of at least a subset of the plurality of SKUs.

In some embodiments, the distributor system integration manager 308 can establish an authenticated interface session with a distributor enterprise resource planning system to exchange inventory availability data, shipment status updates, and supplier delivery timelines for SKUs included in an adaptive SKU configuration represented in the adaptive SKU data structure for a surgical procedure. The distributor system integration manager 308 can establish the connection in response to receiving a procedure identifier for a type of procedure, or in response to initiating an inventory forecasting process that accesses real-time distributor data.

In some embodiments, the distributor system integration manager 308 can establish the connection by transmitting authentication credentials to the entity's systems and receiving an authorization token that permits data exchange via application programming interfaces. For example, the distributor system integration manager 308 can transmit an authentication request including a client identifier and a cryptographic signature to a distributor authentication server, and can receive an authorization token encoded as a JavaScript Object Notation web token that specifies granted permissions for accessing inventory data endpoints, shipment status endpoints, and order fulfillment endpoints via a network interface that supports bidirectional application-to-application or system-to-system communications, including packets, payloads, configured adapters, or protocol formatted messages.

The distributor system integration manager 308 can maintain the connection by periodically transmitting heartbeat messages or status queries to detect connectivity disruptions or data synchronization failures. For example, the distributor system integration manager 308 can transmit a status query every five minutes to verify that the connection to a warehouse management system remains active and that inventory data remains synchronized with the adaptive SKU data structure or a portion thereof storing operational constraints.

The method 600 can include receiving operational constraints (ACT 606). The system 300 can receive the operational constraints via one or more processing components, as depicted in FIG. 3. For example, the distributor system integration manager 308 of the system 300 can receive, via the one or more interfaces from the one or more systems of the entity, one or more operational constraints of a plurality of parameters of the adaptive SKU for managing the adaptive SKU. The distributor system integration manager 308 can receive the operational constraints in response to establishing the connection in ACT 604. In some embodiments, the distributor system integration manager 308 can receive the operational constraints in response to a change event detected by the proactive monitoring engine 318. For example, the proactive monitoring engine 318 can detect a change event indicating that a shipment containing fifty units of a catheter SKU has an expected delivery date that is delayed by five days relative to an original expected delivery date, and can transmit an anomaly notification to the distributor system integration manager 308. The distributor system integration manager 308 can retrieve updated operational constraints from the distributor ERP system reflecting the revised expected delivery date. The distributor system integration manager 308 can receive the operational constraints via electronic data interchange feeds, warehouse management system APIs, or transportation management system interfaces as machine-readable data for storage with and use in execution over the adaptive SKU data structure or one or more fields thereof.

The operational constraints can include distributor-provided constraints encoded in machine-readable constraint data specifying available-to-promise inventory for one or more SKUs, lot attributes, expiry attributes, backorder attributes, shipment timing constraints, or substitution eligibility constraints. For example, the distributor system integration manager 308 can receive operational constraints from a distributor ERP system specifying available-to-promise inventory for a guidewire SKU as fifty units, lot attributes indicating a lot number range of 1000-1050, expiry attributes specifying an expiration date threshold of ninety days from the current date, backorder attributes indicating that a catheter SKU is currently backordered with an expected restocking date of fifteen days from the current date, shipment timing constraints indicating that replenishment orders require a minimum lead time of seven days, and substitution eligibility constraints indicating that the catheter SKU can be replaced with an alternative catheter SKU having a different supplier identifier provided that the alternative catheter SKU satisfies procedural compatibility requirements stored in the rule field of the adaptive SKU data structure and associated with underlying SKU identifiers stored in the membership field of the adaptive SKU data structure.

In some embodiments, the machine-readable constraint data can further define supply availability, quantity bounds, or dependency restrictions applicable to the plurality of SKUs. For example, the machine-readable constraint data can specify lower or upper quantity limits for particular SKUs, or can restrict use of one SKU when a dependency relationship with another SKU would not be satisfied upon execution of dependency logic stored in the adaptive SKU data structure.

The distributor system integration manager 308 can parse the operational constraints to extract machine-readable constraint data that can be processed by the orchestration engine 322 to determine permissible SKU allocations and substitution actions. For example, the distributor system integration manager 308 can extract the backorder attribute indicating that the catheter SKU is currently backordered with an expected restocking date of fifteen days from the current date. The distributor system integration manager 308 can transmit the backorder attribute to the orchestration engine 322. The orchestration engine 322 can, by executing or evaluating one or more rules of the adaptive SKU data structure, evaluate alternative catheter SKUs that satisfy procedural compatibility constraints stored in the rule field of the adaptive SKU data structure and that have available-to-promise inventory quantities greater than zero units as indicated in the operational constraints received from the distributor ERP system.

The adaptive SKU manager 302 can interface with the distributor system integration manager 308 to receive operational constraints that can define permissible membership modifications and quantity adjustments based on distributor inventory availability, lot attributes, expiry attributes, backorder attributes, or shipment timing constraints. For example, the adaptive SKU manager 302 can receive operational constraints from the distributor system integration manager 308 specifying that a particular guidewire SKU has an available-to-promise inventory of fifty units and a shipment timing constraint indicating that replenishment orders require a minimum lead time of seven days. The adaptive SKU manager 302 can update the rule field of the adaptive SKU data structure to include an executable membership rule that can prevent the orchestration engine 322 from selecting the particular guidewire SKU for orders that require delivery within fewer than seven days.

In some embodiments, the operational constraints can further include warehouse-specific transition parameters that define when a first warehouse is permitted to transition from a first SKU combination to a second SKU combination relative to one or more other warehouses. Such warehouse-specific transition parameters can include scheduled transition dates, depletion thresholds, receipt conditions, approval milestones, or confidence levels associated with expected inventory availability. The distributor system integration manager 308 can receive such warehouse-specific transition parameters from one or more distributor systems and can store the warehouse-specific transition parameters in association with the adaptive SKU data structure for use in subsequent action determination operations, for instance.

The method 600 can include storing operational constraints with the adaptive SKU data structure (ACT 608). The system 300 can store the operational constraints with the adaptive SKU data structure via one or more processing components, as depicted in FIG. 3. For example, the adaptive SKU manager 302 of the system 300 can store the one or more operational constraints in association with the adaptive SKU data structure. The adaptive SKU manager 302 can store the operational constraints in response to receiving the operational constraints in ACT 606, such that the constraints can be accessed during SKU selection processes executed by the orchestration engine 322, substitution evaluations performed by the adaptive SKU manager 302, or incremental recomputation operations that update quantities for a subset of the plurality of SKUs identified in the membership field of the adaptive SKU data structure.

The adaptive SKU manager 302 can store the operational constraints as additional data fields within the adaptive SKU data structure schema. In some embodiments, the adaptive SKU manager 302 can store the operational constraints as linked data records in a relational database table that references the adaptive SKU data structure via a foreign key relationship. For example, the adaptive SKU manager 302 can create a constraint record table where each record can include a constraint identifier, an adaptive SKU identifier, a constraint type field specifying whether the constraint pertains to available-to-promise inventory, lot attributes, expiry attributes, backorder attributes, or shipment timing constraints, and a constraint value field storing the machine-readable constraint data received from the distributor system integration manager 308 for subsequent access and execution in connection with the adaptive SKU data structure or one or more corresponding underlying SKU identifiers represented therein.

In some embodiments, the adaptive SKU manager 302 can store the operational constraints by creating a constraint data structure that can map each underlying SKU identifier in the membership field of the adaptive SKU data structure to a corresponding set of operational constraints received from the entity. For example, the adaptive SKU manager 302 can generate a constraint mapping table where each row can associate a guidewire SKU identifier with an available-to-promise inventory value of fifty units, a lot number range of 1000-1050, an expiration date threshold of ninety days from the current date, and a shipment timing constraint indicating a minimum lead time of seven days for replenishment orders such that SKU specific portions of the adaptive SKU data structure can be executed using the mapped constraints.

The adaptive SKU manager 302 can update the stored operational constraints periodically at scheduled intervals, in response to receiving update messages from the distributor system integration manager 308 indicating changes in inventory availability, lot attributes, or shipment timing restrictions, or in response to detecting a change event via the proactive monitoring engine 318. For instance, the adaptive SKU manager 302 can update the stored operational constraints for a suture SKU when the distributor system integration manager 308 receives an update message indicating that the available-to-promise inventory has decreased from one hundred units to twenty units due to fulfillment of a large order, and can modify the constraint value field in the constraint record table to reflect the updated inventory quantity of twenty units for the underlying SKU identifier represented in the adaptive SKU data structure.

In some embodiments, the adaptive SKU manager 302 can also cache the associated operational constraints in memory together with the adaptive SKU data structure, such that successive change events can be processed without reloading constraint data from external systems. Caching the adaptive SKU data structure together with the associated operational constraints can reduce repeated rule evaluation across successive change events and support repeated execution of the adaptive SKU data structure as a retrievable execution unit.

The method 600 can include monitoring for change events (ACT 610). The system 300 can monitor for change events via one or more processing components, as depicted in FIG. 3. For example, the proactive monitoring engine 318 of the system 300 can monitor for change events by interfacing with transportation management systems, electronic data interchange feeds, and warehouse management systems to retrieve shipment status data, supplier shipment updates, and order fulfillment records. For example, the proactive monitoring engine 318 can query shipment status data from the distributor system integration manager 308 at periodic intervals to detect delayed shipments, stock-out conditions, recall events, expiry-related restrictions, or backorder status changes for SKUs included in adaptive SKU configurations and identified in the membership field of the adaptive SKU data structure.

The proactive monitoring engine 318 can perform monitoring continuously, at scheduled intervals, or in response to receiving alert notifications from the distributor system integration manager 308 or the customer system integration manager 306. In some embodiments, the proactive monitoring engine 318 can monitor for change events by executing anomaly detection algorithms that compare retrieved data against expected delivery timelines, projected inventory states, or procedural demand forecasts to identify deviations. The anomaly detection algorithms can apply statistical threshold tests to identify deviations exceeding predefined variance limits. The anomaly detection algorithms can apply trend analysis operations to identify gradual degradation in supplier delivery performance or inventory replenishment rates that can trigger execution of an update, substitution, or recomputation operation over the adaptive SKU data structure.

The proactive monitoring engine 318 can transmit anomaly notifications to the orchestration engine 322 when a change event is detected, such that the orchestration engine 322 can determine appropriate actions based on the operational constraints and the change event. For example, the proactive monitoring engine 318 can detect a change event indicating that a shipment containing fifty units of a catheter SKU has an expected delivery date that is delayed by five days relative to an original expected delivery date, and can transmit an anomaly notification to the orchestration engine 322 to initiate substitution or allocation adjustments using the adaptive SKU data structure.

In some embodiments, the system 300 can receive, via one or more network interfaces, an update message that identifies a change event for an SKU (e.g., a first SKU) of the plurality of SKUs identified in the membership field of the adaptive SKU data structure. For example, the update message can identify that the first SKU has become unavailable, has been placed on backorder, is subject to a recall, has an expiry-related restriction, or is eligible for substitution. The one or more network interfaces can include APIs, network packets, payload-based messages, configured adapters, or protocol specific communications for bidirectional application-to-application or system-to-system exchange.

The method 600 can include determining an action based on operational constraints and change events (ACT 612). The system 300 can determine an action based on operational constraints and change events via one or more processing components, as depicted in FIG. 3. For example, the orchestration engine 322 of the system 300 can determine, based at least on the one or more operational constraints and the change event, an action to take with respect to the adaptive SKU. The orchestration engine 322 can receive the change event notification from the proactive monitoring engine 318 in ACT 610, where the change event notification can identify a stock-out condition, a recall, an expiry-related restriction, a backorder status change, or a substitution notice for an SKU (e.g., a first SKU) of the plurality of SKUs identified in the membership field of the adaptive SKU data structure. In some embodiments, the change event notification can identify an availability transition for the first SKU, including a transition into or out of an in-stock, low-stock, backordered, delayed, restricted, or unavailable state for an underlying SKU identifier represented in the adaptive SKU data structure.

The orchestration engine 322 can retrieve the one or more operational constraints stored in association with the adaptive SKU data structure by the adaptive SKU manager 302 in ACT 608, where the operational constraints can specify available-to-promise inventory for one or more SKUs, lot attributes, expiry attributes, backorder attributes, shipment timing constraints, or substitution eligibility constraints provided by the entity. The system 300 can execute one or more portions of the adaptive SKU data structure using the retrieved operational constraints.

In some embodiments, the orchestration engine 322 can determine the action by executing at least one executable rule stored in the rule field of the adaptive SKU data structure to modify the membership field of the adaptive SKU data structure by replacing the first SKU with another SKU, adding an additional SKU, or removing an SKU. For example, the orchestration engine 322 can execute an executable rule that specifies that when a catheter SKU receives a backorder status change indicating an expected restocking date of fifteen days from the current date, the orchestration engine 322 can replace the catheter SKU with an alternative catheter SKU that satisfies procedural compatibility constraints stored in the rule field of the adaptive SKU data structure and that has an available-to-promise inventory quantity greater than zero units as indicated in the operational constraints. In some embodiments, executing the at least one executable rule can enforce compatibility constraints across the ordered list of SKUs. For example, a proposed replacement or addition of an SKU can be prevented when the dependency field of the adaptive SKU data structure indicates an invalid quantity propagation outcome, including an outcome that violates a required dependency relationship, quantity limit, or procedural compatibility requirement.

In some embodiments, the orchestration engine 322 can select a distributor-level fulfillment action based at least on the one or more operational constraints provided by the entity. The distributor-level fulfillment action can include initiating a replenishment order, delaying a shipment associated with the adaptive SKU, splitting a shipment across multiple fulfillment windows, or rerouting fulfillment to an alternate distributor endpoint. For example, the orchestration engine 322 can determine that a shipment associated with the adaptive SKU is to be delayed when the operational constraints indicate that a backordered SKU has an expected restocking date of three days from the current date and when the machine learning model 324 predicts that delaying the shipment reduces the need for a more costly substitution or split shipment action. The system 300 can select the fulfillment action by evaluating stored constraints, preferences, or rules associated with the adaptive SKU data structure and one or more underlying SKU identifiers represented in the membership field thereof.

In some embodiments, the one or more operational constraints can further include warehouse-specific transition parameters that define when a first warehouse is permitted to transition from a first SKU combination to a second SKU combination relative to one or more other warehouses. Such warehouse-specific transition parameters can include scheduled transition dates, depletion thresholds, receipt conditions, approval milestones, or confidence levels associated with expected inventory availability. In some embodiments, the system 300 can apply such parameters to maintain different transition logic for different warehouses while coordinating fulfillment for a common customer or procedure type.

The orchestration engine 322 can invoke the machine learning model 324 to score and recommend action parameters based on forecasted demand, inventory availability, supplier performance metrics, or customer-defined operational parameters. The machine learning model 324 can process the forecasted demand data received from the forecasting engine 304, the inventory availability data received from the distributor system integration manager 308, the supplier performance metrics retrieved from the distributor system integration manager 308, and the customer-defined operational parameters retrieved from the customer manager 312 to generate action scores for each candidate action. The orchestration engine 322 can select the action having the highest action score from among the candidate actions when the operational constraints permit the selected action. In some embodiments, the orchestration engine 322 can determine the action by selecting a distributor based at least on the distributor preference information and the one or more operational constraints received from one or more distributor systems and stored in association with the adaptive SKU data structure or in one or more fields of the adaptive SKU data structure.

The orchestration engine 322 can determine, based at least on the one or more operational constraints, an action to take with respect to the adaptive SKU as a recommendation to the entity for a change in the plurality of SKUs that form a combination SKU for the adaptive SKU or for a different combination SKU for the adaptive SKU. For example, the orchestration engine 322 can transmit, to the distributor system integration manager 308, a recommendation identifying removal of a guidewire SKU identifier from the membership field of the adaptive SKU data structure and addition of an alternative guidewire SKU identifier to the membership field of the adaptive SKU data structure when the operational constraints indicate an expiry attribute threshold for the guidewire SKU identifier and an available-to-promise inventory quantity for the alternative guidewire SKU identifier.

In some embodiments, the orchestration engine 322 can determine, based at least on receiving a substitution notice for the first SKU, an action that performs a swap of an SKU combination of the plurality of SKUs by replacing the first SKU with a substitute SKU identified by the substitution notice. For example, the orchestration engine 322 can replace a catheter SKU identifier in the membership field of the adaptive SKU data structure with an alternate catheter SKU identifier identified by the substitution notice when the operational constraints indicate substitution eligibility constraints for the alternate catheter SKU identifier and a shipment timing constraint for the catheter SKU identifier by executing a membership modification operation over the adaptive SKU data structure.

In some embodiments, the orchestration engine 322 can determine the action by performing an incremental recomputation operation that updates quantities for a subset of the plurality of SKUs affected by the change event without recalculating quantities for SKUs that remain unaffected by the membership modification. For example, the orchestration engine 322 can perform an incremental recomputation operation that updates a guidewire SKU quantity from ten units to twelve units when the dependency field of the adaptive SKU data structure indicates that replacement of the catheter SKU with the alternative catheter SKU requires a proportional adjustment to the guidewire SKU quantity, while leaving quantities for contrast agent SKUs unmodified because the dependency field of the adaptive SKU data structure does not specify a quantity relationship between the catheter SKU and the contrast agent SKUs represented in the membership field of the adaptive SKU data structure.

In some embodiments, the dependency field of the adaptive SKU data structure can store distributor-aware quantity propagation rules that update quantities for the subset of SKUs affected by the membership modification without recomputing quantities for unaffected SKUs. For example, the dependency field of the adaptive SKU data structure can store a quantity relationship entry specifying that a substitution of an SKU (e.g., a first SKU) triggers a proportional quantity update for a second SKU, while a third SKU remains unchanged and is excluded from recomputation during execution of the adaptive SKU data structure.

In some embodiments, updating quantities without recalculating quantities for unaffected SKUs can reduce processor utilization relative to a full recomputation of quantities for some or all SKUs in the adaptive SKU. In some embodiments, determining the action and performing the incremental recomputation operation can be executed as a single coordinated transaction. Executing the determination and incremental recomputation as a single coordinated transaction can prevent cascading recalculation cycles triggered by independent SKU-level updates and can preserve consistency of the membership field and dependent quantity values stored in the adaptive SKU data structure.

In some embodiments, the system 300, via the orchestration engine 322, can generate exception alerts associated with the warehouse-specific transition parameters, including alerts for excessive ordering relative to a transition plan, days-on-hand threshold violations, missed transition milestones, or vendor shortfalls that can affect a planned transition. In some embodiments, the orchestration engine 322 can compare alternative scenarios associated with a delayed warehouse transition or schedule slip and can determine a distributor-level fulfillment action based on the comparison while maintaining different transition logic for different warehouses associated with a common customer or procedure type.

The method 600 can include communicating the action to the entity (ACT 614). The system 300 can communicate the action to the entity via one or more processing components, as depicted in FIG. 3. For example, the orchestration engine 322 of the system 300 can communicate, via the one or more interfaces, to the one or more systems of the entity the action determined in ACT 612. In some embodiments, the orchestration engine 322 can transmit a procedure-level instruction set to the entity via the distributor system integration manager 308. For example, the orchestration engine 322 can transmit a procedure-level instruction set to a distributor enterprise resource planning system via the distributor system integration manager 308. The procedure-level instruction set can specify a modified membership field of the adaptive SKU data structure indicating that a backordered catheter SKU has been replaced with an alternative catheter SKU, and updated quantities generated by the incremental recomputation operation indicating that the quantity of a guidewire SKU has been adjusted from ten units to twelve units to maintain procedural compliance. In some embodiments, the procedure-level instruction set can include a procedure-level inventory adjustment instruction that can reflect a coordinated update to the plurality of SKUs, rather than separate per-SKU instructions generated independently for individual SKU records. The orchestration engine 322 can transmit the procedure-level instruction set encoded in a structured data format such as Extensible Markup Language, JavaScript Object Notation, or Electronic Data Interchange transaction set formats that the entity's systems can parse and process to execute fulfillment operations, procurement transactions, or inventory adjustments with respect to the adaptive SKU data structure or one or more underlying SKU identifiers represented therein.

In some embodiments, the orchestration engine 322 can communicate the action by transmitting order instructions, shipment delay notifications, or inventory reallocation directives to the entity's systems via application programming interfaces or electronic data interchange protocols established by the distributor system integration manager 308. For example, the orchestration engine 322 can transmit an order instruction to a warehouse management system via an application programming interface endpoint that can specify a replenishment order for twenty units of an alternative catheter SKU having a SKU identifier of CAT-5678, a requested delivery date of seven days from the current date, and a destination distribution center identifier of DC-001. The order instruction can correspond to a transaction executed using the adaptive SKU data structure.

The orchestration engine 322 can receive confirmation messages from the entity's systems via the distributor system integration manager 308 indicating that the action has been executed. The orchestration engine 322 can transmit the confirmation messages to the adaptive SKU manager 302, which can update the stored operational constraints in the adaptive SKU data structure to reflect the expected restocking date and available-to-promise inventory for the alternative catheter SKU. For example, the adaptive SKU manager 302 can receive a confirmation message from a warehouse management system indicating that a replenishment order for twenty units of the alternative catheter SKU has been initiated with an expected restocking date of seven days from the current date, and can update a constraint value field in a constraint record table associated with the adaptive SKU data structure to reflect an available-to-promise inventory quantity of twenty units and an expected restocking date attribute specifying the date seven days from the current date.

In some embodiments, the orchestration engine 322 can transmit the confirmation messages to the proactive monitoring engine 318, which can schedule subsequent monitoring operations to verify that the entity executes the action within an expected time window. For example, the proactive monitoring engine 318 can schedule a monitoring query to be executed three days after the confirmation message is received to retrieve shipment status data from the distributor system integration manager 308 and determine whether the replenishment order for the alternative catheter SKU has been shipped or is still pending. The system 300 can use the retrieved status data to update or re-execute one or more portions of the adaptive SKU data structure.

In some embodiments, the orchestration engine 322 can communicate, via the distributor system integration manager 308, the action as a recommendation that identifies a change in the plurality of SKUs that form the combination SKU or that identifies a different combination SKU for the adaptive SKU. For example, the orchestration engine 322 can transmit, to a distributor enterprise resource planning system via the distributor system integration manager 308, a recommendation message that identifies a first ordered list of underlying SKU identifiers for a first combination SKU and a second ordered list of underlying SKU identifiers for a second combination SKU, and that identifies a selection of the second combination SKU based on the operational constraints and execution of the adaptive SKU data structure or one or more executable portions thereof.

### F. Systems and Methods for Managing Adaptive Stock-Keeping Units Using Customer Parameters

The present description relates to techniques for managing adaptive stock-keeping units using customer parameters. Distributors can maintain inventory allocations for procedure-based workflows by grouping multiple stock-keeping units into procedure-specific combinations. Customers can establish parameters that define site-specific ordering limits to guide inventory allocations across multiple customer sites. However, certain approaches to managing procedure-based inventory fail to provide mechanisms to enforce customer-defined parameters when processing stock-keeping unit substitutions or redistribution actions across customer sites. Certain systems can track inventory levels for individual stock-keeping units but fail to maintain procedure-level inventory configurations that encode quantity dependencies between multiple stock-keeping units consumed together as part of a procedure. Certain systems also fail to enforce site-specific ordering limits or allocation limits when processing order requests, such that orders can violate customer-defined constraints. Additionally, certain approaches fail to provide mechanisms to trigger membership modifications to stock-keeping unit combinations based on inventory thresholds at specific customer sites, resulting in user driven intervention to update stock-keeping unit combinations when inventory levels fall below customer-defined thresholds.

The technical solutions described herein provide a system that can maintain an adaptive stock-keeping unit data structure having a schema that can store customer-defined parameters in association with procedure-level inventory configurations. The system can enforce customer-defined constraints when processing order requests and can trigger membership modifications to stock-keeping unit combinations based on inventory thresholds at customer sites. The system can establish connections to customer systems via interfaces that can allow customers to submit order requests identifying procedure identifiers and to transmit customer parameters that define site-specific ordering limits.

To implement the technical solutions described herein, the system can maintain an adaptive stock-keeping unit data structure that can store a procedure-key field, a membership field storing an ordered list of stock-keeping unit identifiers, a dependency field storing quantity relationship entries, and a rule field storing executable membership rules. The system can receive customer parameters from customer systems via interfaces and can store the customer parameters in association with the adaptive stock-keeping unit data structure. The system can process order requests by retrieving site-level constraints from the customer parameters and by verifying that requested order quantities do not violate the site-level constraints. The system can monitor inventory values across customer sites and can trigger membership modifications to the ordered list when an inventory value at a first site satisfies a threshold condition by executing executable membership rules stored in the rule field.

The technical solutions described herein provide a system that can enforce customer-defined constraints when processing stock-keeping unit substitutions and order requests. By maintaining procedure-level inventory configurations that encode quantity dependencies between related stock-keeping units, the system can adjust quantities for related stock-keeping units when a membership modification occurs, such that the system can maintain consistent stock-keeping unit combinations across customer sites. The technical solutions described herein can improve the alignment between customer-defined preferences and system actions by processing customer parameters such that the system can generate recommended configurations and redistribution actions that conform to customer-defined operational constraints.

Furthermore, certain customer-facing inventory and ordering computing systems can be architecturally constrained to processing orders and inventory state at an individual SKU level. In such systems, customer ordering interfaces, site-level inventory records, and supplier ordering workflows can be implemented as separate, loosely coordinated components. When a customer orders items associated with a procedure that requires multiple interdependent SKUs, the system is to repeatedly assemble the required set of SKUs, evaluate substitution and configuration rules, and reconcile quantities across multiple records and services. Such operations can be performed independently for each SKU and for each site, resulting in repeated traversal of inventory records, repeated rule evaluation, and repeated quantity recalculation.

Such architecture can create a computing resource problem rather than a user-facing limitation. For example, customer parameters such as site inventories, ordering thresholds, configuration preferences, and transition requests can be processed as independent inputs that trigger multiple downstream computations. A change in inventory at one site, a threshold condition, or a request to transition to a different configuration can cause the system to repeatedly recompute procedure-level inventory state, allocate temporary in-memory structures to reconcile SKU combinations, and issue multiple read and write operations across distributed data stores. As customer ordering volume and site-level granularity increase, such repeated per-SKU computations can increase processor utilization, memory churn, and I/O overhead, and introduce latency into order placement, redistribution, and configuration workflows.

Certain systems can also fail to provide a durable, procedure-linked representation that can allow customer ordering actions to be evaluated and executed as coordinated operations. Instead, configuration changes, substitutions, and redistribution decisions can be applied incrementally and non-atomically across individual SKUs, which can increase the likelihood of inconsistent intermediate states between customer-facing ordering interfaces, internal inventory records, and supplier-facing order actions. Such limitations can arise from how the computing system models and processes inventory data, not from the content of the customer request itself.

The present solution can improve customer-facing inventory and ordering computing by configuring one or more processors to manage procedure-based inventory using an adaptive stock-keeping unit maintained as an adaptive SKU data structure. The adaptive SKU data structure can be stored in memory and can have a defined schema including a procedure-key field storing a procedure identifier, a membership field storing an ordered list of identifiers for a plurality of SKUs that form a combination SKU for the procedure, a dependency field storing quantity relationship entries that define propagation rules between SKUs, and a rule field storing executable membership rules that define permitted modifications to the ordered list.

The system can establish one or more connections, via one or more interfaces, to one or more systems of an entity and can provide an ordering interface through which the entity can request one or more units associated with the adaptive SKU. Customer parameters received through the ordering interface, including site-level inventory values, thresholds, configuration preferences, and ordering constraints, can be stored in association with the adaptive SKU data structure rather than being distributed across independent SKU records.

When an order request, inventory update, threshold condition, or transition request is received, the system can evaluate the request at the level of the adaptive SKU. Executable membership rules stored in the rule field can be applied to modify the membership field when a configuration change, substitution, or transition is required. Quantity updates can be performed using the dependency field by executing an incremental recomputation operation that can update quantities for the subset of SKUs affected by the membership modification, without recalculating quantities for unaffected SKUs.

The system can initiate supplier orders, trigger redistribution across sites, or generate a recommended configuration using the adaptive SKU as a procedure-linked execution unit. Because membership, dependency relationships, executable rules, and customer parameters can be stored together and accessed using the procedure identifier, the system can perform customer ordering and inventory management as coordinated, procedure-level computations rather than as repeated per-SKU operations.

The present solution can generate concrete technical effects in the operation of customer-facing inventory and ordering computing systems by reducing processor usage, memory consumption, and I/O overhead associated with procedure-based ordering workflows. By maintaining the adaptive SKU as a stored, procedure-linked data structure, the system can reduce repeated database reads and repeated reconstruction of procedure-level SKU sets that would otherwise be required each time a customer order, site inventory update, or configuration request is processed.

The incremental recomputation operation can further reduce computing resource consumption by limiting quantity updates to SKUs affected by a membership field modification. Such a configuration can avoid full recomputation of quantities across some or all SKUs in the combination and can eliminate iterative correction loops that arise when substitutions or configuration changes are applied independently at the SKU level. As a result, processor utilization can be reduced during high-volume ordering and inventory update scenarios.

Additionally, memory efficiency can be improved by reducing the creation of temporary in-memory reconciliation structures. Certain systems frequently allocate transient objects to assemble SKU combinations, evaluate substitution logic, and reconcile site-level inventory changes. By storing the membership field, dependency field, rule field, and customer parameters in association with the adaptive SKU data structure, the technical solutions described herein can facilitate efficient caching of procedure-level state while reducing memory churn and memory reclamation overhead during repeated ordering operations.

Storage and I/O efficiency can also be improved. Procedure-level configuration logic, quantity relationships, and site-level constraints can no longer be duplicated across multiple SKU records or maintained in separate mapping tables. Instead, this information can be persisted within the adaptive SKU data structure, thereby reducing redundant storage and reducing the number of read and write operations to keep the customer-facing ordering state consistent with the internal inventory state.

In addition, coordinated execution of membership modification and incremental recomputation can reduce inconsistent intermediate states across ordering, inventory, and supplier interfaces. Customer requests to order, reconfigure, or redistribute adaptive SKUs can be executed as coherent procedure-level operations to improve system stability and responsiveness. The overall effect is an inventory and ordering computing system that can perform customer-driven procedure-based operations more efficiently and consistently while consuming fewer computing resources than certain SKU-level architectures.

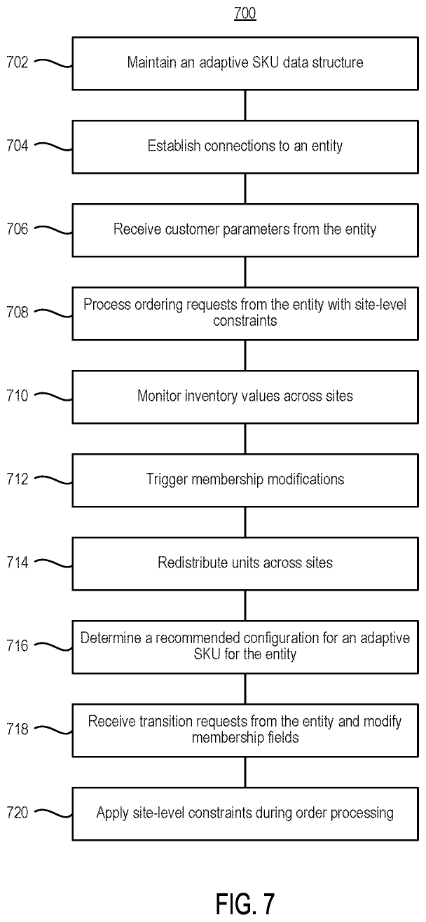

Referring now to FIG. 7, illustrated is a method 700 for managing adaptive stock-keeping units using customer parameters. The method 700 can be executed, performed, or otherwise carried out by any of the computing systems or devices described herein, and any of the components thereon, such as depicted in FIG. 3. In brief overview of the method 700, the method 700 can include maintaining an adaptive SKU data structure (ACT 702), establishing connections to an entity (ACT 704), receiving customer parameters from the entity (ACT 706), processing ordering requests from the entity with site-level constraints (ACT 708), monitoring inventory values across sites (ACT 710), triggering membership modifications (ACT 712), redistributing units across sites (ACT 714), determining a recommended configuration for an adaptive SKU for the entity (ACT 716), receiving transition requests from the entity and modifying membership fields (ACT 718), and applying site-level constraints during order processing (ACT 720).

The method 700 can include maintaining an adaptive SKU data structure (ACT 702). The system 300 can maintain an adaptive SKU data structure via one or more processing components, as depicted in FIG. 3. For example, the adaptive SKU manager 302 of the system 300 can maintain, in memory, an adaptive SKU data structure associated with a type of procedure, where the adaptive SKU can include a combination SKU having a plurality of SKUs for the type of procedure and having a plurality of parameters. For example, the adaptive SKU manager 302 can maintain an adaptive SKU data structure for a cardiac catheterization procedure that includes a combination SKU having a guidewire SKU, a catheter SKU, and a contrast agent SKU, where the plurality of parameters can include supplier details, lot ranges, expiry date cushions, or dynamic SKU quantities.

The adaptive SKU manager 302 can maintain the adaptive SKU data structure in response to initialization of the system 300 or in response to updates to procedural requirements or SKU availability. In some embodiments, the adaptive SKU manager 302 can maintain the adaptive SKU data structure by periodically synchronizing the data structure with distributor enterprise resource planning systems to reflect current SKU configurations and inventory states. The adaptive SKU manager 302 can update values stored in the adaptive SKU data structure for subsequent execution thereof.

In some embodiments, the system 300 can retrieve and update the adaptive SKU data structure as a single procedure-linked object keyed by the procedure identifier stored in the procedure-key field for reducing repeated database reads of separate SKU records during processing of change events. In some embodiments, the system 300 can cache, in memory, at least a portion of the adaptive SKU data structure including the membership field, the dependency field, and the rule field, and reuse the cached portion across a plurality of update messages to reduce repeated rule evaluation and repeated reconstruction of procedure-level state. The system 300 can execute the cached portion as a retrievable execution unit. The execution unit can refer to a stored set of data, logic, rules, parameters, instructions, or structure that the system 300 can process, evaluate, or execute as a unit during an operation.

The adaptive SKU manager 302 can maintain the adaptive SKU data structure by storing the data structure in a non-transitory computer-readable medium, where the schema can include a procedure-key field storing a procedure identifier, a membership field storing an ordered list of underlying SKU identifiers, a dependency field storing quantity relationship entries, or a rule field storing executable membership rules. The adaptive SKU manager 302 can update the data structure continuously or periodically to reflect changes in SKU availability, supplier relationships, or procedural requirements, such that the data structure remains synchronized with operational constraints and customer preferences used in ordering, transition, or redistribution operations.

The method 700 can include establishing connections to an entity (ACT 704). The system 300 can establish connections to an entity via one or more processing components, as depicted in FIG. 3. For example, the customer system integration manager 306 of the system 300 can establish one or more connections via one or more interfaces to one or more systems of a customer entity, where the one or more interfaces provide an ordering interface for the customer entity to request one or more units associated with the adaptive SKU. For example, the customer system integration manager 306 can establish an authenticated interface session with a customer inventory management system by transmitting an authentication request including a client identifier and receiving an authorization token that specifies granted permissions for accessing ordering endpoints and inventory data endpoints.

The customer system integration manager 306 can establish the connections in response to a system initialization event or in response to a request from the customer entity to access the ordering interface. In some embodiments, the customer system integration manager 306 can establish the connections by executing a handshake protocol that verifies credentials and establishes secure communication channels for transmitting order requests and inventory updates. In some embodiments, the customer system integration manager 306 can establish the connections by configuring application programming interface endpoints that receive order requests, inventory alerts, and SKU migration schedules from the one or more systems of the customer entity. The customer system integration manager 306 may maintain the connections by periodically transmitting heartbeat messages or status queries to detect connectivity disruptions and data synchronization failures, such that the ordering interface remains accessible to the customer entity via bidirectional application-to-application or system-to-system communications, including packets, payloads, configured adapters, or protocol-formatted messages.

The method 700 can include receiving customer parameters from the entity (ACT 706). The system 300 can receive customer parameters from the entity via one or more processing components, as depicted in FIG. 3. For example, the customer system integration manager 306 of the system 300 can receive, by the one or more interfaces from the one or more systems of the customer entity, one or more customer parameters of the plurality of parameters for managing the adaptive SKU, and can store the one or more customer parameters in association with the adaptive SKU data structure. For example, the customer system integration manager 306 can receive customer parameters including inventory values for the adaptive SKU at a plurality of sites of the customer entity, usage factor ranges for each SKU combination, and site-level constraints specifying site-specific ordering limits for at least one SKU identifier in the ordered list.

The customer system integration manager 306 can receive the customer parameters in response to configuration updates submitted by customer users or in response to periodic synchronization operations that retrieve current parameter values from the one or more systems of the customer entity. In some embodiments, the customer system integration manager 306 can receive the customer parameters by parsing batch inventory files, flat-file inventory files, or episodic inventory alerts transmitted by the customer entity via the one or more interfaces. The customer system integration manager 306 can receive the customer parameters by extracting data from structured messages transmitted via the ordering interface, where the messages can include fields specifying recommended usage ranges, site prioritization preferences, or SKU migration sequencing rules for storage in or association with the adaptive SKU data structure.

In some embodiments, the one or more customer parameters can include one or more combination rules that define, for the adaptive SKU, permitted substitutions in which one SKU identifier in the ordered list is replaced with a different SKU identifier, such as a rule specifying that a first catheter SKU identifier can be replaced with a second catheter SKU identifier that satisfies compatibility requirements for the type of procedure. The one or more combination rules can be executable from the adaptive SKU data structure.

The customer system integration manager 306 can store the one or more customer parameters as additional data fields within the adaptive SKU data structure schema or as linked data records in a relational database table that references the adaptive SKU data structure via a foreign key relationship. In some embodiments, the one or more customer parameters can further include transition calendar data associated with at least one customer site, warehouse, or both, such that transition timing for a first SKU combination and a second SKU combination can vary by customer, by site, or by warehouse. The transition calendar data can identify planned transition dates, approval milestones, confidence levels, or exception states for one or more underlying SKU identifiers or SKU combinations. In some embodiments, the system 300 can process a shared transition calendar across multiple teams and can apply warehouse-specific transition logic such that a first warehouse can continue fulfillment according to a first transition schedule while a second warehouse fulfills according to a second transition schedule for the same procedure type or adaptive SKU.

The method 700 can include processing ordering requests from the entity with site-level constraints (ACT 708). The system 300 can process ordering requests from the entity with site-level constraints via one or more processing components, as depicted in FIG. 3. For example, the orchestration engine 322 of the system 300 can process the ordering requests in response to receiving the order request via the ordering interface or in response to detecting a threshold condition that triggers automatic order generation. The ordering interface can receive an order request from the customer entity for one or more units associated with the adaptive SKU, where the order request can identify at least the procedure identifier stored in the procedure-key field, and the ordering interface can enforce site-level constraints when processing the order request. For example, the orchestration engine 322 can receive an order request from a first site of the customer entity requesting ten units of a guidewire SKU for a cardiac catheterization procedure, can retrieve a site-level constraint specifying a maximum ordering limit of fifteen units for the guidewire SKU at the first site, and can process the order request by verifying that the requested quantity of ten units does not exceed the maximum ordering limit.

In some embodiments, the orchestration engine 322 can process the ordering requests by applying executable membership rules stored in the rule field of the adaptive SKU data structure to determine whether the requested SKU combination satisfies compatibility constraints and dependency restrictions. The orchestration engine 322 can process the ordering requests by retrieving operational constraints from the distributor system integration manager 308, evaluating available-to-promise inventory quantities for the requested SKUs, and determining whether the order can be fulfilled within the requested delivery timeframe. The orchestration engine 322 can generate a fulfillment instruction set specifying a modified membership field of the adaptive SKU data structure and updated quantities for the adaptive SKU, where the fulfillment instruction set can be transmitted to the distributor enterprise resource planning system to initiate order processing.

In some embodiments, the method 700 can further include initiating, via a second one or more interfaces or one or more additional interfaces to a supplier system, an order for one or more units associated with at least one SKU identifier in the ordered list based at least on the one or more customer parameters. The distributor system integration manager 308 can establish the second one or more interfaces with one or more supplier systems, such as distributor enterprise resource planning systems, supplier ordering platforms, or warehouse management systems. The distributor system integration manager 308 can transmit an order message identifying the at least one SKU identifier, a requested quantity, and one or more delivery parameters derived from the one or more customer parameters. For example, the orchestration engine 322 can determine, based on the one or more customer parameters, that a first site requires ten additional units of a catheter SKU identifier, can generate a fulfillment instruction identifying the catheter SKU identifier and the requested quantity, and can cause the distributor system integration manager 308 to transmit, via the second one or more interfaces to the supplier system, an order for the ten additional units to replenish inventory associated with the adaptive SKU. The system 300 can initiate the order as a transaction using the adaptive SKU data structure or one or more portions thereof.

The method 700 can include monitoring inventory values across sites (ACT 710). The system 300 can monitor inventory values across sites via one or more processing components, as depicted in FIG. 3. For example, the customer system integration manager 306 of the system 300 can receive inventory values for the adaptive SKU at a plurality of sites of the customer entity, and can store the inventory values in association with the adaptive SKU data structure. For example, the customer system integration manager 306 can receive inventory values indicating that a first site of the customer entity has five units of a guidewire SKU on hand, a second site has twelve units on hand, and a third site has three units on hand, and can store the inventory values in a linked data table that references the adaptive SKU data structure via a foreign key relationship.

The customer system integration manager 306 can monitor the inventory values in response to receiving batch inventory files, micro-batch inventory files, or episodic inventory alerts from the one or more systems of the customer entity. In some embodiments, the customer system integration manager 306 can monitor the inventory values by periodically querying the one or more systems of the customer entity to retrieve current on-hand quantities for each SKU identifier in the ordered list at each site. For example, the customer system integration manager 306 can transmit a query message every hour, for instance, to a customer inventory management system requesting current stock levels for each SKU identifier associated with the adaptive SKU data structure, can receive a response message including quantity values for each site, and can update the stored inventory values in the linked data table. In some embodiments, the customer system integration manager 306 can monitor the inventory values by receiving real-time or near real-time updates from customer inventory management systems that transmit inventory change notifications whenever a SKU quantity is adjusted due to consumption, receipt, or redistribution via one or more network interfaces including APIs, packets, payloads, configured adapters, or protocol formatted messages.

The customer system integration manager 306 can update the stored inventory values continuously or periodically to maintain an accurate representation of current stock levels across the plurality of sites, such that the orchestration engine 322 can determine recommended configurations and redistribution actions based on up-to-date inventory data stored in or associated with the adaptive SKU data structure.

The method 700 can include triggering membership modifications (ACT 712). The system 300 can trigger membership modifications via one or more processing components, as depicted in FIG. 3. For example, the adaptive SKU manager 302 of the system 300 can determine that an inventory value for the adaptive SKU at a first site satisfies a threshold condition and, responsive to the threshold condition, can trigger a membership modification of the ordered list using at least one executable membership rule stored in the rule field of the adaptive SKU data structure.

In some embodiments, the system 300 can receive an update message identifying a change event associated with a first SKU identifier in the membership field of the adaptive SKU data structure, and select at least one executable membership rule from the rule field of the adaptive SKU data structure based on the change event to modify the ordered list, where the change event can include stock-out, recall, or supplier transition events. For example, the adaptive SKU manager 302 can determine that an inventory value of three units for a catheter SKU at a first site has fallen below a threshold condition of five units, and can trigger a membership modification by executing an executable membership rule that replaces the catheter SKU identifier with an alternative catheter SKU identifier having available inventory.

The adaptive SKU manager 302 can trigger the membership modifications in response to detecting that the inventory value satisfies the threshold condition or in response to receiving an asynchronous event notification indicating a stock-out condition, recall, or backorder status change. In some embodiments, the adaptive SKU manager 302 can trigger the membership modifications by evaluating multiple threshold conditions associated with different SKU identifiers in the ordered list, and can execute a sequence of membership modifications to address multiple inventory shortfalls or substitution requirements using the adaptive SKU data structure as an execution unit.

In some embodiments, the system 300 can perform an incremental recomputation operation that updates quantities for the subset of SKU identifiers affected by the modification of the ordered list by applying one or more quantity relationship entries in the dependency field of the adaptive SKU data structure, without recomputing quantities for SKU identifiers that are unaffected. In some embodiments, the modification of the membership field of the adaptive SKU data structure and the incremental recomputation operation can be executed as a single coordinated transaction that prevents inconsistent intermediate quantity states and reduces repeated correction cycles that would otherwise be triggered by independent per-SKU updates. For example, the adaptive SKU manager 302 can evaluate a first threshold condition specifying that a catheter SKU inventory at a first site has fallen below five units and a second threshold condition specifying that a guidewire SKU inventory at the first site has fallen below ten units, and can determine that both threshold conditions are satisfied. The adaptive SKU manager 302 can execute a first membership modification that replaces the catheter SKU identifier with an alternative catheter SKU identifier and a second membership modification that replaces the guidewire SKU identifier with an alternative guidewire SKU identifier, where each replacement satisfies compatibility constraints stored in the rule field.

The adaptive SKU manager 302 can trigger the membership modifications by retrieving executable membership rules from the rule field of the adaptive SKU data structure, evaluating the current state of the membership field of the adaptive SKU data structure and the dependency field of the adaptive SKU data structure, and determining whether a substitution, addition, or removal operation can be permitted under the stored compatibility constraints. The adaptive SKU manager 302 can execute the membership modifications by updating the membership field of the adaptive SKU data structure to reflect the replacement, addition, or removal of an underlying SKU identifier, and by performing an incremental recomputation operation that can update quantities for a subset of SKU identifiers affected by the membership modification.

The method 700 can include redistributing units across sites (ACT 714). The system 300 can redistribute units across sites via one or more processing components, as depicted in FIG. 3. For example, the orchestration engine 322 of the system 300 can trigger a redistribution of one or more units associated with the adaptive SKU across the plurality of sites based at least on the inventory values and the one or more customer parameters. For example, the orchestration engine 322 can determine that a first site of the customer entity has three units of a guidewire SKU on hand and a second site has twelve units on hand, can retrieve a customer parameter specifying that the first site has a higher priority for receiving SKU allocations, and can trigger a redistribution by transmitting an instruction to transfer five units of the guidewire SKU from the second site to the first site.

The orchestration engine 322 can trigger the redistribution in response to detecting that the inventory values satisfy a redistribution threshold condition or in response to receiving a customer-defined preference indicating that redistribution is preferred when inventory imbalances exceed a specified threshold. In some embodiments, the orchestration engine 322 can trigger the redistribution by generating a redistribution instruction set that can specify source sites, destination sites, SKU identifiers, or quantities to be transferred, and by transmitting the redistribution instruction set to the distributor system integration manager 308 for execution via a warehouse management system. For example, the orchestration engine 322 can generate a redistribution instruction set encoded as a JavaScript Object Notation data structure that can include a source site field storing an identifier of the second site, a destination site field storing an identifier of the first site, an SKU identifier field storing an identifier of the guidewire SKU, and a quantity field storing a transfer quantity value of five units. The orchestration engine 322 can transmit the redistribution instruction set to the distributor system integration manager 308, which can provide the instruction set to a warehouse management system to initiate the physical transfer of the five units from the second site to the first site via a network interface using protocol formatted messages, packets, or payloads.

The orchestration engine 322 can trigger the redistribution by evaluating site-level inventory values, site prioritization preferences stored in the one or more customer parameters, or expected delivery dates for in-transit shipments retrieved from the distributor system integration manager 308, and by determining an optimal redistribution plan that minimizes transportation costs while satisfying customer preferences. The orchestration engine 322 can execute the redistribution by coordinating with the distributor system integration manager 308 to initiate shipment orders, update inventory records across the warehouse management system, and transmit confirmation notifications to the customer entity via the customer system integration manager 306 indicating that the redistribution has been completed. The system 300 can determine the redistribution using values stored in or associated with the adaptive SKU data structure.

The method 700 can include determining a recommended configuration for an adaptive SKU for the entity (ACT 716). The system 300 can determine a recommended configuration for an adaptive SKU for the entity via one or more processing components, as depicted in FIG. 3. For example, the orchestration engine 322 of the system 300 can determine a recommended configuration of the adaptive SKU for the customer entity, where the recommended configuration can identify at least one of a modified ordered list of SKU identifiers or a modified set of the one or more customer parameters. For example, the orchestration engine 322 can determine a recommended configuration that can replace a catheter SKU identifier in the ordered list with an alternative catheter SKU identifier having a lower cost per unit and a higher available-to-promise inventory quantity, and can modify a customer parameter specifying a usage factor range to account for the substitution by increasing a maximum usage factor threshold from eight units per procedure to ten units per procedure. The orchestration engine 322 can determine the recommended configuration in response to detecting a change event such as a stock-out condition, recall, or backorder status change, or in response to periodic optimization operations that evaluate whether alternative SKU combinations can reduce costs or improve service levels.

In some embodiments, the orchestration engine 322 can determine the recommended configuration by invoking the machine learning model 324, which can process demand forecast data, inventory datasets, procedural classification parameters, or distributor-defined selection criteria to generate action scores for candidate SKU configurations. For example, the machine learning model 324 can receive demand forecast data indicating an expected increase in cardiac catheterization procedure volume from thirty procedures per week to forty-five procedures per week over a three-month period. The machine learning model 324 can retrieve inventory datasets indicating current on-hand quantities of fifty units for a catheter SKU at a first distribution center and seventy units at a second distribution center, and can retrieve procedural classification parameters specifying that the cardiac catheterization procedure demands at least one catheter SKU, one guidewire SKU, and one contrast agent SKU per procedure. The machine learning model 324 can retrieve distributor-defined selection criteria specifying a preference for substituting higher-margin SKU combinations when available-to-promise inventory exceeds a threshold of one hundred units, and can generate action scores for three candidate SKU configurations by computing a cost impact metric, a margin performance metric, and a service level satisfaction metric for each candidate configuration. The machine learning model 324 can assign a first action score of 0.85 to a first candidate configuration that substitutes the alternative catheter SKU, assign a second action score of 0.72 to a second candidate configuration that retains the original catheter SKU but increases order quantities for the guidewire SKU, and assign a third action score of 0.68 to a third candidate configuration that delays substitution until inventory for the original catheter SKU falls below a threshold of twenty units. The orchestration engine 322 can select the first candidate configuration based on the first action score being higher than the second action score and the third action score, for instance. The candidate SKU configurations can be represented by or derived from the adaptive SKU data structure.

The orchestration engine 322 can determine the recommended configuration by evaluating multiple candidate configurations using a multi-tiered recommender framework that scores each configuration based on cost impact, margin performance, or ability to satisfy customer service level requirements. The orchestration engine 322 can transmit the recommended configuration to the customer manager 312 for presentation to customer users via an approval interface, where the customer users can review the recommended configuration and approve or reject the proposed modifications to the adaptive SKU data structure.

The method 700 can include receiving transition requests from the entity and modifying membership fields (ACT 718). The system 300 can receive transition requests from the entity and modify membership fields via one or more processing components, as depicted in FIG. 3. For example, the customer system integration manager 306 can receive, via the ordering interface, a transition request from the customer entity to transition from a first combination of the plurality of SKUs to a second combination of the plurality of SKUs, and the adaptive SKU manager 302 can modify the membership field of the adaptive SKU data structure responsive to the transition request using at least one executable membership rule stored in the rule field of the adaptive SKU data structure. For instance, the customer system integration manager 306 can receive a transition request indicating that the customer entity wishes to transition from a first combination including a catheter SKU having a first supplier identifier to a second combination including an alternative catheter SKU having a second supplier identifier, and the adaptive SKU manager 302 can execute an executable membership rule that verifies the alternative catheter SKU can satisfy procedural compatibility requirements stored in the rule field of the adaptive SKU data structure before replacing the first catheter SKU identifier with the alternative catheter SKU identifier in the membership field of the adaptive SKU data structure. The procedural compatibility requirement can specify that the alternative catheter SKU has a matching diameter specification of two millimeters and a matching length specification of one hundred fifty centimeters relative to the first catheter SKU. In some embodiments, the transition request handling can also process an update message identifying a change event associated with a SKU in the membership field of the adaptive SKU data structure and selecting the membership rule based on the event.

The adaptive SKU manager 302 can perform an incremental recomputation operation to update quantities for SKUs affected by the transition, without recomputing unaffected SKUs. Such modification and recomputation can be executed as a single coordinated transaction to prevent intermediate inconsistencies. The adaptive SKU data structure can be updated as a procedure-linked object keyed by the procedure identifier, and the cached membership, dependency, and rule fields can be reused across multiple transitions to avoid repeated evaluation overhead during execution of the adaptive SKU data structure.

The customer system integration manager 306 can receive the transition request in response to a customer-initiated configuration update, a change in medical equipment used at customer sites, or a regulatory rule mandating an SKU transition. In some embodiments, the customer system integration manager 306 can receive the transition request by parsing a structured message transmitted via the ordering interface, where the message can include a first combination field storing identifiers for the first catheter SKU, a guidewire SKU, and a contrast agent SKU, a second combination field storing identifiers for the alternative catheter SKU, the guidewire SKU, and the contrast agent SKU, and a requested transition timeline field storing a transition completion date of thirty days from a current date. The system 300 can receive the structured message via one or more APIs, packets, payloads, configured adapters, or protocol formatted interfaces.

The adaptive SKU manager 302 can modify the membership field of the adaptive SKU data structure by retrieving executable membership rules from the rule field of the adaptive SKU data structure, evaluating whether the transition from the first combination to the second combination satisfies stored compatibility constraints and dependency restrictions, and executing a membership modification operation that updates the ordered list of underlying SKU identifiers to replace the first catheter SKU identifier with the alternative catheter SKU identifier while retaining the guidewire SKU identifier and the contrast agent SKU identifier in the ordered list.

The adaptive SKU manager 302 can perform an incremental recomputation operation that updates quantities for a subset of SKU identifiers affected by the membership modification by applying quantity relationship entries in the dependency field of the adaptive SKU data structure. For example, quantities for the second combination can be recalculated by retrieving a quantity relationship entry specifying that a substitution of the catheter SKU can trigger a proportional adjustment to the guidewire SKU quantity based on a usage factor ratio of one-point-two units of guidewire per unit of catheter, computing an updated guidewire SKU quantity of twelve units by multiplying a baseline catheter SKU quantity of ten units by the usage factor ratio, and storing the updated guidewire SKU quantity in association with the adaptive SKU data structure without requiring full recomputation of the contrast agent SKU quantity.

The method 700 can include applying site-level constraints during order processing (ACT 720). The system 300 can apply site-level constraints during order processing via one or more processing components, as depicted in FIG. 3. The orchestration engine 322 of the system 300 can retrieve a site-level constraint from the one or more customer parameters stored in association with the adaptive SKU data structure, where the site-level constraint can specify a maximum ordering limit, a minimum allocation limit, or both limits for a designated SKU identifier at a designated site of the customer entity. For example, the orchestration engine 322 can retrieve a site-level constraint specifying that a first site of the customer entity has a maximum ordering limit of fifteen units for a guidewire SKU identifier and a minimum allocation limit of five units for a catheter SKU identifier, and can receive an order request via the ordering interface for ten units of the guidewire SKU and six units of the catheter SKU. The orchestration engine 322 can process the order request by verifying that the requested quantity of ten units for the guidewire SKU does not exceed the maximum ordering limit of fifteen units and that the requested quantity of six units for the catheter SKU satisfies the minimum allocation limit of five units before generating a fulfillment instruction. The one or more customer parameters can include at least one site-level constraint specifying site-specific ordering limits or allocation limits for at least one SKU identifier in the ordered list, and the ordering interface can enforce the site-level constraint when processing an order request.

The orchestration engine 322 can apply the site-level constraints in response to receiving an order request via the ordering interface or in response to determining a recommended configuration that includes modifications to SKU quantities at specific sites. In some embodiments, the orchestration engine 322 can apply the site-level constraints by retrieving constraint metadata from the adaptive SKU data structure and evaluating whether the requested order quantities or recommended configuration quantities fall within the specified ordering limits or allocation limits. The orchestration engine 322 can reject or modify the order request when the constraints are not satisfied by executing one or more rules or constraint values stored in or associated with the adaptive SKU data structure.

The orchestration engine 322 can generate an alert notification when an order request would violate a site-level constraint, and the alert notification can be transmitted to the customer manager 312 for presentation to customer users via an approval interface. The orchestration engine 322 can enforce the site-level constraints by adjusting order quantities to conform to the maximum ordering limits, splitting orders across multiple sites when a single site cannot fulfill the requested quantity within the specified limits, or delaying order fulfillment until inventory levels at constrained sites are replenished, such that some or all processed orders can comply with the site-specific ordering limits and allocation limits defined by the customer entity.

### G. Systems and Methods for Forecasting Adaptive Stock-Keeping Units Using Procedure Projections and Distributor Data

The present description relates to techniques for forecasting adaptive stock-keeping units using procedure projections and distributor data. Forecasting systems can process procedure data and factor-based data from heterogeneous data source systems to generate quantity estimates for adaptive stock-keeping units for a given time period. Adaptive stock-keeping units can be maintained as procedure-level inventory configurations that associate a plurality of underlying stock-keeping unit identifiers with a specific procedure type, such that inventory allocations can be managed at the procedure level. For example, for a surgical procedure, an adaptive stock-keeping unit can include a combination of guidewire identifiers, catheter identifiers, and contrast agent identifiers associated with the surgical procedure.

However, certain forecasting systems fail to incorporate distributor-specific delivery timing data into quantity estimates for adaptive stock-keeping units. Certain approaches can apply machine learning models to procedure volume projections and operational parameters to generate initial quantity estimates, but such approaches fail to refine the initial quantity estimates based on delivery dates provided by distributor systems. As a result, quantity estimates can fail to account for supplier delays, shipment rescheduling, or fulfillment timing constraints.

The technical solutions described herein can store, in a data store, an adaptive stock-keeping unit data structure having a schema that can include an adaptive stock-keeping unit identifier, a procedure-key field storing a procedure identifier for a type of procedure, and a membership field storing an ordered list of underlying stock-keeping unit identifiers for a combination stock-keeping unit associated with the type of procedure. An ingestion engine can receive procedure data associated with the procedure identifier from heterogeneous data source systems, where the procedure data can include a projection of volumes of the procedure for a given time period. The ingestion engine can also receive factor-based data including operational parameter values that can cause changes in anticipated quantities of adaptive stock-keeping units for the given time period.

The ingestion engine can transform the procedure data and the factor-based data into a canonical feature representation that can include a feature vector for the given time period. A forecasting engine can execute a trained machine learning model to generate an initial quantity estimate for the adaptive stock-keeping unit for the given time period using the feature vector. An integration manager can receive distributor data from a distributor system, where the distributor data can identify delivery dates for at least one underlying stock-keeping unit identifier of the membership field. The forecasting engine can refine the initial quantity estimate by applying a refinement operation that can update the initial quantity estimate based on the distributor data to generate a refined quantity for the given time period, and can store the refined quantity in association with the adaptive stock-keeping unit identifier.

The technical solutions described herein can address forecasting inaccuracies that arise when delivery timing data for underlying stock-keeping unit identifiers is not reflected in an initial quantity estimate. The technical solutions described herein can generate a refined quantity for an adaptive stock-keeping unit for a given time period by updating the initial quantity estimate based on distributor data identifying delivery dates for at least one underlying stock-keeping unit identifier of a membership field. The adaptive stock-keeping unit can be associated with a procedure identifier for a type of procedure and can include the membership field storing an ordered list of underlying stock-keeping unit identifiers for a combination stock-keeping unit associated with the type of procedure. The refined quantity can be generated using procedure data associated with the procedure identifier and factor-based data including operational parameter values that can cause changes in anticipated quantities of adaptive stock-keeping units, where the procedure data and the factor-based data can be received from heterogeneous data source systems. The procedure data and the factor-based data can be transformed into a canonical feature representation that can include a feature vector for the given time period. A trained machine learning model can be executed to generate the initial quantity estimate for the adaptive stock-keeping unit for the given time period using the feature vector. The refined quantity can be stored in association with the adaptive stock-keeping unit identifier for the given time period.

Furthermore, certain procedure-based inventory forecasting and ordering systems can be architecturally constrained by how they ingest and prepare data from heterogeneous source systems. In such deployments, procedure forecasts, supplier and distributor operational parameters, and inventory state signals can be received in different schemas, units, and timing conventions. As a result, forecast computation pipelines can repeatedly perform per-source parsing, per-source mapping, and per-source normalization steps each time a forecast is produced or refreshed. When the number of data sources grows, such repeated conversions can increase processor utilization, increase memory churn from transient conversion objects, and increase I/O overhead from repeated reads and writes of intermediate transformed datasets.

Such systems can also treat external operational parameters and downstream distributor timing information as late-stage inputs that require repeated re-forecasting. For example, changes to delivery timing can be handled by re-running an entire forecasting job or by iteratively recomputing forecasts across many SKUs to account for shipment updates. Such a workflow can create a computing-resource problem rather than a user-facing limitation, as frequent distributor updates and source-system changes can cause repeated full recomputation, repeated feature assembly, and repeated evaluation of forecasting logic, increasing CPU load, memory allocation pressure, and storage transactions.

In addition, heterogeneous inputs can be stored and processed in their native forms, which can prevent efficient caching and reuse of standardized features across forecast cycles. Without a canonical representation, the system can repeatedly reconstruct forecast-ready data structures from raw inputs for each time period, thereby increasing latency and reducing throughput when forecasts are to be generated for many procedures, sites, or adaptive SKUs.

The technical solutions described herein provide a system that can improve the operation of inventory forecasting computing systems by configuring one or more processors to implement an ingestion-and-forecasting pipeline that standardizes heterogeneous inputs into a canonical feature representation before executing a trained machine learning model. The system receives, via an ingestion engine and interfaces to heterogeneous data source systems, procedure data including projected procedure volumes for a given time period and factor-based data including operational parameter values that can cause changes in anticipated quantities of adaptive SKUs for that time period.

Rather than repeatedly performing ad hoc transformations for each forecast computation, the ingestion engine within the disclosed system can transform the procedure data and the factor-based data into a canonical feature representation that can include a feature vector for the given time period. Such transformations can include normalizing at least one operational parameter value across source systems such that disparate schemas and units can be converted into a standardized, model-consumable form. Such canonicalization can allow downstream forecasting operations to execute against a stable feature schema instead of repeatedly rebuilding per-source mappings.

A forecasting engine of the system 300 can execute a trained machine learning model to generate an initial quantity estimate for an adaptive SKU using the feature vector. The system can further integrate distributor system timing data through an integration manager that receives distributor data identifying delivery dates for underlying SKU identifiers, and the system can refine the initial quantity estimate by applying a refinement operation that updates the estimate based on the distributor data to generate a refined quantity for the given time period. By structuring the pipeline as canonical feature generation followed by targeted refinement using distributor timing signals, the system can avoid repeated end-to-end recomputation when incremental distributor updates arrive.

In implementations that include dependency parameters stored in a dependency field, the system can evaluate such dependency parameters to determine dependency-driven quantity adjustments among underlying SKUs. Combination rules can add, remove, or substitute underlying SKU identifiers, and quantity relationship entries can specify proportional or conditional changes among related underlying SKUs when a modification occurs. The refined quantity can be generated using such dependency-driven adjustments to support controlled quantity propagation among related SKUs rather than broad recalculation across unrelated inventory records.

Such architecture can generate concrete technical effects in the operation of inventory forecasting computing systems by reducing processor usage, memory consumption, and I/O overhead associated with multi-source forecasting and repeated forecast refresh cycles. By transforming heterogeneous procedures and factor-based inputs into a canonical feature representation, the system can reduce repeated parsing, mapping, and normalization work that would otherwise be performed each time forecasts are generated. Forecast computation can become a consistent execution of a trained model over standardized feature vectors, thereby reducing redundant CPU cycles across forecast runs and improving throughput under high forecast volume.

Additionally, memory efficiency can be improved by reducing allocation and churn associated with transient reconciliation structures. Certain pipelines allocate temporary objects to reconcile schema mismatches, perform unit conversions, and assemble per-source features for each forecast run. By canonicalizing inputs into standardized feature vectors and reusing that representation across forecasting operations, the system can reduce the creation of temporary conversion structures and lower memory reclamation overhead during repeated forecasting cycles.

Storage and I/O efficiency can also be improved. Heterogeneous ingestion approaches can persist multiple intermediate datasets that are repeatedly read from and written to storage. Consolidating forecast inputs into a canonical feature representation can reduce the number of read/write operations and reduce redundant storage of duplicative mappings across data sources. In addition, applying a refinement operation using distributor delivery-date data can facilitate targeted updates to quantity estimates without re-running full ingestion and transformation workflows, further reducing I/O and compute required for forecast refreshes triggered by delivery updates.

The refinement and dependency-driven adjustment mechanisms can further reduce recomputation during incremental updates. Distributor delivery dates can be incorporated as an update to an existing estimate rather than requiring a full re-forecast of some or all features and some or all SKUs. Where dependency-driven quantity adjustments are used, quantity updates can be propagated among affected underlying SKUs according to stored dependency parameters, limiting the scope of recalculation and avoiding iterative correction loops that can arise when related SKU quantities are recomputed independently. The overall effect can be a forecasting and inventory computing system that can generate and refresh procedure-based quantity outputs more efficiently, with lower CPU utilization, reduced memory churn, and reduced I/O overhead than certain heterogeneous, per-run transformation architectures.

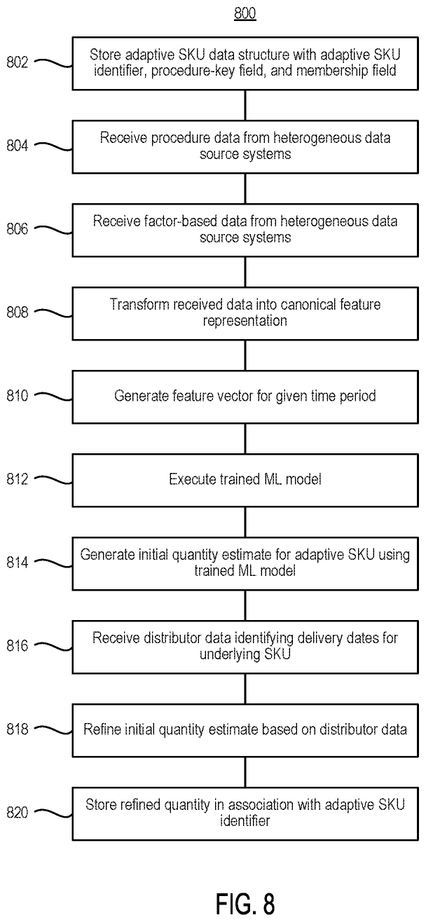

Referring now to FIG. 8, illustrated is a method 800 for forecasting adaptive stock-keeping units using procedure projections and distributor data. The method 800 can be executed, performed, or otherwise carried out by any of the computing systems or devices described herein, and any of the components thereon, such as depicted in FIG. 3. In brief overview of the method 800, the method 800 can include storing adaptive SKU data structure with adaptive SKU identifier, procedure-key field, and membership field (ACT 802), receiving procedure data from heterogeneous data source systems (ACT 804), receiving factor-based data from heterogeneous data source systems (ACT 806), transforming received data into canonical feature representation (ACT 808), generating feature vector for given time period (ACT 810), executing trained machine learning model (ACT 812), generating initial quantity estimate for adaptive SKU using trained machine learning model (ACT 814), receiving distributor data identifying delivery dates for underlying SKU (ACT 816), refining initial quantity estimate based on distributor data (ACT 818), and storing refined quantity in association with adaptive SKU identifier (ACT 820).

The method 800 can include storing adaptive SKU data structure with adaptive SKU identifier, procedure-key field, and membership field (ACT 802). The system 300 can store an adaptive SKU data structure with an adaptive SKU identifier, procedure-key field, and membership field via one or more processing components, as depicted in FIG. 3. For example, the adaptive SKU manager 302 of the system 300 can store, in a data store, the adaptive SKU data structure having a schema that can include an adaptive SKU identifier, a procedure-key field storing a procedure identifier for a type of procedure, and a membership field storing an ordered list of underlying SKU identifiers for a combination SKU associated with the type of procedure. For example, the adaptive SKU manager 302 can store an adaptive SKU data structure for a cardiac catheterization procedure, where the schema includes an adaptive SKU identifier of ASKU-001, a procedure-key field storing a procedure identifier of PROC-CARDIAC-CATH, and a membership field storing an ordered list of underlying SKU identifiers including a guidewire SKU identifier having a value of SKU-GW-2345, a catheter SKU identifier having a value of SKU-CAT-5678, and a contrast agent SKU identifier having a value of SKU-CA-9012.

The adaptive SKU manager 302 can store the adaptive SKU data structure in response to receiving a configuration request from a distributor entity or a customer entity via the customer system integration manager 306 or the distributor system integration manager 308. For example, upon receiving a configuration request from a distributor enterprise resource planning system specifying a new combination SKU for a surgical procedure, the adaptive SKU manager 302 can generate and store a corresponding adaptive SKU data structure in the data store by writing the schema to a relational database table, where the adaptive SKU identifier can serve or function as a primary key and the procedure-key field and membership field can be stored as indexed columns. In some embodiments, the adaptive SKU manager 302 can maintain the adaptive SKU data structure in volatile or non-volatile memory as a retrievable procedure-level execution unit to reduce repeated database reads of individual SKU records during subsequent inventory transactions. The adaptive SKU data structure can further include a dependency field storing dependency parameters that can include combination rules or quantity relationship entries for the underlying SKU identifiers, and the system can store the dependency field in association with the adaptive SKU identifier to facilitate subsequent dependency-driven quantity adjustments during inventory allocation operations.

In some embodiments, the system 300 via one or more processing components, as depicted in FIG. 3, can evaluate the dependency parameters stored in the dependency field of the adaptive SKU data structure to determine, for the given time period, one or more dependency-driven quantity adjustments among the underlying SKU identifiers of the membership field of the adaptive SKU data structure. For example, the adaptive SKU manager 302 can apply a combination rule that can add an underlying SKU identifier to the membership field of the adaptive SKU data structure, remove an underlying SKU identifier from the membership field of the adaptive SKU data structure, or substitute a first underlying SKU identifier in the membership field of the adaptive SKU data structure with a second underlying SKU identifier. The system 300 can further apply a quantity relationship entry that can specify a proportional or conditional change in an anticipated quantity of at least one other underlying SKU identifier responsive to the add, remove, or substitute operation. In some embodiments, the quantity relationship entry can specify that adding, removing, or substituting one underlying SKU identifier can cause an increase, decrease, or conditional update in an anticipated quantity of another underlying SKU identifier associated with the adaptive SKU for the given time period by executing quantity propagation logic of the adaptive SKU data structure.

The method 800 can include receiving procedure data from heterogeneous data source systems (ACT 804). The system 300 can receive procedure data from heterogeneous data source systems via one or more processing components, as depicted in FIG. 3. For example, the ingestion engine of the system 300 can receive, via one or more interfaces from heterogeneous data source systems, procedure data associated with the procedure identifier. The procedure data can include a projection of volumes of the procedure for a given time period. For example, the ingestion engine can receive procedure data from a hospital enterprise resource planning system indicating that a projected volume of cardiac catheterization procedures for a given time period of thirty days is fifty procedures, where the procedure data can be encoded as a JavaScript Object Notation payload transmitted via a representational state transfer application programming interface endpoint and includes a procedure identifier field storing a value of PROC-CARDIAC-CATH and a projected volume field storing a numerical value of fifty. The ingestion engine can be or include any one or more components of the system 300 that can receive, aggregate, normalize, store, or transform data from heterogeneous source systems. For example, the ingestion engine can include, but is not limited to, the adaptive SKU manager 302, the forecasting engine 304, the customer system integration manager 306, the distributor system integration manager 308, the proactive monitoring engine 318, and the orchestration engine 322, among others.

The ingestion engine can receive the procedure data in response to establishing an authenticated interface session with a customer system via the customer system integration manager 306. For example, upon establishing an authenticated connection to a hospital management system by transmitting an authentication request including a client identifier and a cryptographic signature to a customer authentication server and receiving an authorization token encoded as a JavaScript Object Notation web token that specifies granted permissions for accessing procedure forecast data endpoints, the ingestion engine can transmit a data retrieval request specifying a procedure identifier of PROC-CARDIAC-CATH and a time period of thirty days. The ingestion engine can receive the procedure data in response as a JavaScript Object Notation payload including the projected volume of fifty procedures via a network interface supporting bidirectional application-to-application or system-to-system communications using packets, payloads, configured adapters, or protocol formatted messages.

The ingestion engine can receive the procedure data by parsing incoming messages transmitted via application programming interface endpoints, electronic data interchange feeds, or flat file exchanges from the heterogeneous data source systems. For example, the ingestion engine can parse an incoming electronic data interchange message formatted according to an ANSI X12 standard by extracting a procedure identifier segment and a volume projection segment from the message, and can parse an incoming flat file exchange formatted as a comma-separated values file by reading a row that includes a procedure identifier column storing a value of PROC-CARDIAC-CATH and a projected volume column storing a numerical value of fifty.

In some embodiments, the ingestion engine can validate the received procedure data by verifying that the procedure identifier matches a procedure-key field stored in an existing adaptive SKU data structure and that the projection of volumes is a non-negative numerical value. For example, the ingestion engine can retrieve an adaptive SKU data structure from the data store by querying for a record having a procedure-key field that matches the procedure identifier of PROC-CARDIAC-CATH received in the procedure data. The ingestion engine can verify that the retrieved adaptive SKU data structure exists by confirming that a non-null record was returned from the query, and can verify that the projection of volumes is a non-negative numerical value by applying a validation rule that checks whether the numerical value of fifty is greater than or equal to zero before using the procedure data in a feature generation operation associated with the adaptive SKU data structure.

The method 800 can include receiving factor-based data from heterogeneous data source systems (ACT 806). The system 300 can receive factor-based data from heterogeneous data source systems via one or more processing components, as depicted in FIG. 3. For example, the ingestion engine of the system 300 can receive, via the one or more interfaces from the heterogeneous data source systems, factor-based data including operational parameter values that can cause changes in anticipated quantities of adaptive SKUs for the given time period. For example, the ingestion engine can receive factor-based data from a distributor warehouse management system indicating that a catheter SKU has an expiration date threshold of ninety days from a current date and that a guidewire SKU has a backorder status with an expected restocking date of fifteen days from the current date. The factor-based data can further include one or more adaptive-SKU substitution rules associated with the adaptive SKU identifier or the procedure identifier. The system 300 can store the one or more adaptive-SKU substitution rules in the dependency field of the adaptive SKU data structure as combination rules that can replace a first underlying SKU identifier in the membership field of the adaptive SKU data structure with a second underlying SKU identifier.

In some embodiments, the factor-based data can further include operational parameter values for supplier details, origin attributes including tariff status, lot identifiers, lot ranges, expiration dates, expiration buffer thresholds, dynamic SKU quantity parameters, SKU priority levels, SKU criticality levels, or financial metrics including cost, price, margin, or freight terms. For example, the ingestion engine can receive factor-based data identifying a supplier associated with an underlying SKU identifier, a country of origin and corresponding tariff status for the underlying SKU identifier, a lot identifier or lot range associated with available inventory units, a priority or criticality level assigned to the underlying SKU identifier for the type of procedure, and financial metrics specifying a unit cost, unit price, projected margin, or freight term associated with procurement or delivery of the underlying SKU identifier.

In some embodiments, the ingestion engine can receive the factor-based data in response to a periodic synchronization operation that retrieves updated operational parameter values from the heterogeneous data source systems at predefined intervals. For example, the ingestion engine can execute a scheduled data retrieval operation every six hours, for instance, to obtain updated factor-based data from supplier electronic data interchange systems, warehouse management systems, or transportation management systems.

In some embodiments, the ingestion engine can receive the factor-based data by subscribing to event-driven notification streams from the heterogeneous data source systems, where each notification can include operational parameter values encoded in JavaScript Object Notation or Extensible Markup Language formats. For example, the ingestion engine can establish a persistent connection to a warehouse management system and register a callback function that can receive asynchronous event notifications encoded as JavaScript Object Notation payloads. Each payload can include an event type field specifying a parameter update event, an affected SKU identifier field storing an identifier of an underlying SKU for which an operational parameter value has changed, and a parameter value field storing the updated operational parameter value such as a revised expiration date threshold or a modified backorder status received over one or more network interfaces.

In some embodiments, the ingestion engine can aggregate factor-based data from multiple heterogeneous data source systems by merging operational parameter values associated with a common procedure identifier or adaptive SKU identifier into a unified data structure prior to transformation. For example, the ingestion engine can receive a first operational parameter value specifying an expiration date threshold of ninety days for a catheter SKU from a first warehouse management system, receive a second operational parameter value specifying a backorder status for the catheter SKU from a second supplier electronic data interchange system, and merge the first operational parameter value and the second operational parameter value into a unified data structure by creating a single data record that includes an adaptive SKU identifier field storing an identifier of the adaptive SKU, a first parameter field storing the expiration date threshold of ninety days, and a second parameter field storing the backorder status. The ingestion engine can consolidate multiple heterogeneous operational parameter values into a single data structure that can be transformed by the ingestion engine in a subsequent transformation operation for execution of the trained machine learning model and for updates to the adaptive SKU data structure.

The method 800 can include transforming received data into canonical feature representation (ACT 808). The system 300 can transform the procedure data and the factor-based data into canonical feature representation via one or more processing components, as depicted in FIG. 3. For example, the ingestion engine of the system 300 can transform the procedure data and the factor-based data in response to receiving the procedure data in ACT 804 and the factor-based data in ACT 806. For example, upon receiving the procedure data and the factor-based data, the ingestion engine can initiate a transformation operation to transform the procedure data and the factor-based data by applying normalization rules, including a unit conversion operation to convert heterogeneous units of measurement into standardized units across the heterogeneous data source systems, a categorical encoding operation to convert textual operational parameter values into numerical feature values, and a missing-value imputation operation to replace absent operational parameter values with default or interpolated values derived from historical data records associated with the procedure identifier. For instance, the ingestion engine can receive a first operational parameter value specifying a quantity in kilograms from a first heterogeneous data source system and a second operational parameter value specifying a quantity in pounds from a second heterogeneous data source system. The ingestion engine can normalize the first operational parameter value and the second operational parameter value by converting both quantities to a common unit of grams to generate a normalized operational parameter value that can be included in the canonical feature representation.

In some embodiments, the ingestion engine can apply a dimensionality reduction operation to reduce a number of feature dimensions prior to execution of the trained machine learning model. In some embodiments, the ingestion engine can normalize other operational parameter values across the heterogeneous data source systems by mapping heterogeneous supplier identifiers to a canonical supplier identifier format, or mapping heterogeneous origin codes to canonical origin attributes including tariff-status indicators. The ingestion engine can further standardize lot identifier formats or lot-range representations or normalize financial metric fields including cost, price, margin, or freight terms into corresponding canonical feature fields for inclusion in a feature representation executable by the trained machine learning model.

The method 800 can include generating feature vector for given time period (ACT 810). The system 300 can generate a feature vector for a given time period. For example, the ingestion engine of the system 300 can transform the procedure data and the factor-based data into a canonical feature representation that includes a feature vector for the given time period. For example, the ingestion engine can receive procedure data from a hospital enterprise resource planning system specifying fifty projected cardiac catheterization procedures for a thirty-day time period and can receive factor-based data from a distributor warehouse management system specifying an expiration date threshold of ninety days for a catheter SKU. The ingestion engine can transform the procedure data and the factor-based data into a canonical feature representation by generating a feature vector that includes a procedural volume feature field storing a numerical value of fifty and an expiry proximity feature field storing a numerical value of ninety.

In some embodiments, the ingestion engine can generate the feature vector using a fixed, source-agnostic feature schema that can map a plurality of heterogeneous field names and units from the heterogeneous data source systems into corresponding canonical feature fields to reduce repeated per-source parsing operations for subsequent forecasting for the given time period. For example, the ingestion engine can maintain a schema mapping table that can associate a first field name of “procedureCount” from a hospital management system with a canonical feature field name of “procedural_volume”, associate a second field name of “expiryDays” from a warehouse management system with a canonical feature field name of “expiry proximity”, and associate a third field name of “backorderStatus” from a supplier electronic data interchange system with a canonical feature field name of “availability_constraint”. The ingestion engine can use the schema mapping table to transform the procedure data and the factor-based data into the canonical feature representation without re-parsing heterogeneous field names each time the transformation operation is executed for the given time period.

In some embodiments, the canonical feature representation for the given time period can be stored in a cache in association with at least one of the procedure identifier or the adaptive SKU identifier and reused to execute the trained machine learning model for at least one subsequent forecasting operation for the given time period to reduce processor utilization and memory allocation associated with repeated feature construction. For example, the ingestion engine can store the canonical feature representation in a cache memory by writing a cache entry that includes a cache key field storing a concatenation of the procedure identifier and the adaptive SKU identifier, a feature vector field storing the canonical feature representation, and a timestamp field storing a creation time of the cache entry. The ingestion engine can retrieve the canonical feature representation from the cache memory when a subsequent forecasting operation for the given time period is initiated by querying the cache memory using the concatenated procedure identifier and adaptive SKU identifier as a lookup key to avoid repeated execution of the transformation operation for the same time period and to support repeated execution of the trained machine learning model using the cached representation.

The method 800 can include executing a trained machine learning model (ACT 812). The system 300 can execute a trained machine learning model via one or more processing components, as depicted in FIG. 3. For example, the forecasting engine 304 of the system 300 can execute a trained machine learning model 324 in response to the ingestion engine completing the transformation operation in ACT 808 and generating the feature vector in ACT 810. In some embodiments, the forecasting engine 304 can execute the trained machine learning model 324 by loading model parameters from a storage location, feeding the feature vector into an input layer of the trained machine learning model 324, propagating activations through one or more hidden layers, and extracting the initial quantity estimate from an output layer of the trained machine learning model 324. For example, the forecasting engine 304 can retrieve a set of weight matrices and bias vectors from a model parameter storage location, apply a first weight matrix to the feature vector to generate a first hidden layer activation vector, apply a non-linear activation function to the first hidden layer activation vector to generate a transformed first hidden layer activation vector, apply a second weight matrix to the transformed first hidden layer activation vector to generate a second hidden layer activation vector, apply a second non-linear activation function to the second hidden layer activation vector to generate a transformed second hidden layer activation vector, apply an output weight matrix to the transformed second hidden layer activation vector to generate an output vector, and extract the initial quantity estimate from the output vector as a scalar value representing a projected quantity for the adaptive SKU for the given time period.

In some embodiments, the forecasting engine 304 can execute the trained machine learning model 324 using the canonical feature representation without re-transforming raw inputs received from the heterogeneous data source systems to reduce computational overhead associated with repeated data transformation operations. The resulting quantity estimate can be stored for use in updates to the adaptive SKU data structure.

The method 800 can include generating initial quantity estimate for adaptive SKU using trained machine learning model (ACT 814). The system 300 can generate an initial quantity estimate for the adaptive SKU using the trained machine learning model via one or more processing components, as depicted in FIG. 3. For example, the forecasting engine 304 of the system 300 can execute the trained machine learning model 324 to generate an initial quantity estimate for the adaptive SKU for the given time period using the feature vector. For example, the forecasting engine 304 can execute a trained neural network model 324 that receives the feature vector as input, processes the feature vector through a plurality of hidden layers using stored weight parameters and activation functions, and generates an initial quantity estimate of seventy-five units for an adaptive SKU associated with a cardiac catheterization procedure for a given time period of thirty days by extracting an output value from an output layer of the trained neural network model 324.

The method 800 can include receiving distributor data identifying delivery dates for underlying SKU (ACT 816). The system 300 can receive distributor data identifying delivery dates for the underlying SKU via one or more processing components, as depicted in FIG. 3. For example, the distributor system integration manager 308 of the system 300 can receive, via one or more interfaces to a distributor system, distributor data that can identify delivery dates for at least one underlying SKU identifier of the membership field of the adaptive SKU data structure. For example, the distributor system integration manager 308 can receive distributor data from a distributor enterprise resource planning system indicating that an expected delivery date for a catheter SKU having an underlying SKU identifier of CAT-5678 is seven days from a current date, for instance.

The distributor system integration manager 308 can receive the distributor data in response to transmitting a data retrieval request to the distributor system specifying one or more underlying SKU identifiers from the membership field of the adaptive SKU data structure. For example, upon generating the initial quantity estimate in ACT 814, the forecasting engine 304 can trigger the distributor system integration manager 308 to transmit a data retrieval request to the distributor system to obtain updated delivery dates for underlying SKU identifiers associated with the adaptive SKU.

The distributor system integration manager 308 can receive the distributor data by parsing incoming messages transmitted via application programming interface endpoints established with the distributor system, where the messages can include delivery date attributes encoded as timestamp values or date strings. In some embodiments, the distributor system integration manager 308 can receive distributor data that includes at least one of an expected delivery date or an actual delivery date for one or more underlying SKU identifiers of the membership field of the adaptive SKU data structure.

The method 800 can include refining initial quantity estimate based on distributor data (ACT 818). The system 300 can refine the initial quantity estimate based on the distributor data via one or more processing components, as depicted in FIG. 3. For example, the forecasting engine 304 of the system 300 can refine the initial quantity estimate in response to the distributor system integration manager 308 receiving the distributor data in ACT 816. For example, upon receiving the distributor data from the distributor system integration manager 308, the forecasting engine 304 can initiate the refinement operation to update the initial quantity estimate based on the delivery date attributes included in the distributor data by extracting a delivery date field from the distributor data, comparing the extracted delivery date field to a baseline expected delivery date stored in association with the underlying SKU identifier, and computing a time delta representing a difference in days between the extracted delivery date field and the baseline expected delivery date.

The forecasting engine 304 can refine the initial quantity estimate by applying a refinement operation that updates the initial quantity estimate based on the distributor data to generate a refined quantity for the given time period. For example, the forecasting engine 304 can receive distributor data from the distributor system integration manager 308 indicating that an expected delivery date for a catheter SKU has shifted from a first date to a second date that is seven days later than the first date, and can refine the initial quantity estimate for the adaptive SKU by reducing a quantity allocation for the catheter SKU during a time interval between the first date and the second date and increasing a quantity allocation for the catheter SKU after the second date to generate the refined quantity that accounts for the delivery date shift.

In some embodiments, the forecasting engine 304 can refine the initial quantity estimate by updating the initial quantity estimate using a subset of the feature vector corresponding to delivery-date features derived from the distributor data while maintaining the remaining features of the canonical feature representation unchanged to reduce recomputation relative to re-executing the trained machine learning model 324 over an entire reconstructed feature vector. For example, the forecasting engine 304 can identify a delivery-date feature field in the feature vector that can store a numerical representation of an expected delivery timeline for the catheter SKU, and can update the delivery-date feature field by replacing a first numerical value representing the first date with a second numerical value representing the second date that is seven days later than the first date. The forecasting engine 304 can recompute the refined quantity by applying a lightweight adjustment operation that multiplies the initial quantity estimate by a scaling factor derived from the time delta between the first date and the second date, without reconstructing or re-transforming any other feature fields in the feature vector such as procedural volume features or expiry proximity features. The system 300 can execute the lightweight adjustment operation over the stored feature representation.

In some embodiments, the forecasting engine 304 or another system component can evaluate the dependency parameters by executing a localized quantity-propagation operation that updates anticipated quantities for fewer than some or all of the underlying SKU identifiers in the membership field of the adaptive SKU data structure based on at least one quantity relationship entry. The refined quantity can be generated using the localized quantity-propagation operation to reduce processor cycles and memory churn relative to full recomputation across the ordered list of underlying SKU identifiers.

In some embodiments, the forecasting engine 304 or the adaptive SKU manager 302 can apply a quantity relationship entry stored in the dependency field of the adaptive SKU data structure to update a dynamic quantity for a second underlying SKU identifier responsive to replacement of a first underlying SKU identifier in the membership field of the adaptive SKU data structure. The dynamic quantity can be constrained by a usage factor range determined for the type of procedure based at least on a quantity of units purchased over a period of time, a number of procedures performed over the period of time, or a quantity of units utilized over the period of time.

In some embodiments, the forecasting engine 304 can further generate or refine quantity estimates using forward-looking commercial and financial planning data, including projected price changes, rebate effects, contract terms, or other deal-economics attributes associated with one or more underlying SKU identifiers. In some embodiments, the forecasting engine 304 can apply such data when selecting among candidate substitutions, transition schedules, or procurement quantities for the given time period. In some embodiments, where forecast data is incomplete, sparse, or unreliable for a particular market, customer, or site, the forecasting engine 304 can generate the initial quantity estimate or the refined quantity using partial forecast inputs in combination with historical usage factors, distributor constraints, or procedure-linked dependency parameters stored in the adaptive SKU data structure.

In some embodiments, the ingestion engine, the forecasting engine 304, or both can further normalize warehouse-specific unit-of-measure data and consumption-factor data for use in generating the initial quantity estimate or the refined quantity. Such normalization can include applying conversion factors between non-equivalent packaging or ordering units, applying rounding rules associated with a warehouse or supplier, and mapping consumption values across transition states such that quantity outputs remain aligned with warehouse-specific fulfillment constraints and procedure-level usage expectations.

The method 800 can include storing refined quantity in association with adaptive SKU identifier (ACT 820). The system 300 can store the refined quantity in association with an adaptive SKU identifier via one or more processing components, as depicted in FIG. 3. For example, in response to the forecasting engine 304 refining the initial quantity estimate by applying a refinement operation that updates the initial quantity estimate based on the distributor data to generate a refined quantity for the given time period in ACT 818, the adaptive SKU manager 302 of the system 300 can store the refined quantity in association with the adaptive SKU identifier. In some embodiments, the adaptive SKU manager 302 can store the refined quantity in a database table that can associate the refined quantity with the adaptive SKU identifier via a foreign key relationship to facilitate subsequent retrieval of the refined quantity for inventory allocation operations performed by the orchestration engine 322 or for execution of subsequent quantity adjustment operations using the adaptive SKU data structure.

### H. Systems and Methods for Orchestration Using Adaptive Stock-Keeping Units

The present description relates to techniques for orchestration using adaptive stock-keeping units. Distribution systems can manage inventories of stock-keeping units associated with procedure types and can receive data from a plurality of heterogeneous source systems to track inventory availability and projected demand. Certain distribution systems can encounter challenges when managing stock-keeping unit allocations for procedure-based workflows, particularly when heterogeneous source systems use different identifier schemes or reporting formats for procedures and stock-keeping units. In such cases, mismatches between identifier schemes can result in repeated reconciliation operations that can consume processor resources and introduce latency. Certain systems can also recalculate inventory allocations for some or all stock-keeping units associated with a procedure when inventory availability changes, even when a subset of stock-keeping units is affected, thereby consuming processor cycles and memory resources unnecessarily. Certain systems can further lack a unified data structure that can acquire membership relationships, quantity ranges, executable combination rules, and dependency relationships governing how a change to one stock-keeping unit can affect quantities for related stock-keeping units.

The technical solutions described herein provide an orchestration system that can address identifier reconciliation, selective quantity recomputation, and multi-parameter orchestration of procedure-based distribution workflows. The technical solutions can maintain a mapping data structure that can address or resolve procedure identifiers and stock-keeping unit identifiers received from a plurality of heterogeneous source systems to canonical identifiers. The technical solutions can store combination stock-keeping unit records that define membership fields, quantity-range fields, rule fields, and dependency fields for constituent stock-keeping units, such that the orchestration system can perform incremental recomputation operations that update quantities for an affected subset of constituent stock-keeping units responsive to a change event, rather than recalculating quantities for some or all constituent stock-keeping units.

To implement the technical solutions described herein, the orchestration system can receive procedure data from a plurality of heterogeneous source systems and can transform the procedure data into a procedure record associated with a canonical procedure identifier using the mapping data structure. The orchestration system can receive factor-based data including operational parameter values and can receive preference data associated with at least one site identifier. The orchestration system can generate, by executing one or more trained machine learning models, a plurality of candidate combination stock-keeping unit record identifiers and corresponding score values based on the canonical procedure record, the factor-based data, inventory data, or preference profile records. The orchestration system can select a target combination stock-keeping unit record identifier based on the score values and at least one rule-based selection criterion. The orchestration system can compute quantities for constituent stock-keeping units by applying dynamic quantity ranges stored in a quantity-range field and by applying propagation rules stored in a dependency field. When a change event occurs, the orchestration system can perform an incremental recomputation operation that identifies an affected subset of constituent stock-keeping units and updates quantities for the affected subset without recomputing quantities for unaffected constituent stock-keeping units.

The technical solutions described herein can reduce processor utilization and memory usage associated with identifier reconciliation by storing and reusing the mapping data structure for orchestration operations across heterogeneous source systems. The technical solutions can reduce processor utilization associated with quantity recomputation by updating quantities for an affected subset of constituent stock-keeping units in response to a change event. The technical solutions can also reduce compute consumption associated with infeasible candidate configurations by enforcing constraints that prevent selection of candidate combination stock-keeping unit records that include constituent stock-keeping units indicated by inventory data as unavailable for a given time period. The technical solutions can improve stock-keeping unit allocation processing by incorporating factor-based data, preference data, inventory data, or canonical procedure data into the machine learning models and by applying rule-based selection criteria or constraints and dependency-based quantity propagation.

Furthermore, certain procedure-based inventory selection and configuration systems can be constrained by how they reconcile heterogeneous identifiers and repeatedly recompute SKU sets and quantities when inputs change. In multi-system environments, procedure identifiers and SKU identifiers can differ across source systems, which can force the execution layer to repeatedly translate identifiers and rebuild intermediate representations each time procedure data, factor-based operational inputs, inventory data, or site preferences are processed. Such repeated reconciliation can increase CPU usage and memory churn and can introduce I/O overhead from repeatedly constructing and persisting intermediate, non-canonical records for each decision cycle.

Such systems further waste compute when they recompute quantities across some or all constituent SKUs whenever any localized input changes. A change in inventory, a preference update, or a configuration rule execution can trigger broad recalculation of dependent quantities, even when a subset of SKUs is affected. Such configurations can create a technical bottleneck, as repeated full recomputation can increase processor cycles and transient memory allocation. Such an approach can further degrade throughput for time-sensitive configuration and replenishment decisions.

The technical solutions described herein provide a system that can improve the operation of the computing system by configuring an orchestration engine to canonicalize heterogeneous identifiers and execute procedure-level configuration and quantity computation using stored, structured records. The system can store a mapping data structure that can map source-system procedure identifiers and SKU identifiers to canonical identifiers, and can transform incoming procedure data into a canonical procedure record using that mapping.

For each adaptive SKU identifier, the system can store a combination SKU record that can encode an ordered membership field of canonical constituent SKUs, dynamic quantity ranges, executable combination rules defining permitted membership modifications, or a dependency field storing propagation rules that can map quantity changes between constituent SKUs. Using such records, the system via the orchestration engine can execute one or more trained machine learning models to generate candidate combination SKU record identifiers and score values based on canonical procedure data, factor-based operational parameters, inventory data, or site preference profiles. The system can then select a target combination SKU record identifier subject to rule-based selection criteria.

In response to selecting the target combination SKU record identifier, the system via the orchestration engine can compute quantities by applying dynamic quantity ranges or dependency propagation rules. When changes occur (e.g., inventory or preference updates or rule execution), the system via the orchestration engine can perform an incremental recomputation operation that can update quantities for an affected subset of constituent SKUs and commit an updated quantity state to memory in association with the selected combination SKU record identifier. Such a configuration can avoid a full recomputation across the entire membership list.

Such architecture can generate concrete technical effects by reducing CPU, memory, or I/O consumption associated with identifier reconciliation and repeated recomputation. The canonical mappings can reduce repeated parsing and translation overhead by allowing downstream operations to run on standardized identifiers and stable record schemas rather than repeatedly reconstructing source-specific representations. The stored combination SKU records can reduce repeated assembly of SKU sets and rule logic by providing an executable, procedure-linked record that can be accessed and updated as a unit.

Furthermore, the incremental recomputation of constituent SKU quantities can reduce processor utilization and memory churn by limiting quantity updates to an affected subset of constituent SKUs rather than recalculating quantities for some or all SKUs in the combination. Committing an updated quantity state tied to the selected target record can further reduce I/O by avoiding broad rewrites of unrelated records and facilitating localized updates keyed to the canonical procedure and selected combination SKU records. Such an approach can result in a procedure-level orchestration system that can scale to heterogeneous inputs while consuming fewer computing resources than certain systems that repeatedly rebuild mappings and recompute full SKU sets on each update.

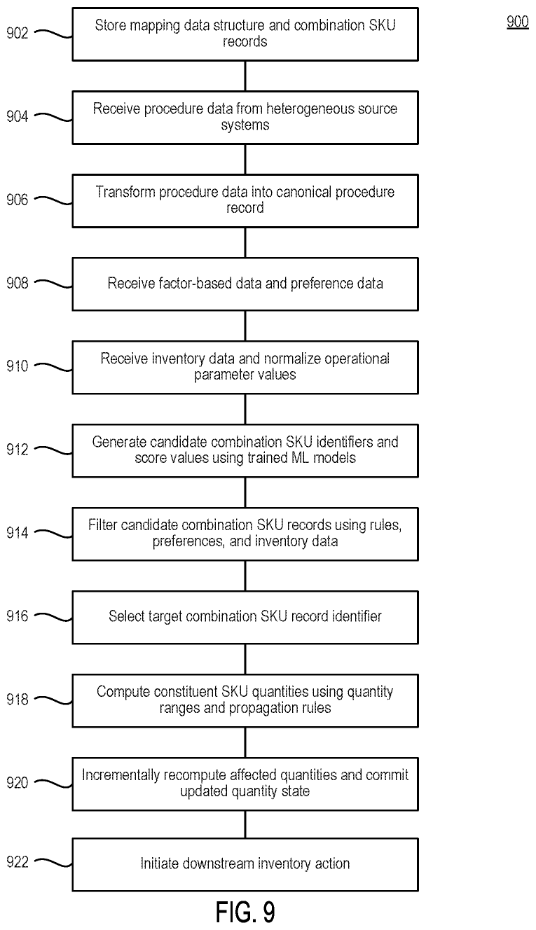

Referring now to FIG. 9, illustrated is a flow diagram of a method 900 for orchestration using adaptive stock-keeping units. The method 900 can be executed, performed, or otherwise carried out by any of the computing systems or devices described herein, and any of the components thereon, such as depicted in FIG. 3. In brief overview of the method 900, the method 900 can include storing mapping data structure and combination SKU records (ACT 902), receiving procedure data from heterogeneous source systems (ACT 904), transforming procedure data into canonical procedure record (ACT 906), receiving factor-based data and preference data (ACT 908), receiving inventory data and normalizing operational parameter values (ACT 910), generating candidate combination SKU identifiers and score values using trained machine learning models (ACT 912), filtering candidate combination SKU records using rules, preferences, and inventory data (ACT 914), selecting target combination SKU record identifier (ACT 916), computing constituent SKU quantities using quantity ranges and propagation rules (ACT 918), incrementally recomputing affected quantities and committing updated quantity state (ACT 920), and initiating downstream inventory action (ACT 922).

The method can include storing mapping data structure and combination SKU records (ACT 902). The system 300 can store the mapping data structure and the combination SKU records via one or more processing components, as depicted in FIG. 3. The adaptive SKU manager 302 of the system 300 can store the mapping data structure having a schema that can include a procedure-identifier mapping that can map procedure identifiers received from the plurality of heterogeneous source systems to a canonical procedure identifier, and a SKU-identifier mapping that can map SKU identifiers received from the plurality of heterogeneous source systems to canonical SKU identifiers. For example, the adaptive SKU manager 302 of the system 300 can store a mapping data structure that can map a procedure identifier of “CATH-001” received from a first hospital enterprise resource planning system and a procedure identifier of “CP-123” received from a second hospital enterprise resource planning system to a canonical procedure identifier of “CARDIAC-CATH,” such that subsequent transformation operations can resolve or address source-system identifier to the same canonical procedure identifier without repeated identifier reconciliation logic. The plurality of heterogeneous source systems can include different source systems that use different data formats, identifier schemes, interfaces, protocols, or system configurations. In some embodiments, the adaptive SKU manager 302 can store the mapping data structure in response to receiving the procedure data from the plurality of heterogeneous source systems in ACT 904.

In some embodiments, the adaptive SKU manager 302 can store the mapping data structure prior to receiving the procedure data, such that the mapping data structure is available for transformation operations when the procedure data arrives. For example, the adaptive SKU manager 302 can store the mapping data structure during an initialization operation that occurs before any procedure data can be received from the plurality of heterogeneous source systems. The adaptive SKU manager 302 or the orchestration engine 322, depending on the implementation, can retrieve the mapping data structure from memory when the orchestration engine 322 receives the procedure data in ACT 904 and can execute transformation operations using the retrieved mapping data structure.

The adaptive SKU manager 302 of the system 300 can store the mapping data structure by creating relational database tables that can associate source-system identifiers with canonical identifiers, or by storing the mapping data structure as a configuration file in volatile or non-volatile memory. For example, the adaptive SKU manager 302 can create a first relational database table that can store rows each having a source-system procedure identifier field, a source-system identifier field that can identify the heterogeneous source system from which the procedure identifier originates, or a canonical procedure identifier field. The adaptive SKU manager 302 can create a second relational database table that can store rows each having a source-system SKU identifier field, a source-system identifier field, or a canonical SKU identifier field.

The system 300, via one or more processing components, as depicted in FIG. 3, such as the orchestration engine 322, can cache the mapping data structure in memory to facilitate rapid retrieval during transformation operations to reduce processor utilization associated with repeated database queries for identifier mappings. For example, the system 300 can load the mapping data structure into a cache memory structure upon initialization of the orchestration engine 322, and can retrieve the mapping data structure from the cache memory structure when transforming the procedure data in ACT 906 without executing a database query operation for each identifier mapping. In some embodiments, the orchestration engine 322 can additionally cache at least one of the procedure-identifier mapping, the SKU-identifier mapping, a canonical procedure record, or a preference profile record for reuse during a subsequent orchestration cycle for a given time period without re-transforming source-system identifiers. The system 300 can retrieve the cached data as an execution unit for subsequent orchestration operations.

The system 300 can store the combination SKU record having a schema. The adaptive SKU manager 302 of the system 300 can store the combination SKU record in memory. The adaptive SKU manager 302 can store, in memory, for at least one adaptive SKU identifier, a combination SKU record having a schema that can include a membership field of an adaptive SKU data structure storing an ordered list of canonical SKU identifiers for a plurality of constituent SKUs for the type of procedure, a quantity-range field storing dynamic quantity ranges for at least a subset of the plurality of constituent SKUs, a rule field storing executable combination rules that define permitted membership modifications to the membership field, or a dependency field storing quantity relationship entries.

Each executable combination rule can specify at least one of combining, adding, removing, or substituting one constituent SKU with another constituent SKU. Each quantity relationship entry can define a propagation rule mapping a quantity change of a first constituent SKU to a quantity change of a second constituent SKU. For example, the adaptive SKU manager 302 of the system 300 can store a combination SKU record for a cardiac catheterization procedure. The combination SKU record can include a membership field of the adaptive SKU data structure storing canonical SKU identifiers for a guidewire, a catheter, a contrast agent, and a quantity-range field storing dynamic quantity ranges of ten to twelve units for the guidewire. The combination SKU record can further include a rule field storing an executable combination rule that can permit substitution of the catheter with an alternative catheter provided that procedural compatibility constraints are satisfied, and a dependency field of the adaptive SKU data structure storing a quantity relationship entry that maps a quantity change of the catheter to a proportional quantity change of the guidewire.

The adaptive SKU manager 302 of the system 300 can store the combination SKU record in response to transforming the procedure data into the procedure record in ACT 906. In some embodiments, the system 300 can store the combination SKU record prior to transforming the procedure data, such that the combination SKU record is available for retrieval when the orchestration engine 322 generates candidate combination SKU record identifiers.

The adaptive SKU manager 302 of the system 300 can store the combination SKU record by creating a data structure in memory with the specified schema fields, populating the membership field with canonical SKU identifiers, populating the quantity-range field with dynamic quantity ranges, populating the rule field with executable combination rules, and populating the dependency field with quantity relationship entries. The adaptive SKU manager 302 can store the combination SKU record as a procedure-linked execution object retrievable as a single unit to avoid repeated reconstruction of procedure-level inventory state from individual SKU records.

The method 900 can include receiving procedure data from heterogeneous source systems (ACT 904). The system 300 can receive the procedure data from heterogeneous source systems via one or more processing components, as depicted in FIG. 3. For example, the orchestration engine 322 of the system 300 can receive the procedure data from the plurality of heterogeneous source systems. The procedure data can include a procedure identifier and a projected volume for a type of procedure. For example, the orchestration engine 322 can receive procedure data from a hospital enterprise resource planning system indicating that a cardiac catheterization procedure identifier “CATH-001” has a projected volume of fifty procedures for a monthly time period, and can also receive procedure data from a second hospital system indicating that a procedure identifier “CP-123” has a projected volume of thirty procedures for the same time period.

In some embodiments, the orchestration engine 322 can receive the procedure data in response to establishing one or more connections via one or more interfaces to the plurality of heterogeneous source systems. The customer system integration manager 306 can establish the one or more connections by transmitting an authentication request to a customer authentication server and receiving an authorization token that specifies granted permissions for accessing procedure forecast endpoints via a network interface supporting APIs, packets, payloads, configured adapters, or protocol formatted communications.

In some embodiments, the orchestration engine 322 can receive the procedure data at scheduled intervals, such as daily batch uploads. For example, the orchestration engine 322 can receive procedure data files transmitted at midnight each day from customer enterprise resource planning systems in comma-separated value format.

In some embodiments, the orchestration engine 322 can receive the procedure data in response to event-driven triggers. For example, the orchestration engine 322 can receive procedure data when a customer system detects a change in a procedure forecast value that exceeds a defined threshold percentage relative to a prior forecast value for the same time period.

The orchestration engine 322 can parse incoming messages from the plurality of heterogeneous source systems to extract the procedure identifier and the projected volume. The orchestration engine 322 can receive the procedure data encoded in various formats such as JavaScript Object Notation, extensible markup language, or comma-separated values.

The method 900 can include transforming procedure data into canonical procedure record (ACT 906). The system 300 can transform the procedure data into the canonical procedure record via one or more processing components, as depicted in FIG. 3. For example, the orchestration engine 322 of the system 300 can transform, using the mapping data structure, the procedure data into a procedure record associated with the canonical procedure identifier. In some embodiments, the orchestration engine 322 can transform the procedure data by retrieving the mapping data structure from memory, extracting the procedure identifier from the procedure data, and applying the procedure-identifier mapping to resolve the procedure identifier to the canonical procedure identifier. The orchestration engine 322 can normalize the procedure data into a canonical representation for subsequent processing by applying the mapping data structure to resolve source-system procedure identifiers to canonical procedure identifiers and by storing or associating the canonical procedure record for execution in candidate generation operations.

For example, the orchestration engine 322 can transform procedure data received from a hospital enterprise resource planning system with a procedure identifier of “CATH-001” into a procedure record associated with a canonical procedure identifier of “CARDIAC-CATH” by retrieving the mapping data structure from a cache memory structure, extracting the procedure identifier “CATH-001” from a procedure data message encoded in JavaScript Object Notation format, querying the procedure-identifier mapping to identify a mapping entry that can associate the source-system identifier “CATH-001” with the canonical procedure identifier “CARDIAC-CATH.” The orchestration engine 322 can generate a procedure record data structure that can store the canonical procedure identifier “CARDIAC-CATH” in a procedure identifier field and store the projected volume extracted from the procedure data in a volume field.

The orchestration engine 322 can transform the procedure data in response to receiving the procedure data in ACT 904 and storing the mapping data structure in ACT 902. In some embodiments, the orchestration engine 322 can perform the transformation as part of a batch processing operation that can transform multiple procedure data records in a single execution cycle. For example, the orchestration engine 322 can receive a batch file including fifty procedure data records from a plurality of heterogeneous source systems at a scheduled interval, and can transform all fifty procedure data records into corresponding procedure records by iterating over each procedure data record in the batch file and applying the procedure-identifier mapping for each procedure identifier encountered in the batch file. In some embodiments, when procedure data from two or more heterogeneous source systems map or correspond to the same canonical procedure identifier for the same time period, the orchestration engine 322 can de-duplicate or consolidate the corresponding source records into a single procedure record associated with the canonical procedure identifier for that time period.

The method 900 can include receiving factor-based data and preference data (ACT 908). The system 300 can receive the factor-based data and the preference data via one or more processing components, as depicted in FIG. 3. For example, the orchestration engine 322 of the system 300 can receive the factor-based data including operational parameter values correlated with anticipated consumption of at least one constituent SKU, independent of the projected volume. For instance, the orchestration engine 322 can receive the factor-based data indicating that a hospital occupancy metric for a cardiac care unit has increased by twenty percent relative to a baseline occupancy level. The orchestration engine 322 can receive the factor-based data indicating that a seasonal epidemiological trend shows an increase in cardiovascular procedure demand during winter months based on historical admission data spanning five years. The orchestration engine 322 can receive factor-based data indicating that a supplier has offered a bulk procurement incentive that reduces per-unit cost for surgical glove SKUs by fifteen percent when a minimum order quantity of one thousand units is satisfied. In such cases, the anticipated consumption of surgical gloves can be influenced or regulated by the hospital occupancy metric, the seasonal trend, or the bulk procurement incentive independently of the projected volume of surgical procedures stored in the canonical procedure record.

The orchestration engine 322 can receive the factor-based data in response to storing the combination SKU record in ACT 902. In some embodiments, the orchestration engine 322 can receive the factor-based data concurrently with the procedure data in ACT 904 by establishing a connection to a customer enterprise resource planning system via the customer system integration manager 306 and retrieving the factor-based data in a single retrieval operation that can also retrieve the procedure data, such that the factor-based data and the procedure data can be received in the same data transmission message.

In some embodiments, the orchestration engine 322 can receive the factor-based data at scheduled intervals from external systems. The orchestration engine 322 can establish a scheduled retrieval operation that executes at a predefined time interval, such as daily at midnight or hourly at the start of each hour, to retrieve updated factor-based data from warehouse management systems, transportation management systems, or third-party analytics platforms via the distributor system integration manager 308. The orchestration engine 322 can establish connections to the external data sources via the distributor system integration manager 308. The orchestration engine 322 can parse incoming messages encoded in JavaScript Object Notation format, extensible markup language format, or comma-separated values format to extract operational parameter values such as inventory availability thresholds, shipment delay indicators, or demand volatility coefficients from the incoming messages received over one or more network interfaces.

The orchestration engine 322 can receive preference data and store the preference data in a preference profile record associated with at least one site identifier. In some embodiments, the orchestration engine 322 can receive the preference data via the customer system integration manager 306 that can interface with one or more systems of a customer entity to retrieve customer-defined preferences. For example, the orchestration engine 322 can receive preference data from a hospital enterprise resource planning system indicating that a specific site associated with a site identifier of “SITE-001” prefers a catheter SKU having a supplier identifier of “SUP-A.” The orchestration engine 322 can parse the preference data to extract the site identifier “SITE-001” and the supplier preference for “SUP-A,” and can store the preference data in a preference profile record associated with the site identifier “SITE-001” as a linked data record in a relational database table that can reference the adaptive SKU data structure via a foreign key relationship.

The orchestration engine 322 can receive the preference data by parsing messages from the one or more systems of the customer entity that specify SKU selection parameters, purchase factor thresholds, priority associations between sites and SKU allocations, SKU migration sequencing rules, or conditional preferences invoked by a specific trigger. In some embodiments, the orchestration engine 322 via the adaptive SKU manager 302 can store the preference data as additional fields within the schema of the adaptive SKU data structure by appending a preference field to the combination SKU record that can store a reference to the preference profile record associated with the at least one site identifier. The orchestration engine 322 can receive the preference data in response to receiving the factor-based data in ACT 908, such that the preference data is available for input to the one or more trained machine learning models 324 when generating the plurality of candidate combination SKU record identifiers in ACT 912.

The method 900 can include receiving inventory data and normalizing operational parameter values (ACT 910). The system can receive the inventory data and normalize the operational parameter values via one or more processing components, as depicted in FIG. 3. For example, the orchestration engine 322 of the system 300 can receive inventory data from a plurality of heterogeneous source systems and transform the inventory data using the SKU-identifier mapping to generate a canonical inventory record. The canonical inventory record can store inventory attributes including at least one of available-to-promise quantity, on-hand quantity, backorder status, expected delivery date, inventory location, or availability state in association with canonical SKU identifiers corresponding to constituent SKUs identified in the membership field of the combination SKU record of the adaptive SKU data structure.

The orchestration engine 322 can normalize operational parameter values across the heterogeneous source systems by applying unit conversion operations, categorical encoding operations, or missing-value imputation operations to generate a canonical feature representation. For example, the orchestration engine 322 can receive a first operational parameter value specifying a procedure volume in units of “procedures per month” from a first heterogeneous source system and a second operational parameter value specifying a procedure volume in units of “weekly procedure count” from a second heterogeneous source system. The orchestration engine 322 can apply a unit conversion operation that converts the second operational parameter value from weekly procedure count to monthly procedure count by multiplying the weekly value by a conversion factor of four weeks per month. The orchestration engine 322 can apply a categorical encoding operation that maps a categorical supplier status value of “preferred” to a numerical encoding of one and a categorical supplier status value of “standard” to a numerical encoding of zero, and can apply a missing-value imputation operation that replaces a missing expiry date parameter with a default expiry date threshold of ninety days from a current date. The orchestration engine 322 can generate a canonical feature representation that includes normalized operational parameter values expressed in consistent units and formats suitable for input to the one or more trained machine learning models.

The orchestration engine 322 can normalize the operational parameter values expressed in different units or scales from the plurality of heterogeneous source systems into a canonical scale prior to executing the one or more trained machine learning models 324. The orchestration engine 322 can apply unit conversion operations that convert a first operational parameter value specifying a hospital occupancy percentage from a first heterogeneous source system and a second operational parameter value specifying a bed utilization ratio from a second heterogeneous source system into a normalized occupancy metric expressed as a decimal value between zero and one, and can apply categorical encoding operations that map a categorical supplier status value of “preferred” to a numerical encoding of one and a categorical supplier status value of “standard” to a numerical encoding of zero. The normalized operational parameter values can be expressed in consistent units and formats suitable for input to the one or more trained machine learning models 324 and for execution in subsequent filtering or selection operations.

The method 900 can include generating candidate combination SKU identifiers and score values using trained machine learning models (ACT 912). The system 300 can generate, via one or more processing components, as depicted in FIG. 3, candidate combination SKU identifiers and score values using trained machine learning models. For example, the orchestration engine 322 of the system 300 can generate, by executing one or more trained machine learning models 324, a plurality of candidate combination SKU record identifiers and corresponding score values based on at least the canonical procedure record, the factor-based data, inventory data, or the preference profile record. The orchestration engine 322 can generate the candidate combination SKU record identifiers in response to receiving and storing the preference data in ACT 908.

In some embodiments, the orchestration engine 322 can generate the candidate combination SKU record identifiers at scheduled intervals as part of a forecasting cycle. For example, the orchestration engine 322 can execute the one or more trained machine learning models 324 at midnight each day, for instance, to generate updated candidate combination SKU record identifiers for procedures scheduled for a subsequent seven-day time period.

In some embodiments, the orchestration engine 322 can generate the candidate combination SKU record identifiers in response to event-driven triggers. For example, the orchestration engine 322 can generate a new plurality of candidate combination SKU record identifiers when the distributor system integration manager 308 receives an inventory update from a warehouse management system indicating that a catheter SKU identifier has transitioned from an available status to a backordered status, or when the customer system integration manager 306 receives a shipment delay notification from a transportation management system indicating that an expected delivery date for a guidewire SKU has shifted by seven days relative to a prior expected delivery date.

The orchestration engine 322 can generate the candidate combination SKU record identifiers by retrieving the canonical procedure record from memory, retrieving the factor-based data received in ACT 908, retrieving the inventory data from one or more systems of an entity via the distributor system integration manager 308, and retrieving the preference profile record associated with the at least one site identifier. The orchestration engine 322 can construct a feature vector from the retrieved data by concatenating operational parameter values extracted from the canonical procedure record, the factor-based data, the inventory data, or the preference profile record into a numerical array. The orchestration engine 322 can execute the one or more trained machine learning models 324 with the feature vector as input, and can receive candidate combination SKU record identifiers and corresponding score values as output from the one or more trained machine learning models 324 for use with the adaptive SKU data structure and the combination SKU record associated therewith.

For example, for a cardiac catheterization procedure, the orchestration engine 322 can execute a trained machine learning model 324 and can receive candidate combination SKU record identifiers and corresponding score values as output. A first candidate combination SKU record identifier can include a membership field of an adaptive SKU data structure storing canonical SKU identifiers for a first guidewire SKU having a supplier identifier of “SUP-A,” a first catheter SKU having a supplier identifier of “SUP-A,” and a first contrast agent SKU having a supplier identifier of “SUP-B,” and can have a corresponding score value of 0.85 indicating a predicted suitability based on procedural compatibility requirements stored in the rule field of the adaptive SKU data structure, inventory availability indicated by the inventory data, and customer preferences specified in the preference profile record. A second candidate combination SKU record identifier can include a membership field of the adaptive SKU data structure storing canonical SKU identifiers for a second guidewire SKU having a supplier identifier of “SUP-C,” a second catheter SKU having a supplier identifier of “SUP-D,” and a second contrast agent SKU having a supplier identifier of “SUP-E.” The second candidate combination SKU record identifier can have a corresponding score value of 0.72 indicating a lower predicted suitability relative to the first candidate combination SKU record identifier due to a higher per-unit procurement cost for the second guidewire SKU and lower historical delivery performance for the supplier associated with the second catheter SKU.

In some embodiments, the orchestration engine 322 can cache the canonical feature representation for a given time period in association with the procedure identifier or the adaptive SKU identifier. The orchestration engine 322 can reuse the cached representation to execute the one or more trained machine learning models 324 for at least one subsequent forecasting operation for the given time period without reconstructing the feature vector from the canonical procedure record, the factor-based data, the inventory data, and the preference profile record to reduce processor utilization and memory allocation associated with repeated feature construction operations.

The method 900 can include filtering candidate combination SKU records using rules, preferences, and inventory data (ACT 914). The system 300 can filter, via one or more processing components, as depicted in FIG. 3, candidate combination SKU records using rules, preferences, and inventory data. For example, the orchestration engine 322 can filter candidate combination SKU record identifiers based on executable combination rules stored in the rule field of the adaptive SKU data structure to exclude any candidate combination SKU record identifier that may not be permitted for the preference profile record associated with the at least one site identifier. For example, the orchestration engine 322 can retrieve a preference profile record indicating that a site identifier “SITE-001” prefers catheter SKUs associated with a supplier identifier of “SUP-A,” and can retrieve an executable combination rule specifying that candidate combination SKU record identifiers that include a catheter SKU associated with a non-preferred supplier are not permitted for the site identifier “SITE-001.” The orchestration engine 322 can identify that a candidate combination SKU record identifier includes a catheter SKU associated with a supplier identifier of “SUP-C,” and can exclude the candidate combination SKU record identifier from further evaluation based on the executable combination rule and the preference profile record.

The orchestration engine 322 can enforce a hard constraint that can exclude any candidate combination SKU record identifier whose membership field of the adaptive SKU data structure includes a constituent SKU identifier that is indicated by the inventory data as unavailable for the given time period. For example, the orchestration engine 322 can retrieve inventory data from the distributor system integration manager 308 indicating that a catheter SKU supplied by a fourth supplier has an available-to-promise inventory quantity of zero units for a delivery window spanning a start date seven days from a current date to an end date fourteen days from the current date. The orchestration engine 322 can identify that a third candidate combination SKU record identifier has a membership field of the adaptive SKU data structure that includes the catheter SKU supplied by the fourth supplier, and can determine that the third candidate fails to satisfy a hard constraint rule stored in the rule field of the adaptive SKU data structure specifying that all constituent SKUs in a selected combination SKU record are to have an available-to-promise inventory quantity greater than zero units for the delivery window. The orchestration engine 322 can exclude the third candidate from further evaluation without computing a score value for the third candidate or propagating quantities for the constituent SKUs of the third candidate to reduce processor utilization associated with scoring and quantity computation for infeasible candidate configurations.

The method 900 can include selecting target combination SKU record identifier (ACT 916). The system can select the target combination SKU record identifier via one or more processing components, as depicted in FIG. 3. For example, the orchestration engine 322 of the system 300 can select a target combination SKU record identifier based on the score values generated in ACT 912 and at least one rule-based selection criterion or condition stored in the rule field of the combination SKU record of the adaptive SKU data structure. In some embodiments, the orchestration engine 322 can select the target combination SKU record identifier by ranking the plurality of candidate combination SKU record identifiers according to their corresponding score values in descending order, applying one or more rule-based selection criteria to filter the ranked candidates, and selecting the highest-ranked candidate that satisfies the applied criteria.

For example, the orchestration engine 322 can receive a plurality of candidate combination SKU record identifiers including a first candidate having a membership field of the adaptive SKU data structure that stores canonical SKU identifiers for a guidewire SKU supplied by a first supplier, a catheter SKU supplied by the first supplier, and a contrast agent SKU supplied by a second supplier, where the first candidate has a score value of 0.87, and a second candidate having a membership field of the adaptive SKU data structure that stores canonical SKU identifiers for a guidewire SKU supplied by a third supplier, a catheter SKU supplied by a fourth supplier, and a contrast agent SKU supplied by the second supplier, where the second candidate has a score value of 0.79. The orchestration engine 322 can rank the first candidate ahead of the second candidate based on the higher score value of 0.87. The orchestration engine 322 can apply a rule-based selection criterion retrieved from the rule field of the adaptive SKU data structure specifying that all constituent SKUs in a selected combination SKU record are to have an available-to-promise inventory quantity greater than zero units for a delivery window spanning a start date seven days from a current date to an end date fourteen days from the current date. The orchestration engine 322 can retrieve inventory data from the distributor system integration manager 308 indicating that the guidewire SKU supplied by the first supplier has an available-to-promise inventory quantity of fifty units and that the catheter SKU supplied by the first supplier has an available-to-promise inventory quantity of thirty units for the delivery window. The orchestration engine 322 can determine that the first candidate satisfies the rule-based selection criterion, and can select the first candidate as the target combination SKU record identifier by executing the rule-based selection criterion using the adaptive SKU data structure or one or more fields thereof.

The orchestration engine 322 can select the target combination SKU record identifier in response to generating the plurality of candidate combination SKU record identifiers and corresponding score values in ACT 912. In some embodiments, the orchestration engine 322 can select the target combination SKU record identifier in response to generating the candidate combination SKU record identifiers as part of a single computational operation that executes the one or more trained machine learning models 324, generates the score values, ranks the candidates, applies the rule-based selection criteria, and commits the selected target combination SKU record identifier to memory. In some embodiments, the orchestration engine 322 can defer the selection of the target combination SKU record identifier until after a review period during which a user accesses a user interface provided by the customer manager 312 or the distributor manager 314 to validate, approve, or modify at least one candidate combination SKU record identifier before the orchestration engine 322 selects the target combination SKU record identifier.

For example, the orchestration engine 322 can generate the plurality of candidate combination SKU record identifiers at a first time, and can transmit a notification message via a network interface to a computing device of a purchasing manager at a second time that occurs ten minutes after the first time, where the notification message can include data identifying the plurality of candidate combination SKU record identifiers and their corresponding score values formatted for display in a user interface presented by the customer manager 312. The orchestration engine 322 can receive an approval message from the computing device at a third time that occurs thirty minutes after the second time, where the approval message includes an identifier of the first candidate combination SKU record identifier approved by the purchasing manager. The orchestration engine 322 can select the first candidate as the target combination SKU record identifier at the third time in response to receiving the approval message over a network interface including an API, packet-based message, payload, adapter-based interface, or protocol-formatted communication.

The method 900 can include computing constituent SKU quantities using quantity ranges and propagation rules (ACT 918). The system 300 can compute, via one or more processing components, as depicted in FIG. 3, constituent SKU quantities using quantity ranges and propagation rules. For example, the orchestration engine 322 of the system 300 can compute quantities for at least a subset of the plurality of constituent SKUs by applying at least one dynamic quantity range in the quantity-range field and applying at least one propagation rule in the dependency field of the adaptive SKU data structure. The orchestration engine 322 can retrieve the selected target combination SKU record identifier from memory, and can retrieve the quantity-range field and the dependency field of the adaptive SKU data structure from the combination SKU record associated with the selected target combination SKU record identifier. The orchestration engine 322 can apply the dynamic quantity range to establish a base quantity for each constituent SKU in the ordered list. The orchestration engine 322 can apply the propagation rules stored in the dependency field to adjust quantities based on dependencies between constituent SKUs.

For example, the orchestration engine 322 can retrieve a target combination SKU record identifier having a membership field of the adaptive SKU data structure that stores canonical SKU identifiers for a guidewire SKU, a catheter SKU, and a contrast agent SKU, and can retrieve a quantity-range field that stores a dynamic quantity range of ten to twelve units for the guidewire SKU. The orchestration engine 322 can establish a base quantity of ten units for the guidewire SKU by applying the lower bound of the dynamic quantity range, and can retrieve a dependency field of the adaptive SKU data structure that stores a quantity relationship entry specifying that a quantity change of the catheter SKU from a default quantity of five units to a substituted quantity of seven units triggers a proportional adjustment of the guidewire SKU quantity by a factor of 1.2. The orchestration engine 322 can compute an adjusted quantity of twelve units for the guidewire SKU by multiplying the base quantity of ten units by the proportional adjustment factor of 1.2.

The orchestration engine 322 can compute the quantities in response to selecting the target combination SKU record identifier in ACT 916. In some embodiments, the orchestration engine 322 can perform the computation concurrently with the selection by executing the quantity computation as part of a single coordinated operation that selects the target combination SKU record identifier and computes constituent SKU quantities without an intervening commit operation to memory.

In some embodiments, the orchestration engine 322 can perform the computation as part of a subsequent refinement operation that adjusts quantities based on updated inventory data by receiving an inventory update message from the distributor system integration manager 308 indicating that a backordered catheter SKU has transitioned from a backordered status to an available status, and retrieving the dependency field of the adaptive SKU data structure to identify quantity relationship entries incident to the catheter SKU. The orchestration engine 322 can recalculate quantities for the guidewire SKU and any other constituent SKUs affected by the status change without recalculating quantities for the contrast agent SKU when the dependency field indicates that the contrast agent SKU quantity is independent of the catheter SKU quantity.

The orchestration engine 322 can apply a dynamic quantity range as a bounded constraint on a base quantity derived from a projected procedure volume stored in the canonical procedure record. The orchestration engine 322 can retrieve the projected volume of fifty procedures, for instance, for a cardiac catheterization procedure from the canonical procedure record, and can multiply the projected volume by a usage factor of 0.2 units per procedure for the guidewire SKU to compute a base quantity of ten units. The orchestration engine 322 can apply the dynamic quantity range of ten to twelve units from the quantity-range field to constrain the base quantity to a permissible interval, such that the computed quantity for the guidewire SKU remains within the interval defined by the dynamic quantity range even when the projected procedure volume fluctuates.

The orchestration engine 322 can apply, using the dependency field of the adaptive SKU data structure, at least one propagation rule that can adjust the quantity of a second constituent SKU responsive to the bounded quantity of a first constituent SKU. The orchestration engine 322 can retrieve a propagation rule from the dependency field of the adaptive SKU data structure that specifies a proportional relationship between the guidewire SKU and the contrast agent SKU, can compute a bounded quantity of twelve units for the guidewire SKU, for instance, by applying the dynamic quantity range, and can apply the proportional relationship to compute a quantity of three units for the contrast agent SKU by multiplying the bounded quantity of the guidewire SKU by a proportionality coefficient of 0.25 stored in the propagation rule.

The method 900 can include incrementally recomputing affected quantities and committing updated quantity state (ACT 920). The system 300 can incrementally recompute affected quantities and commit updated quantity state using one or more components. For example, the orchestration engine 322 can perform an incremental recomputation operation that updates quantities for an affected subset of the plurality of constituent SKUs responsive to at least one of a change in inventory data, a change in preference data, or execution of at least one executable combination rule. The orchestration engine 322 can commit an updated quantity state to memory in association with the selected target combination SKU record identifier. The orchestration engine 322 can perform the incremental recomputation operation in response to detecting a change event by executing one or more quantity relationship entries of the adaptive SKU data structure.

For example, the orchestration engine 322 can receive an inventory update message from the distributor system integration manager 308 indicating that a catheter SKU identifier has transitioned from an available status to a backordered status with an expected restocking date of fifteen days from the current date. The orchestration engine 322 can parse the inventory update message to extract the catheter SKU identifier and the change in availability status. The orchestration engine 322 can initiate the incremental recomputation operation. The orchestration engine 322 can identify quantity relationship entries in the dependency field of the adaptive SKU data structure that are incident to the catheter SKU identifier and recalculate quantities for constituent SKUs reachable through such quantity relationship entries.

In some embodiments, the change event can include a change in preference data associated with the preference profile record for at least one site identifier. For example, the orchestration engine 322 can receive an updated preference message indicating that a site identifier “SITE-001” has changed a supplier preference from a first catheter SKU supplied by “SUP-A” to a second catheter SKU supplied by “SUP-B,” and can identify a constituent SKU affected by the updated preference data. The orchestration engine 322 can initiate the incremental recomputation operation by traversing quantity relationship entries in the dependency field of the adaptive SKU data structure that are incident to the affected constituent SKU and recalculating quantities for constituent SKUs in the affected subset without recalculating quantities for unaffected constituent SKUs.

In some embodiments, the orchestration engine 322 can perform the incremental recomputation operation as part of a coordinated transaction that updates the membership field of the adaptive SKU data structure and recomputes quantities in a single execution cycle. For example, the orchestration engine 322 can execute an executable combination rule from the rule field of the adaptive SKU data structure that replaces the backordered catheter SKU identifier in the membership field of the adaptive SKU data structure with an alternative catheter SKU identifier that satisfies procedural compatibility constraints stored in the rule field of the adaptive SKU data structure. The orchestration engine 322 can retrieve quantity relationship entries from the dependency field of the adaptive SKU data structure that define a proportional relationship between the catheter SKU and a guidewire SKU specifying that a substitution of the catheter SKU triggers a quantity adjustment of the guidewire SKU by a proportionality coefficient of 1.2. The orchestration engine 322 can apply the proportional relationship to recalculate a quantity for the guidewire SKU from ten units to twelve units. The orchestration engine 322 can commit the updated membership field and the recalculated guidewire SKU quantity to memory in a single atomic write operation without committing intermediate states to memory.

The orchestration engine 322 can identify the affected subset of the plurality of constituent SKUs by traversing quantity relationship entries in the dependency field of the adaptive SKU data structure that are incident to the changed constituent SKU identifier, updating quantities for the affected subset, and committing the updated quantity state to memory without recalculating quantities for unaffected constituent SKUs. For example, the orchestration engine 322 can retrieve a dependency field of the adaptive SKU data structure that stores a first quantity relationship entry specifying that a quantity change of the catheter SKU from five units to seven units triggers a proportional adjustment of the guidewire SKU quantity by a factor of 1.2. The orchestration engine 322 can retrieve a second quantity relationship entry specifying that the contrast agent SKU quantity remains independent of the catheter SKU quantity and is not subject to propagation when the catheter SKU quantity changes. The orchestration engine 322 can identify the guidewire SKU as the affected subset by determining that the guidewire SKU is reachable through the first quantity relationship entry incident to the catheter SKU, and can recalculate the quantity for the guidewire SKU from ten units to twelve units by applying the proportionality coefficient of 1.2. The orchestration engine 322 can commit the recalculated guidewire SKU quantity to memory without recalculating the quantity for the contrast agent SKU to reduce processor utilization relative to a full recomputation operation that recalculates quantities for all constituent SKUs in the membership field of the adaptive SKU data structure.

The method can include initiating downstream inventory action (ACT 922). The system 300 can initiate downstream inventory actions via one or more processing components, as depicted in FIG. 3. For example, in response to selecting the target combination SKU record identifier or computing quantities for the constituent SKUs, the orchestration engine 322 can initiate at least one downstream inventory action without recomputing quantities for unaffected constituent SKUs or unaffected portions of the selected combination SKU record, or without recomputing quantities for non-affected combination SKU records. The orchestration engine 322 can perform the downstream inventory action by generating a replenishment instruction for at least one constituent SKU, triggering a redistribution operation among a plurality of sites, or updating an availability state for the selected combination SKU record or one or more constituent SKUs via a network interface and as a transaction executed over or using the adaptive SKU data structure.

It should be noted that certain passages of this disclosure can reference terms such as “first” and “second” in connection with devices, modes of operation, transmit chains, roles, etc., for purposes of identifying or differentiating one from another or from others. These terms are not intended to merely relate entities (e.g., a first device and a second device) temporally or according to a sequence, although in some cases, these entities can include such a relationship. Nor do these terms limit the number of possible entities (e.g., devices) that can operate within a system or environment. The terms coupled or connected (which can refer to electronic or communicative coupling or connection, such as for the purposes of data transmission) include indirect and direct couplings and connections.

While the disclosure has been described with respect to specific embodiments, one skilled in the art will recognize that numerous modifications are possible. For instance, although specific examples of rules (including triggering conditions and/or resulting actions) and processes for generating suggested rules are described, other rules and processes can be implemented. Embodiments of the disclosure can be realized using a variety of computer systems and communication technologies including but not limited to specific examples described herein.

Embodiments of the present disclosure can be realized using any combination of components and/or programmable processors and/or other programmable devices. The various processes described herein can be implemented on the same processor or different processors in any combination. Where components are described as being configured to perform certain operations, such configuration can be accomplished, e.g., by designing electronic circuits to perform the operation, by programming programmable electronic circuits (such as microprocessors) to perform the operation, or any combination thereof. Further, while the embodiments described above can make reference to specific hardware and software components, those skilled in the art will appreciate that different combinations of hardware and/or software components can also be used and that particular operations described as being implemented in hardware might also be implemented in software or vice versa.

Computer programs incorporating various features of the present disclosure can be encoded and stored on various computer readable storage media; suitable media include magnetic disk or tape, optical storage media such as compact disk (CD) or DVD (digital versatile disk), flash memory, and other non-transitory media. Computer readable media encoded with the program code can be packaged with a compatible electronic device, or the program code can be provided separately from electronic devices (e.g., via Internet download or as a separately packaged computer-readable storage medium).

Thus, although the disclosure has been described with respect to specific embodiments, it will be appreciated that the disclosure is intended to cover all modifications and equivalents within the scope of the following claims.

It should be understood that the described embodiments are not representative of all claimed innovations. As such, certain aspects of the disclosure have not been discussed herein. Alternate embodiments that can not have been presented for a specific portion of the innovations or that further undescribed alternate embodiments can be available for a portion is not to be considered a disclaimer of those alternate embodiments. Thus, it is to be understood that other embodiments can be utilized and functional, logical, operational, organizational, structural and/or topological modifications can be made without departing from the scope of the disclosure. As such, all examples and/or embodiments are deemed to be non-limiting throughout this disclosure.

Some embodiments described herein relate to methods. It should be understood that such methods can be computer implemented methods (e.g., instructions stored in memory and executed on processors). Where methods described above indicate certain events occurring in a certain order, the ordering of certain events can be modified. Additionally, certain of the events can be performed repeatedly, concurrently in a parallel process when possible, as well as performed sequentially as described above. Furthermore, certain embodiments can omit one or more described events.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) can be those designed and constructed for a specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules can include, for example, a general-purpose processor, a field-programmable gate array (FPGA), and/or an application-specific integrated circuit (ASIC). Software modules (executed on hardware) can be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as those produced by a compiler, code used to produce a web service, and files containing higher-level instructions that are executed by a computer using an interpreter. For example, embodiments can be implemented using Python, Java, JavaScript, C++, and/or other programming languages and software development tools. For example, embodiments can be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

The drawings primarily are for illustrative purposes and are not intended to limit the scope of the subject matter described herein. The drawings are not necessarily to scale; in some instances, various aspects of the subject matter described herein can be shown exaggerated or enlarged in the drawings to facilitate an understanding of different features. In the drawings, like reference characters generally refer to like features (e.g., functionally similar and/or structurally similar elements).

The acts performed as part of a described method(s) can be ordered in any suitable way. Accordingly, embodiments can be constructed in which processes or steps are executed in an order different than illustrated, which can include performing some steps or processes simultaneously, even though shown as sequential acts in illustrative embodiments. Put differently, it is to be understood that such features can not necessarily be limited to a particular order of execution, but rather, any number of threads, processes, services, servers, and/or the like that can execute serially, asynchronously, concurrently, in parallel, simultaneously, synchronously, and/or the like in a manner consistent with the disclosure. As such, some of these features can be mutually contradictory, in that they cannot be simultaneously present in a single embodiment. Similarly, some features are applicable to one aspect of the innovations, and inapplicable to others.

Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood as open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A system comprising:
one or more processors; and
a non-transitory computer-readable medium storing instructions that, when executed by the one or more processors, cause the system to:
maintain, in memory, an adaptive stock-keeping unit (SKU) associated with a type of procedure, the adaptive SKU comprising a combination SKU having a plurality of SKUs for the type of procedure and having a plurality of parameters, wherein the adaptive SKU is represented by an adaptive SKU data structure having a schema comprising:
(i) a procedure-key field storing a procedure identifier for the type of procedure;
(ii) a membership field storing an ordered list of identifiers for the plurality of SKUs of the combination SKU;
(iii) a dependency field storing quantity relationship entries that define, for at least one pair of identifiers for the plurality of SKUs, a propagation rule that maps a quantity change of a first SKU to a quantity change of a second SKU; and
(iv) a rule field storing executable membership rules that define permitted membership modifications to the ordered list;
establish one or more connections, via one or more interfaces, to one or more systems of an entity, the one or more interfaces providing an ordering interface for the entity to request one or more units associated with the adaptive SKU; and
receive, by the one or more interfaces from the one or more systems of the entity, one or more customer parameters of the plurality of parameters for managing the adaptive SKU, and store the one or more customer parameters in association with the adaptive SKU data structure.

2. The system of claim 1, wherein the ordering interface is configured to receive an order request from the entity for one or more units associated with the adaptive SKU, the order request identifying at least the procedure identifier stored in the procedure-key field.

3. The system of claim 1, wherein the one or more customer parameters comprise one or more combination rules that define, for the adaptive SKU, permitted substitutions in which one SKU identifier in the ordered list is replaced with a different SKU identifier.

4. The system of claim 1, wherein the instructions further cause the system to:
initiate, via a second one or more interfaces to a supplier system, an order for one or more units associated with at least one SKU identifier in the ordered list based at least on the one or more customer parameters.

5. The system of claim 1, wherein the one or more customer parameters comprise inventory values for the adaptive SKU at a plurality of sites of the entity, and wherein the system is further configured to store the inventory values in association with the adaptive SKU data structure.

6. The system of claim 5, wherein the instructions further cause the system to:
determine that an inventory value for the adaptive SKU at a first site satisfies a threshold condition, and responsive to the threshold condition, trigger a membership modification of the ordered list using at least one executable membership rule stored in the rule field.

7. The system of claim 5, wherein the instructions further cause the system to:
trigger a redistribution of one or more units associated with the adaptive SKU across the plurality of sites based at least on the inventory values and the one or more customer parameters.

8. The system of claim 1, wherein the instructions further cause the system to:
determine a recommended configuration of the adaptive SKU for the entity, the recommended configuration identifying at least one of a modified ordered list of SKU identifiers or a modified set of the one or more customer parameters.

9. The system of claim 1, wherein the instructions further cause the system to:
receive, via the ordering interface, a transition request from the entity to transition from a first combination of the plurality of SKUs to a second combination of the plurality of SKUs, and to modify the membership field responsive to the transition request using at least one executable membership rule stored in the rule field.

10. The system of claim 1, wherein the one or more customer parameters comprise at least one site level constraint specifying site-specific ordering limits or allocation limits for at least one SKU identifier in the ordered list, and wherein the ordering interface enforces the site level constraint when processing an order request.

11. A computer-implemented method comprising:
maintaining, in memory, an adaptive stock-keeping unit (SKU) associated with a type of procedure, the adaptive SKU comprising a combination SKU having a plurality of SKUs for the type of procedure and having a plurality of parameters, wherein the adaptive SKU is represented by an adaptive SKU data structure having a schema comprising:
(i) a procedure-key field storing a procedure identifier for the type of procedure;
(ii) a membership field storing an ordered list of identifiers for the plurality of SKUs of the combination SKU;
(iii) a dependency field storing quantity relationship entries that define, for at least one pair of identifiers for the plurality of SKUs, a propagation rule that maps a quantity change of a first SKU to a quantity change of a second SKU; and
(iv) a rule field storing executable membership rules that define permitted membership modifications to the ordered list;
establishing one or more connections, via one or more interfaces, to one or more systems of an entity, the one or more interfaces providing an ordering interface for the entity to request one or more units associated with the adaptive SKU; and
receiving, by the one or more interfaces from the one or more systems of the entity, one or more customer parameters of the plurality of parameters for managing the adaptive SKU, and storing the one or more customer parameters in association with the adaptive SKU data structure.

12. The computer-implemented method of claim 11, wherein the ordering interface is configured to receive an order request from the entity for one or more units associated with the adaptive SKU, the order request identifying at least the procedure identifier stored in the procedure-key field.

13. The computer-implemented method of claim 11, wherein the one or more customer parameters comprise one or more combination rules that define, for the adaptive SKU, permitted substitutions in which one SKU identifier in the ordered list is replaced with a different SKU identifier.

14. The computer-implemented method of claim 11, further comprising:
initiating, via a second one or more interfaces to a supplier system, an order for one or more units associated with at least one SKU identifier in the ordered list based at least on the one or more customer parameters.

15. The computer-implemented method of claim 11, wherein the one or more customer parameters comprise inventory values for the adaptive SKU at a plurality of sites of the entity, and wherein the system is further configured to store the inventory values in association with the adaptive SKU data structure.

16. The computer-implemented method of claim 15, further comprising:
determining that an inventory value for the adaptive SKU at a first site satisfies a threshold condition, and responsive to the threshold condition, trigger a membership modification of the ordered list using at least one executable membership rule stored in the rule field.

17. The computer-implemented method of claim 15, further comprising:
triggering a redistribution of one or more units associated with the adaptive SKU across the plurality of sites based at least on the inventory values and the one or more customer parameters.

18. The computer-implemented method of claim 15, further comprising:
determining a recommended configuration of the adaptive SKU for the entity, the recommended configuration identifying at least one of a modified ordered list of SKU identifiers or a modified set of the one or more customer parameters.

19. The computer-implemented method of claim 11, further comprising:
receiving, via the ordering interface, a transition request from the entity to transition from a first combination of the plurality of SKUs to a second combination of the plurality of SKUs, and to modify the membership field responsive to the transition request using at least one executable membership rule stored in the rule field.

20. A non-transitory computer readable medium including one or more instructions stored thereon and executable by a processor to:
maintain, in memory, an adaptive stock-keeping unit (SKU) associated with a type of procedure, the adaptive SKU comprising a combination SKU having a plurality of SKUs for the type of procedure and having a plurality of parameters, wherein the adaptive SKU is represented by an adaptive SKU data structure having a schema comprising:
(i) a procedure-key field storing a procedure identifier for the type of procedure;
(ii) a membership field storing an ordered list of identifiers for the plurality of SKUs of the combination SKU;
(iii) a dependency field storing quantity relationship entries that define, for at least one pair of identifiers for the plurality of SKUs, a propagation rule that maps a quantity change of a first SKU to a quantity change of a second SKU; and
(iv) a rule field storing executable membership rules that define permitted membership modifications to the ordered list;
establish one or more connections, via one or more interfaces, to one or more systems of an entity, the one or more interfaces providing an ordering interface for the entity to request one or more units associated with the adaptive SKU; and
receive, by the one or more interfaces from the one or more systems of the entity, one or more customer parameters of the plurality of parameters for managing the adaptive SKU, and store the one or more customer parameters in association with the adaptive SKU data structure.
